(19) United States
(12) Patent Application Publication
(10) Pub. No.: US 2022/0162761 A1
(43) Pub. Date: May 26, 2022

(54) PROCESSES USEFUL IN THE MANUFACTURE OF CYCLODODECASULFUR

(71) Applicant: EASTMAN CHEMICAL COMPANY, KINGSPORT, TN (US)

(72) Inventors: SCOTT DONALD BARNICKI, KINGSPORT, TN (US); ROBERT THOMAS HEMBRE, JOHNSON CITY, TN (US); SUMIT CHAKRABORTY, JOHNSON CITY, TN (US); MICHAEL RICHARD LANINGHAM, ERWIN, TN (US); VICKIE HAGOOD OSBORNE, FALL BRANCH, TN (US); LESLIE SHARON DEPEW, KINGSPORT, TN (US); ANNETTE ELIZABETH STEVENS, KINGSPORT, TN (US); JOHN DEREK WOOLLINS, SAINT ANDREWS, FIFE (GB); GUOXIONG HUA, SAINT ANDREWS, FIFE (GB)

(73) Assignee: EASTMAN CHEMICAL COMPANY, KINGSPORT, TN (US)

(21) Appl. No.: 17/437,956

(22) PCT Filed: Mar. 5, 2020
(86) PCT No.: PCT/US2020/021073

§ 371 Date: Sep. 10, 2021

Related U.S. Application Data
(60) Provisional application No. 62/817,781, filed on Mar. 13, 2019.

(51) Int. Cl. C25B 1/24; B01D 3/36; C25B 9/19; C25B 15/08; C25B 1/50

(52) U.S. Cl. CPC C25B 1/24; B01D 3/36; C25B 1/50; C25B 15/083; C25B 9/19

(57) ABSTRACT

Method for producing molecular halogen are disclosed, that include the steps of: oxidizing a halide to produce a mixture comprising one or more of a molecular halogen, a trihalide, and a halide; reducing a polysulfide comprising a higher rank polysulfide dianion to produce a lower rank polysulfide dianion; and recovering molecular halogen from the mixture comprising one or more of a molecular halogen, a trihalide, and a halide.

### FIELD OF THE INVENTION

The present application relates generally to methods and systems related to the recycle and regeneration of reactants and byproducts in the manufacture of cyclic sulfur allotropes such as cyclododecasulfur. The methods may be carried out in a continuous fashion or discontinuously, and with minimum waste formation.

### BACKGROUND OF THE INVENTION

U.S. Pat. No. 10,011,663, the disclosure of which is incorporated herein by reference, relates to vulcanizing compositions that include cyclododecasulfur. These vulcanizing compositions demonstrate improved thermal stability in vulcanizable formulations used to form vulcanized articles.

U.S. Pat. No. 10,011,485, the disclosure of which is likewise incorporated herein by reference, relates to methods for the manufacture of cyclododecasulfur, that include reacting a metallasulfur derivative with an oxidizing agent in a reaction zone to form a cyclododecasulfur-containing reaction mixture. The metallasulfur derivative may comprise a (TMEDA)Zn(S₆) complex (TMEDA=tetramethylethylenediamine), described hereinafter as (TMEDA)Zn(S₆) and the oxidizing agent may comprise molecular bromine, Br₂. We have found that, in addition to the desired cyclododecasulfur, a by-product metallabromide derivative, such as (TMEDA)ZnBr₂ complex, may also be formed. It would be desirable to recover such derivatives for reuse.

U.S. Pat. No. 4,485,154 relates to an electrically rechargeable anionically-active reduction-oxidation electric storage-supply system and process using a sodium or potassium sulfide-polysulfide anolyte reaction and an iodide-polyiodide, chloride-chlorine or bromide-bromine species catholyte reaction.

U.S. Pat. No. 8,815,050 relates to processes and systems for drying liquid bromine utilizing two fractionators to produce a substantially dry liquid bromine stream and a substantially bromine-free water stream. Wet bromine liquid may be conveyed to a first fractionator wherein a substantially dry bromine liquid is produced, while a vapor stream from the first fractionator may be condensed into a first liquid phase comprising bromine saturated with water and a second liquid phase comprising water saturated with bromine.

U.S. Pat. No. 4,110,180 relates to a method and apparatus for electrolyzing an aqueous bromide containing electrolyte to form bromine by passing an electrolysis current through said electrolyte between a cathode and an anode.

U.S. Pat. No. 5,466,848 discloses sulfur-containing organosilicon compounds useful as coupling agents in vulcanizable rubbers to enhance various properties, including low rolling resistance for automobile tires, are prepared. In a preferred process scheme, sodium ethoxylate is reacted with hydrogen sulfide gas to yield sodium sulfide. The sodium sulfide is then reacted with sulfur to form the tetrasulfide. The product of that reaction is then reacted with chloropropyltriethoxysilane to form the compound 3,3′-bis (triethoxysilylpropyl) tetrasulfide. The use of hydrogen sulfide gas and sodium metal alcoholates is said to provide an efficient and economical process.

There remains a need in the art for processes and systems for recycling byproducts in the manufacture of cyclic sulfur allotropes such as cyclododecasulfur.

### SUMMARY OF THE INVENTION

The present invention concerns improvements in the processes for producing cyclododecasulfur. In one aspect, methods for producing molecular halogen are provided that include the steps of oxidizing a halide to produce a mixture comprising one or more of a molecular halogen, a trihalide, and a halide; reducing a polysulfide comprising a higher rank polysulfide dianion to produce a lower rank polysulfide dianion; and recovering molecular halogen from the mixture comprising one or more of a molecular halogen, a trihalide, and a halide. In another aspect, the invention relates to systems for carrying out the inventive processes.

Further aspects and areas of applicability will become apparent from the description provided herein. It should be understood that the description and specific examples are intended for purposes of illustration only and are not intended to limit the spirit and scope of the present invention.

### DESCRIPTION OF FIGURES

FIG. 1 illustrates an aspect of the invention wherein molecular bromine is recovered from halide salts coupled with the reduction of a polysulfide dianion which shifts the distribution of the rank of the polysulfide dianion from a higher to a lower rank.

FIG. 2 illustrates an aspect of the invention which is an integrated process for the synthesis of cyclododecasulfur, with recycle of intermediate halide salt and metallahalide derivative and a polysulfilde salt.

FIG. 3 illustrates an integrated process for electrochemical regeneration of molecular bromine, with concomitant production of hydrogen and hydroxide, and with subsequent integration into a process for generation of a polysulfide.

FIG. 4 illustrates an integrated process for the production of S₁₂ that includes the bromine regeneration process set out in FIG. 3.

FIG. 5 illustrates a system for electrochemical regeneration of molecular bromine, with concomitant production of hydrogen and hydroxide, and with subsequent integration into a process for generation of a metal or quaternary polysulfide.

FIG. 6 illustrates an integrated process for the production of S₁₂ that includes the process for regeneration of molecular bromine from FIG. 5.

FIG. 7 illustrates a molecular halogen recovery zone in which the anolyte comprises a bromine-tribromide solution, and in which molecular bromine is recovered via distillation.

FIG. 8 illustrates a molecular halogen recovery zone in which the anolyte comprises a bromine-tribromide solution, in which molecular bromine is recovered via extraction.

FIG. 9 illustrates a system for bromine-chlorine exchange by reactive distillation carried out in an exchange reaction tower.

### DETAILED DESCRIPTION

As utilized herein, the following terms or phrases are defined as follows:

“Alkali metal” as used herein includes one or more of lithium, sodium, potassium, rubidium, and cesium, and especially sodium.

“Alkaline earth metal” as used herein includes especially calcium and magnesium.

As used herein, “halide” or “halide salt” means a salt of a halogen, for example a metal or a quaternary salt of a halogen. “Alkali metal halide salt” or simply “alkali metal halide” thus means in the simplest case a halide of an alkali metal, for example sodium chloride (NaCl) or sodium bromide (NaBr). Other examples include chloride and bromide salts of other alkali metals such as potassium chloride and potassium bromide. Further examples include any combination of alkali metals selected from lithium, sodium, potassium, and cesium with either chloride, bromide, iodide, or a pseudohalide, such as thiocyanate. Halides or halide salts are thus used according to the invention, for example in the production of molecular bromine or polysulfide dianion. In addition to alkali metal halide salts, alkaline earth metal halide salts such as CaBr₂ or CaCl₂), MgBr₂ or MgCl₂, or the like, may also be used. In another aspect, other metal salts may also be used. Alternatively, a quaternary halide salt may be used, for example a quaternary halide salt such as an ammonium or phosphonium salt such as ammonium bromide or chloride, tetrabutylammonium bromide or chloride, tetrabutylphosphonium bromide or chloride, or the like, may be used. Quaternary salts useful according to the invention are thus halide salts of quaternary cations. It should be understood with respect to the present invention that a reference to a particular halide should encompass halides generally, unless the context suggests the specific halide.

The term “trihalide” or “trihalide salt” as used herein means a salt of a halide in which three halide atoms are present, for example sodium tribromide or NaBr₃.

“Continuously” means that a process is carried out for an extended period of time, and continuous processes are thus distinguished in this sense from batch processes in which the process is carried out based primarily on the length of time needed to complete the intended reaction(s) or other unit operation(s). Continuous processes according to the invention are advantageous, as they allow multiple process steps to be carried out simultaneously, with reuse and recycle of byproducts and reactants.

“Cyclic sulfur allotrope” means a sulfur compound characterized by a homocyclic ring of sulfur atoms.

“Cyclododecasulfur” or “cyclododecasulfur compound” means a cyclic sulfur allotrope with twelve sulfur atoms in its homocyclic ring, also referred to herein as S₁₂.

“Electrochemical cell” or “electrolysis cell” means an apparatus comprising an anolyte chamber and a catholyte chamber, having an anode and a cathode respectively, provided with a direct electrical current, the chambers being separated by an ion-selective membrane which is permeable to cations. Electrolysis cells may be used according to the invention to carry out redox processes, that is, chemical reactions in which the oxidation states of atoms or molecules are changed, thus including or coupling both a reduction process and a complementary oxidation process. At its most basic level, oxidation is the loss of electrons, or an increase in the oxidation state, of a molecule, atom, or ion. Conversely, reduction is the gain of electrons or a decrease in the oxidation state by a molecule, atom, or ion. Thus, according to the invention, electrons may be supplied via an electrical current in an electrolysis cell, and both a reduction and an oxidation carried out simultaneously, with passage of cations across the ion-selective separator membrane and passage of electrons through the electrodes and a circuit.

“Elemental sulfur” as used herein may include S₈, also referred to as “cyclooctasulfur”. However, as used in the present invention, the term “elemental sulfur” is not intended to be especially limiting, and is intended to comprise allotropes other than S₈, it being understood that in the absence of special preparation or storage conditions, S₈ is typically the predominant allotrope seen in elemental sulfur. Thus, elemental sulfur more broadly is intended to include any sulfur allotrope from about 5 sulfur atoms up to about 30, or even larger in the case of polymeric sulfur.

“Halogen” as used herein refers to one or more of chlorine, bromine, and iodine. The symbol X may be used herein generically to refer to any halogen. Unless the context suggests otherwise, for example in the claims of the application, the mention of bromine or bromide should be understood to refer also to the other halogens or halides, as the case may be.

“Metallacyclosulfane” means a metallasulfur derivative with at least one cyclic structural feature containing sulfur and metal atoms, preferably only sulfur and metal atoms, with at least two sulfur atoms and one or more metal atoms, for example (TMEDA)Zn(S₆) may be referred to as a metallaheptacyclosulfane.

“Metallahalide derivative” or “metal halide derivative” means a compound containing monovalent halogen atoms and metal (M) atoms, in which the metal atom (M) may be monovalent, divalent or multivalent. The compound may contain other elements, ligands, cations or anions bonded or coordinated to the metal atom (inner- or outer-sphere), without limitation. According to the invention, when (TMEDA)Zn(S₆) complex (TMEDA=tetramethylethylenediamine) is used as the metallasulfur derivative and is oxidized with molecular bromine a metal dibromide derivative is obtained, the metallahalide derivative (TMEDA)ZnBr₂. Other metallahalide derivatives according to the invention will be understood to correspond to the metallasulfur derivatives from which they are derived.

“Metallasulfur derivative” means a compound containing divalent sulfur (S) atoms and metal (M) atoms with a ratio of sulfur to metal atoms of at least 2:1 (S:M≥2.0), and especially a (TMEDA)Zn(S₆) complex. The defining structural unit of such derivatives may be represented generically as:

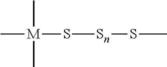

in which the metal atom (M) may be divalent or multivalent and the sulfur atoms (S) are divalent and form a chain with n 0. The compound may be linear or branched, it may be cyclic, multicyclic, oligomeric or polymeric and it may contain other elements, ligands, cations or anions bonded or coordinated to the metal atom (inner- or outer-sphere), without limitation.

“Sulfur templating agent” or “sulfur templating agents” means a compound, or combination of compounds and elements, which when reacted with elemental sulfur and/or a polysulfide form a metallasulfur derivative.

“Oxidizing agent” in one aspect means an agent which is (i) reduced by a metallasulfur derivative; (ii) promotes the release of the sulfur contained in the metallasulfur derivative; and (iii) does not add sulfur from its composition to the cyclododecasulfur being produced in the process. Molecular or diatomic halogens such as Br₂ are particularly useful oxidizing agents according to the present invention.

“Sulfide” generically may include S⁻², SH⁻, or polysulfide dianions having from an average of about 2.0 to about 6, or even 7 or 8 when present in an alcoholic medium. That is, “sulfide” may be used broadly to include both monosulfides and polysulfides. As used herein, it may also refer specifically to a monosulfide, depending on context, or to a metal or quaternary monosulfide comprising a monosulfide dianion, or an average of about 1.0 to about 1.2 sulfur atoms. Our intent here is not to exclude any average number of sulfurs between 1 and 2, but rather to ensure consistent nomenclature that would be well understood by one of ordinary skill in the art.

“Polysulfide dianion” thus refers to a divalent-sulfur-containing dianion where the number of sulfur atoms in an S—S chain comprises an average, for example, of from about 1.2 to about 6.5 sulfur atoms. Depending on context, “polysulfide” or “polysulfide dianion” may also refer to the dianion when associated with a metal such as an alkali or alkaline earth metal, and especially sodium polysulfide, which is also referred to herein as an “alkali metal polysulfide salt” or an “alkali metal polysulfide dianion.” Alternatively, the dianion may be associated with a quaternary cation, as defined elsewhere herein. Thus, the metal or quaternary polysulfide salts of the invention are metal or quaternary salts of polysulfide dianions and comprise a polysulfide dianion and a metal or quaternary cation(s). Metal or quaternary polysulfide salts useful according to the invention include mixtures of compounds corresponding to the formula M₂Sₓ, wherein x is an average, for example, of from about 1.5 to about 6.0. One specific alkali metal polysulfide salt is Na₂S₆ and its corresponding polysulfide dianion is S₆²⁻.

“Pseudohalogen” means a molecule or functional group with properties and a reactivity profile similar to a halogen.

“Rank” refers to the relative number of sulfur atoms in a polysulfide dianion moiety. Those having a higher number of sulfur atoms are higher in “rank.” According to this nomenclature, polysulfides or polysulfide anions have a higher rank than sulfides or sulfide dianions. That is, polysulfides having an average of about 4 sulfur atoms, for example, have a higher rank than those having an average of about 3, or about 2, sulfur atoms per molecule.

The present invention is characterized as providing a number of steps that are useful for the production of cyclododecasulfur, and for the recycle and reuse of reactants and byproducts. These steps are described and claimed herein in various forms and combinations, and may be practiced together or separately, continuously or as batch processes, as further disclosed and claimed herein.

Thus, according to one aspect of the invention, a step is provided of reacting a metallasulfur derivative with molecular halogen, to produce cyclododecasulfur and a metallahalide derivative.

In another aspect, a step is provided that comprises reacting a metallahalide derivative with a polysulfide salt such as an alkali metal polysulfide to obtain a metallasulfur derivative and a halide salt, for example an alkali metal halide salt.

In a further aspect, a step is provided that comprises oxidizing a halide salt, for example an alkali metal halide salt, to produce a molecular halogen. This oxidation step may result in a mixture of one or more of a trihalide such as an alkali metal trihalide, a halide such as an alkali metal halide, and elemental or molecular halogen or X₂.

In yet another aspect, a step is provided that comprises reducing a polysulfide salt comprising a higher rank polysulfide dianion to produce a lower rank polysulfide dianion.

In a further aspect, a step is provided that comprises reacting a lower rank polysulfide dianion with elemental sulfur to obtain a higher rank polysulfide dianion.

Another aspect of the invention comprises a step of recovering molecular halogen from a mixture of one or more of a trihalide, a halide and molecular halogen. In another aspect of the invention, a step is provided of recovering a halide from a mixture of one or more of a trihalide, a halide, and molecular halogen.

In a further aspect, the invention comprises a step of both oxidizing a halide to produce molecular halogen; and reducing a polysulfide salt comprising a higher rank polysulfide dianion to produce a lower rank polysulfide dianion, in an electrolysis cell, as further described herein.

In a further aspect, a step is provided of reacting a bromide salt with molecular chlorine to obtain molecular bromine and a chloride salt. In another aspect, a step is provided that comprises oxidizing a chloride salt in aqueous solution to obtain molecular chlorine, while reducing water to obtain hydrogen and hydroxide, especially a metal or quaternary hydroxide.

In other aspects, the invention provides steps that comprise: reacting hydrogen with elemental sulfur to obtain hydrogen sulfide; reacting hydrogen sulfide with a hydroxide to obtain a sulfide; and reacting a sulfide with elemental sulfur to obtain a polysulfide salt. Further aspects of the invention include the steps of: reacting alkali metal hydroxide with an alkanol with removal of water to produce an alkali metal alkoxide; and reacting hydrogen sulfide with the alkali metal alkoxide to obtain an alkali metal sulfide in alkanol. These steps likewise may be carried out separately, in sequence, or simultaneously, in suitable apparatuses, as further described below.

As noted, the steps of the invention are useful for the production of cyclododecasulfur, and for the recycle and reuse of reactants and byproducts of this production. These steps are described and claimed herein and may be practiced in various forms and combinations, and may be practiced together or separately, continuously or as batch processes, as further disclosed and claimed herein.

In one aspect, then, the present invention relates to a step of producing a metallasulfur derivative, which is useful to produce cyclododecasulfur, by reacting a metallahalide derivative with a polysulfide salt to obtain the metallasulfur derivative and a halide salt. In another aspect, the invention relates to methods of producing cyclododecasulfur that comprise at least the steps of: reacting a metallasulfur derivative with a molecular halogen, to produce cyclododecasulfur and a metallahalide derivative; and reacting a metallahalide derivative with a polysulfide to obtain the metallasulfur derivative and a halide salt. In either aspect, the reacting of the metallahalide derivative with the polysulfide salt may be carried out in the presence or absence of elemental sulfur. The polysulfide salt may comprise a higher rank polysulfide dianion, and the reacting of the metallahalide derivative with the polysulfide salt may also obtain a lower rank polysulfide dianion. The lower rank polysulfide dianion may, in turn, be reacted with elemental sulfur to obtain a higher rank polysulfide dianion. These methods may further comprise oxidizing the halide salt to produce a molecular halogen, and as further elaborated below, this oxidation may be carried out in an electrolysis cell.

It will be evident to those skilled in the art that these and other steps may be carried out in sequence, or may be carried out simultaneously, and preferably continuously. They may also be carried out in combination with further steps and sub-steps, as elaborated below, and serve to allow one skilled in the art to develop processes and systems, and especially continuous processes and systems, for producing S₁₂ from a metallasulfur derivative and molecular halogen, while recycling and reusing byproducts such as metallahalide derivatives, polysulfide salts or polysulfide dianions, and/or halide salts.

In another aspect, methods for producing molecular halogen are provided that comprise: oxidizing a halide to produce a mixture comprising one or more of a molecular halogen, a trihalide, and a halide; reducing a polysulfide comprising a higher rank polysulfide dianion to produce a lower rank polysulfide dianion; and recovering molecular halogen from the mixture comprising one or more of a molecular halogen, a trihalide, and a halide. In this aspect, the molecular halogen may be recovered by reacting the molecular halogen with a metallasulfur derivative by contacting the mixture with the metallasulfur derivative, to produce cyclododecasulfur and a metallahalide derivative. In this aspect, the methods may further comprise a step of reacting a metallasulfur derivative with the molecular halogen, to produce cyclododecasulfur and a metallahalide derivative.

In this aspect, the oxidizing and the reducing steps may be carried out in an electrochemical cell comprising a catholyte chamber and an anolyte chamber separated by an ion-selective membrane which is permeable to cations, wherein the polysulfide is reduced by electrons in the catholyte chamber, and wherein the halide is oxidized in the anolyte chamber by loss of electrons to produce molecular halogen.

In this aspect, the recovering of the molecular halogen may occur by contacting the mixture with an extraction solvent comprising one or more of: CS₂, C₅ and larger alkanes, halogenated hydrocarbons of 1 to 12 carbon atoms and one halogen atom up to perhalogenated content, and esters of C₂ to C₈ carboxylic acids with C₁ to C₈ alcohols. In this and other aspects, the halide may comprise one or more of a metal halide or a quaternary halide, and the recovering of the molecular halogen may occur by contacting the mixture with an extraction solvent comprising one or more of: CS₂, chlorobenzene, or ethyl acetate, or alternatively by heterogeneous azeotropic distillation, which may be carried out in the presence of hydrogen peroxide.

According to this aspect, the methods may further comprise reacting the metallahalide derivative with a polysulfide to obtain the metallasulfur derivative and a halide, and may also further comprise reacting the lower rank metal polysulfide dianion with elemental sulfur to obtain a higher rank polysulfide dianion. The halide may comprise an alkali metal halide, and the concentration of the lower rank polysulfide dianion after the reducing step is typically from about 20 wt % to about 45 wt %.

In this aspect, the methods may further comprise: reacting the lower rank polysulfide dianion with elemental sulfur to obtain a higher rank metal polysulfide dianion; and reacting the higher rank metal polysulfide dianion with a metallahalide derivative to obtain a metallasulfur derivative and a halide.

In a further aspect, the invention relates to methods for producing molecular bromine that include the steps of: oxidizing NaBr by loss of electrons to produce a mixture comprising molecular bromine, NaBr₃, and NaBr; reducing Na₂Sₓ comprising a higher rank polysulfide dianion, wherein x is from about 2 to about 6.5, to produce a lower rank polysulfide dianion; and recovering molecular bromine from the mixture of one or more of molecular bromine, NaBr₃, and NaBr. In this aspect, the molecular bromine in the mixture of the molecular bromine, NaBr₃, and NaBr may be recovered by reaction with (TMEDA)Zn(S₆) by contacting the mixture with (TMEDA)Zn(S₆), to produce cyclododecasulfur and (TMEDA)ZnBr₂. In this aspect, the oxidizing and the reducing steps may be carried out in an electrochemical cell comprising a catholyte chamber and an anolyte chamber separated by an ion-selective membrane which is permeable to cations, wherein the Na₂Sₓ is reduced by electrons in the catholyte chamber, and wherein the NaBr is oxidized in the anolyte chamber by loss of electrons to produce the molecular bromine, and the recovering of the molecular bromine may occur by contacting the mixture with an extraction solvent comprising one or more of: CS₂, chlorobenzene, or ethyl acetate, or by heterogeneous azeotropic distillation, which may be carried out in the presence of hydrogen peroxide.

In another aspect, methods and systems are provided that comprise the following steps:
reacting bromide with molecular chlorine to obtain molecular bromine and chloride, for example by reactive distillation;
oxidizing chloride in aqueous solution to obtain molecular chlorine, and reducing water to obtain hydrogen and a hydroxide;
reacting hydrogen with elemental sulfur to obtain hydrogen sulfide;
reacting hydrogen sulfide with a hydroxide to obtain a sulfide; and
reacting a sulfide with elemental sulfur to obtain a polysulfide.

These steps may likewise be advantageously carried out sequentially or simultaneously, with recycle and regeneration of the reactants, as just described. The invention also relates to systems that may be used to carry out these processes.

In yet another aspect, the invention relates to carrying out the following process steps, in which the halogens used are more specifically defined:
oxidizing a bromide in aqueous solution with electrons to obtain molecular bromine, and reducing water in an aqueous solution to produce hydrogen and hydroxide;
reacting hydrogen with elemental sulfur to obtain hydrogen sulfide;
reacting hydrogen sulfide with a hydroxide to obtain a sulfide;
reacting a sulfide with elemental sulfur to obtain a polysulfide salt; and
recovering bromide and molecular bromine from a mixture of one or more of a tribromide, a bromide, and molecular bromine.

In still another aspect, the invention relates to carrying out the following process steps, in which the halogens used are more specifically defined and in which:
a metallasulfur derivative is reacted with molecular bromine to produce S₁₂ and a metallabromide derivative;
the metallasulfur derivative and bromide salt are reformed by the reaction of the metallabromide derivative with a polysulfide salt;
a chloride salt is electrolyzed, or oxidized, to produce molecular chlorine along with water being reduced to form molecular hydrogen and a hydroxide;
molecular chlorine is exchanged by reaction with bromide to produce molecular bromine and a chloride salt;
molecular hydrogen is reacted with elemental sulfur to produce hydrogen sulfide; and
hydrogen sulfide, elemental sulfur, and hydroxide are reacted to produce a polysulfide salt.
   These steps also may be advantageously carried out continuously to form cyclododecasulfur, with recycle and regeneration of the salts used as reactants, as just described. The invention also relates to systems that may be used to carry out these continuous processes.

In another aspect, the invention relates to carrying out the following process steps:
oxidizing a bromide in aqueous solution with removal of electrons to
obtain
   molecular bromine, and reducing water to produce hydrogen and hydroxide;
an optional step of carrying out one or more of the following:
   a. reacting hydrogen with elemental sulfur to obtain hydrogen sulfide;
   b. reacting hydrogen sulfide with a hydroxide to obtain a sulfide;
   c. reacting a sulfide with elemental sulfur to obtain a polysulfide salt; and
   recovering bromide and molecular bromine from a mixture of one or more of a tribromide, a bromide, and molecular bromine.

In another aspect, the invention relates to an integrated process for the production of S₁₂ in which a metallasulfur derivative is reacted with a molecular bromine to produce S₁₂ and a metal dibromide derivative; the metallasulfur derivative and a bromide salt are reformed by the reaction of the metal dibromide derivative and a polysulfide dianion; a bromide is used to produce hydroxide, molecular hydrogen, and molecular halogen oxidizing agent; molecular hydrogen is reacted with elemental sulfur to produce hydrogen sulfide; and hydrogen sulfide, elemental sulfur, and hydroxide are reacted to produce a polysulfide salt.

Thus, according to one aspect of the invention, methods and systems are provided that comprise: reacting a metallasulfur derivative with a molecular halogen, to produce cyclododecasulfur and a metallahalide derivative; and reacting a metallahalide derivative with a polysulfide salt to obtain the metallasulfur derivative and a halide salt.

According to this aspect of the invention, these steps are useful together for the manufacture of cyclic sulfur allotropes, and the products and byproducts of each of the steps is useful in the manufacture of cyclic sulfur allotropes, and for other purposes. The steps may be carried out in sequence, or continually in a continuous process or system. The metallasulfur derivative of the first step may be the same or different than the metallasulfur derivative of the second step. Similarly, the metal halide derivative of the first step may be the same or different than the metal halide derivative of the second step. In fact, any of the elements of each step of the claimed invention may be the same or different than the same named element of a different step.

In another aspect, the invention relates simply to a step of reacting a metallahalide derivative with a polysulfide salt to obtain a metallasulfur derivative and a halide salt, optionally in the presence of elemental sulfur. The step of this aspect of the invention may be performed alone or may be combined with other steps as set out herein or as envisioned by one skilled in the art in light of the present disclosure.

In a further aspect, the invention relates simply to a step of oxidizing halide salts to produce molecular halogen. This step may be carried out alone or may be coupled with a step of reducing a polysulfide salt comprising a higher rank polysulfide dianion to produce a lower rank polysulfide dianion. The polysulfide may correspond to the formula Na₂Sₓ, wherein x is from 2 to 6, or an average of from about 1.8 to about 4.5. The step of this aspect of the invention may be performed alone or may be combined with other steps as set out herein or as envisioned by one skilled in the art in light of the present disclosure.

The methods of the present invention thus may include a step of reacting a metallasulfur derivative with an oxidizing agent, and especially a molecular halogen such as Br₂, to produce cyclododecasulfur and a metallahalide derivative.

According to the invention, a suitable metallasulfur derivative may be generally characterized by the formula

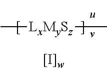

wherein
L is a monodentate or polydentate ligand species which may be the same or different when x>1;
x is the total number of ligand species L and is from 0 to 6 inclusive;
M is a metal atom;
y is the total number of metal atoms and is from 1 to 4 inclusive;
S is a sulfur atom;
z is the number of sulfur atoms, and is from 1 to 12 inclusive;
u represents the charge of the metallasulfur derivative and may be from −6 to +6 inclusive;
v is the number of metallasulfur derivative units in an oligomeric or polymeric structure;
l is an ionic atom or group and may be cationic or anionic;
and w is the number of cationic or anionic atoms or groups, as required to provide charge neutrality.

The ligand species may be mono- or polydentate and may be charged or neutral. Suitable ligand species are cyclopentadienyl or substituted cyclopentadienyl rings; amines such as primary, secondary, and tertiary alkyl or aryl linear or cyclic amines and may also be diamines or triamines or other polyamines such as ethylenediamine and ethylenetriamine and their derivatives, piperidine and derivatives, and pyrrolidine and derivatives; or heteroaromatic derivatives such as pyridine and pyridine derivatives or imidazole and imidazole derivatives. Preferred amines include but are not limited to tetraalkyl ethylenediamines, such as tetramethyl ethylenediamine (TMEDA), tetraethyl ethylenediamine, tetrapropyl ethylenediamine, tetrabutyl ethylenediamine; diethylene-triamine and derivatives such as pentamethyldiethylenetriamine (PMDETA); pyridine and derivatives of pyridine, such as bipyridine, 4-(N,N-dimethylaminopyridine (DMAP), picolines, lutidines, quinuclidines; imidazole and derivatives of imidazole such as N-methylimidazole, N-ethylimidazole, N-propylimidazole, and N-butylimidazole.

Suitable metals for the substituent M above include copper, zinc, iron, nickel, cobalt, molybdenum, manganese, chromium, titanium, zirconium, hafnium, cadmium, mercury; and precious and rare earth metals such as rhodium, platinum, palladium, gold, silver, and iridium. A preferred metal is zinc.

Particularly suitable metallasulfur derivatives for the method of the present invention are metallacyclosulfanes. Preferred metallacyclosulfanes include those depicted below as A, B, C and D. Other metallasulfur derivatives are oligomeric or polymeric species and may be linear as depicted in E below or branched as depicted in F below with the metal atoms serving as branch points.

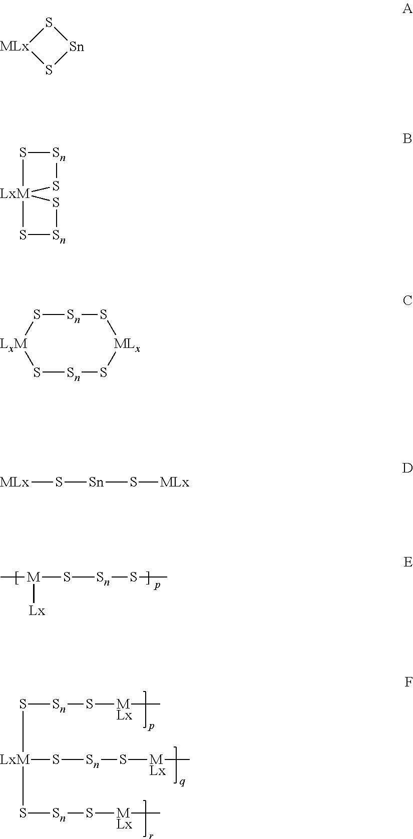

The metallasulfur derivatives of the invention may contain charged ligand species. For instance, a suitable metallasulfur derivative for the formation of a cyclododecasulfur compound is shown below:

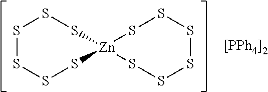

It contains only sulfur atoms bonded to zinc in two metallacyclosulfane rings and two tetraphenyl phosphonium cationic groups to neutralize the dianionic charge of the metallasulfur derivative.

A related metallasulfur derivative which contains ligands is illustrated below:

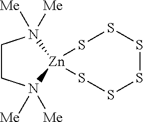

In this case a TMEDA ligand coordinated to zinc replaces a hexasulfide dianion, and thus the metallasulfur derivative is not anionic, it is neutral.

A particularly preferred class of metallacyclosulfanes for the method of the present invention are those containing an N-donor zinc complex. Even more particularly, when the intended cyclic sulfur allotrope is cyclododecasulfur, metallacyclosulfanes having four to six sulfur atoms and N-donor ligands coordinated to zinc may be preferred. Such complexes are formed by reacting elemental sulfur, also referred to herein as cyclooctasulfur or S₈, with metallic zinc in a solvent composed of, or containing, a donor amine, diamine or polyamine templating agent as described in more detail below. Examples of N-donor-zinc-cyclosulfanes include (TMEDA)Zn(S₆), (DMAP)₂Zn(S₆), (pyridine)₂Zn(S₆), (methylimidazole)₂Zn(S₆), (quinuclidine)₂Zn(S₆), (PMDETA)Zn(S₄), and (bipyridine)₂Zn(S₆). The zinc complex, (TMEDA)Zn(S₆), is a particularly preferred metallacyclosulfane in the method of the present invention and can be formed by reacting cyclooctasulfur, tetramethylethylene-diamine and zinc. We have found that these metallacyclosulfane-forming reactions are best accomplished in the presence of water, as in the examples in which the addition of water consistently produced (TMEDA)Zn(S₆) complex in high yields and purity even with low grade TMEDA.

U.S. Pat. No. 6,420,581, the disclosure of which is incorporated herein by reference, relates to processes of producing zinc hexasulfide amine complexes that are suitable for use according to the present invention. These processes comprise reacting zinc, sulfur and a molar excess of amine at an elevated temperature to obtain a reaction mixture comprising zinc hexasulfide amine complexes and excess amine. A first solvent in which the zinc hexasulfide amine complexes are largely not soluble is added to obtain a slurry of the reaction mixture. The zinc hexasulfide amine complexes may be recovered in a subsequent separation process.

The metallasulfur derivatives of the methods of the present invention may also be formed by reacting elemental sulfur with a sulfur templating agent. Accordingly, in one aspect, the method of the present invention may include a step of reacting elemental sulfur with a sulfur templating agent to form a metallasulfur derivative prior to the step of reacting the metallasulfur derivative with an oxidizing agent.

Suitable sulfur templating agents for use in this embodiment of the method of the present invention include those characterized by the formula:

LₓM_{y}
wherein
   L is a monodentate or polydentate ligand species which may be the same or different when x>1;
x is the total number of ligand species L and is from 1 to 6 inclusive;
M is a metal atom; and
y is the total number of metal atoms and is from 1 to 4 inclusive.

The ligand species may be mono- or polydentate. Suitable ligand species are cyclopentadienyl or substituted cyclopentadienyl rings; amines such as primary, secondary, and tertiary alkyl or aryl linear or cyclic amines and may also be diamines or triamines or other polyamines such as ethylenediamine and ethylenetriamine and their derivatives, piperidine and derivatives, and pyrrolidine and derivatives; or heteroaromatic derivatives such as pyridine and pyridine derivatives or imidazole and imidazole derivatives.

Preferred amines include but are not limited to tetraalkyl ethylenediamines, such as tetramethyl ethylenediamine (TMEDA), tetraethyl ethylenediamine, tetrapropyl ethylenediamine, tetrabutyl ethylenediamine; diethylene-triamine and derivatives such as pentamethyldiethylenetriamine (PMDETA); pyridine and derivatives of pyridine, such as bipyridine, 4-(N,N-dimethylaminopyridine (DMAP), picolines, lutidines, quinuclidines; imidazole and derivatives of imidazole such as N-methylimidazole, N-ethylimidazole, N-propylimidazole, and N-butylimidazole.

Suitable metals for the substituent M are as defined above. A preferred metal is zinc.

In the methods of the present invention, the above-described metallasulfur derivative is reacted with molecular halogen, such as Br₂, as an oxidizing agent. Appropriate oxidizing agents include those which are reduced by a metallasulfur derivative and promote the release of the sulfur contained in the metallasulfur derivative. In addition, the oxidizing agent ideally does not add sulfur from its composition to the cyclododecasulfur being produced in the process.

Preferably, the oxidizing agent for the method of the present invention is molecular halogen, and especially molecular or diatomic bromine (Br₂). In the method of the present invention, the stoichiometry of the oxidizing agent to the metallasulfur derivative may depend on its composition and structure. In one embodiment, the stoichiometric ratio of the oxidizing agent to the metallasulfur derivative is selected so that one equivalent of oxidizing agent (Br₂) is present for every two M-S bonds in the metallasulfur derivative. For the production of a cyclododecasulfur compound, if the metallasulfur derivative has one metal-sulfur bond for every three sulfur atoms then one equivalent of an oxidizing agent (Br₂) may be combined with a weight of metallasulfur derivative equal to six equivalents of sulfur. Examples of suitable ratios of oxidizing agent to metallasulfur derivative include: 1 mole of (TMEDA)Zn(S₆) to 1 mole of Br₂; 1 mole of [PPh₄]₂[Zn(S₆)₂] to 2 moles of Br₂; 1 mole of (N-methyl imidazole)₂Zn(S₆) to 1 mole of Br₂; 1 mole of (PMDETA)Zn(S₄) to 1 mole of Br₂.

In another aspect, the stoichiometry may be selected so as to increase the purity of the final cyclododecasulfur product. Thus, in a preferred embodiment, a substoichiometric (i.e. less than one equivalent) ratio of the oxidizing agent to the metallasulfur derivative is selected in order to synthesize a cyclododecasulfur mixture having lower levels of halogens. In this aspect, the stoichiometric ratio of the oxidizing agent to the metallasulfur derivative is selected so that less than one equivalent of the oxidizing agent is present for every two M-S bonds in the metallasulfur derivative. For the production of a cyclododecasulfur compound, if the metallasulfur derivative has one metal-sulfur bond for every three sulfur atoms then substoichiometric amounts of an oxidizing agent (Br₂) may be combined with a weight of metallasulfur derivative equal to six equivalents of sulfur. In this aspect, examples of suitable ratios of oxidizing agent to metallasulfur derivative include: 1 mole of (TMEDA)Zn(S₆) to 0.90-0.99 mole of Br₂; 1 mole of [PPh₄]₂[Zn(S₆)₂] to 1.80-1.99 moles of Br₂; 1 mole of (N-methyl imidazole)₂Zn(S₆) to 0.90-0.99 mole of Br₂; 1 mole of (PMDETA)Zn(S₄) to 0.90-0.99 mole of Br₂.

The metallasulfur derivative just described is thus reacted with a molecular halogen to produce S₁₂ and a metallahalide derivative, or metal halide derivative. When the metallasulfur derivative is (TMEDA)Zn(S₆), the metallahalide derivative produced is a (TMEDA) ZnBr₂ complex. The (TMEDA)Zn(S₆) complex may be formed in situ, in turn, by reacting the (TMEDA)/ZnBr₂ complex with a polysulfide salt or polysulfide dianion, with by-product formation of a halide. Alternatively, the metallasulfur derivative may be [PPh₄]₂[Zn(S₆)₂], in which case the corresponding metallahalide derivative would be [PPh₄]₂[ZnBr₄]. Similarly, when the metallasulfur derivative is (N-methyl imidazole)₂Zn(S₆), the corresponding metallahalide derivative would be (N-methyl imidazole)₂ZnBr₂, and when the metallasulfur derivative is (PMDETA)Zn(S₄), the corresponding metallahalide derivative would be (PMDETA)ZnBr₂.

In another aspect, the invention may include a step of reacting a metallahalide derivative with a polysulfide salt comprising a polysulfide dianion to obtain a metallasulfur derivative and a halide salt. In one embodiment, this reaction may be depicted as (TMEDA)ZnX₂+Na₂Sₓ+y S→(TMEDA)Zn(S₆)+2NaX, wherein, X is a halogen, and x+y=6.

Suitable metallahalide derivatives include those already described, as well as those that may be depicted generically according to the following formula:

LₓM_{y}Xₙ
wherein
   L is a monodentate or polydentate ligand species which may be the same or different when x>1;
x is the total number of ligand species L and is from 1 to 6 inclusive;
M is a metal atom of valence v;
y is the total number of metal atoms and is from 1 to 4 inclusive.
X is a halide ion; and
n is the total number of halide ions X and is equal to the product vy,
i.e., of metal valance times total number of metal atoms;

In addition to (TMEDA)ZnBr₂, other suitable metallahalide derivatives include N-donor zinc-halides, exemplified by (tetrapropylethylene-diamine)ZnBr₂, (tetrabutylethylenediamine)ZnBr₂, (diethylenetriamine)ZnBr₂, (ethylenediamine)ZnBr₂, [PPh₄]₂[ZnBr₄], (N-methyl imidazole)₂ZnBr₂, (N-ethylimidazole)₂ZnBr₂, (N-propylimidazole)₂ZnBr₂, (N-butylimidazole)₂ZnBr₂, (PMDETA)ZnBr₂, (DMAP)₂ZnBr₂, (pyridine)₂ZnBr₂, (lutidine)₂ZnBr₂, (quinuclidine)₂ZnBr₂, and (bipyridine)₂ZnBr₂.

In such a process, the presence of too much water in a metalla-sulfur derivative reaction zone may be detrimental to high yield formation of the metallasulfur derivative. Accordingly, the polysulfide salt feed stream to the reaction zone may be concentrated to remove excess water by any means known in the art, for example by single or multi-effect evaporation. The resulting concentrated polysulfide salt should preferably comprise less than 70 wt % water, more typically 50 wt % or less. The concentration step may result in precipitation of polysulfide salt or not.

Suitable polysulfide dianions present as polysulfide salts include those that correspond to the formula Na₂Sₓ, in which x is, for example, from about 2 to about 6, or on average from about 1.2 to about 6.5, for example. Those skilled in the art will readily understand that other alkali metals such as potassium, lithium, or cesium may be substituted for sodium, thus K₂Sₓ, Li₂Sₓ, or Cs₂Sₓ, respectively. Alternatively, the polysulfide salts may be quaternary polysulfide salts as already described.

The formation of the metallasulfur derivative may be accomplished by combining the corresponding metal halide with the appropriate polysulfide dianion, optionally in the presence of elemental sulfur, within certain stoichiometric constraints. Defining M as moles of metal atoms, S as moles of sulfur atoms, and X as moles of halide, and L as moles ligand in the metallahalide derivative, these constraints may be delineated as follows, corresponding to the feeds to the metallahalide derivative reaction zone.

The moles of sulfur atoms to metal or cation moles may fall, for example, within a range of 1:2≤S:M≤13:2, wherein the sulfur atoms may or may not be entirely from the monosulfide or polysulfide salt, upon introduction into the reaction zone, but may be introduced instead as elemental sulfur, as long as the average polysulfide salt rank is one or greater, i.e., M₂S_{1.0} or greater.

The average rank of the polysulfide salt introduced into the MHD reaction zone may fall, for example, between about 1.2 and about 6.5. Thus, about M₂S_{1.2} to M₂S_{6.5}. The solubility of the M₂Sₓ species is dependent on temperature and solvent characteristics. We have found that higher solubility is achieved with C₁ to C₄ alkanol solvents than with purely water as solvent.

The ratio of sulfur atoms (as both elemental sulfur and contained in the polysulfide) to moles of metal halide derivative may be in the range, for example, of 4:1≤S:X≤8:1, and is largely determined by the stoichiometric sulfur content, z, of the metallasulfur derivative. Thus, for preparation of (T)Zn(S₆) from (T)ZnBr₂, the ratio S:X may be around 6:1, while for (PMDETA)Zn(S₄) from (PMDETA) ZnBr₂, the ratio S:X may be around 4:1. It is understood that the process may advantageously be carried out with a molar excess of sulfur.

The ratio of moles of metal atoms to moles of metallahalide derivative may be in the range of 2:0.9≤M:X≤2:1.2, preferably metal atoms should be the limiting reagent, thus, 2:1.01≤M:X≤2:1.2.

In one aspect of the method of the present invention, the stoichiometry of the alkali metal polysulfide salt to metal halide derivative may be selected so as to increase the purity of the metallasulfur derivative. Thus, in a preferred embodiment, a substoichiometric (i.e. less than one equivalent) ratio of the polysulfide dianion to the metallahalide derivative is selected, in order to synthesize a metallasulfur derivative mixture having lower levels of unreacted polysulfide. In this aspect, the stoichiometric ratio of the polysulfide to the metallahalide derivative is selected so that less than one equivalent of the polysulfide dianion is present for every metallahalide derivative. In this aspect, examples of suitable ratios of alkali metal polysulfides to metallahalide derivative include: 1 mole of (TMEDA)ZnBr₂ to 0.90-0.99 mole of Na₂Sₓ; 1 mole of [PPh₄]₂[ZnBr₂] to 1.80-1.99 moles of Na₂Sₓ; 1 mole of (N-methyl imidazole)₂ZnBr₂ to 0.90-0.99 mole of Na₂Sₓ; 1 mole of (PMDETA)ZnBr₂ to 0.90-0.99 mole of Na₂Sₓ.

The formation of metallasulfur derivative is enhanced in the presence of excess free ligand. Thus, it is desirable to feed additional ligand to the metallasulfur derivative reaction zone above that which is incorporated in the metallahalide derivative. The ratio of moles of excess ligand to moles of metal halide derivative may be in the range, for example, of 0.1:1≤L:X≤3:1, preferably 0.3:1≤L:X≤2:1.

Alkali metal polysulfide dianions generally exhibit relatively low solubility in many organic solvents such as hydrocarbons, esters, and halohydrocarbons. Favorable solvents for solubilization of alkali metal polysulfides are C₁ to C₄ alkanols, such as methanol, ethanol, n-propanol, isobutanol, n-butanol, 2-butanol. C₁ to C₃ alkanols are favored. Methanol and ethanol are most favored. Depending on polysulfide rank, carbon number of alcohol, and temperature, up to about 50 wt % alkali metal polysulfide salt may be solubilized in alkanols.

The solvent for the alkali metal polysulfide may comprise C₁-C₄ alkanols, with up to about 30 wt % other solvents selected from halogenated solvents of one to 12 carbon atoms and one halogen atom up to perhalogenated content, alkanes of 5 to 20 carbons, aromatics, alkyl aromatics of 7 to 20 carbons, carboxylic acid esters of 2 to 6 carbons, and carbon disulfide. Examples of halogenated solvents include methylene chloride, chloroform, carbon tetrachloride, carbon tetrabromide, methylene bromide, bromoform, bromobenzene, chlorobenzene, chlorotoluenes, dichlorobenzenes, dibromobenzenes. Examples of hydrocarbons are pentanes, hexanes, cyclohexane, heptanes, octanes, decanes, benzene, toluene, xylenes, mesitylene, ethyl benzene and the like. Examples of esters are methyl formate, methyl acetate, ethyl formate, n-propyl acetate, i-propyl acetate, i-propyl formate, ethyl acetate, n-propyl formate, i-butyl acetate, n-butyl acetate, sec-butyl acetate, i-propyl propionate, n-propyl propionate, ethyl propionate, i-butyl formate, n-butyl formate, sec-butyl formate, and the like. One or more combinations of solvents may also be utilized. Said combination of solvents may result in the formation of two liquid phases in the reaction effluent, without detriment to the reaction yield or extent.

The metallahalide derivative may be introduced into the reaction zone as a dissolved solid or as a slurry in a solvent or solvent mixture. Suitable solvents for the metal halide are C₁-C₄ alkanols, halogenated solvents of 1 to 12 carbon atoms and one halogen atom up to perhalogenated content, and carbon disulfide. Examples of halogenated solvents include methylene chloride, chloroform, carbon tetrachloride, carbon tetrabromide, methylene bromide, bromoform, bromobenzene, chlorobenzene, chlorotoluenes, dichlorobenzenes, dibromobenzenes. Examples of alkanols are methanol, ethanol, n-propopanol, isobutanol, n-butanol, 2-butanol. C₁ to C₃ alkanols are favored. Methanol and ethanol are most favored. The metallahalide derivative may be dissolved or slurried in the solvent or solvent mixture at up to about 70 wt %, more typically at 5 to 50 wt %.

The reacting of the metallahalide derivative to form the metallasulfur derivative may be performed at a wide range of temperatures, pressures, and concentration ranges. The reaction may be accomplished at 0 to 85° C., or from 20 to 75° C., at a pressure sufficient to keep the reactants largely in the liquid phase. Alternatively, the reaction may be operated at a pressure to allow partial vaporization of the reaction mixture to help control the heat of reaction, i.e., from about 0.5 to 6 bara. When operated as a continuous process, the metallasulfur derivative formation reaction may be operated such that the effluent stream comprises, for example, from about 5 wt % to about 40 wt % or more metallasulfur derivative.

The products of the metallasulfur derivative reaction, i.e., the metallasulfur derivative and the halide salt, differ significantly in solubility in various solvents. As such, the metallasulfur derivative and the halide salt may be separated by any means known in the art exploiting such physical property differences. Such separation methods include but are not limited to extraction (e.g., with water), crystallization, precipitation, sedimentation, membrane permeation, filtration, and the like.

In a further aspect, the invention includes a step of oxidizing a halide salt to produce molecular halogen. For example, this step may be accomplished in an electrolysis cell, as further elaborated below, in which other reactions occur simultaneously or continuously, for example a step of reducing a polysulfide salt comprising a higher rank polysulfide dianion to produce a lower rank polysulfide dianion, as depicted in the following reaction schemes:

2NaX+Na₂Sₓ→X₂+2Na₂S_{(x/2)}

(x/2 is the approximate stoichiometry, but x is a distribution, and it is understood that electrons are moving between the oxidant and reductant)

NaX+X₂←→NaX₃

Na₂S_{(x/2)}+x/2→Na₂Sₓ

In the first reaction above, two moles of alkali metal halide are oxidized in the anolyte chamber of an electrochemical cell to produce one mole of molecular halogen. This reaction may be coupled in an electrochemical cell with the reduction of a higher-rank polysulfide dianion to obtain a correspondingly lower rank polysulfide dianion in the catholyte chamber, with the stoichiometry understood to be approximate. The second reaction depicted describes an equilibrium of an alkali metal halide, molecular halogen, and an alkali metal trihalide. The equilibrium may be affected, as described elsewhere herein, by removing one or more of the alkali metal halide, molecular halogen, or the trihalide, each by any suitable method. In the third reaction, a higher rank polysulfide dianion is regenerated by reacting a lower rank polysulfide dianion with elemental sulfur. Those skilled in the art will understand that various sources of sulfur may be used according to this step, with elemental sulfur being both economical and readily available. Each of the three reactions depicted are further elaborated elsewhere herein.

The step of reducing an alkali metal polysulfide salt comprising a higher rank polysulfide dianion to produce a lower rank metal polysulfide dianion may be coupled with the step of oxidizing an alkali metal halide salt to produce a molecular halogen, which as noted results in a mixture comprising one or more of an alkali metal trihalide, an alkali metal halide, and elemental halogen, and typically a mixture of all three.

According to one aspect of the present invention then, methods are provided as just described that comprise the following steps: reacting a metallasulfur derivative with a molecular halogen, to produce S₁₂ and a metallahalide derivative; reacting the metallahalide derivative with a polysulfide to obtain the metallasulfur derivative and a halide; and oxidizing the halide salt to produce molecular halogen coupled with the reduction of a higher rank polysulfide dianion to a lower rank polysulfide dianion. The steps may be advantageously carried out continuously to form cyclododecasulfur, with recycle and regeneration of the salts used as reactants, as just described. The invention also relates to systems that may be used to carry out these continuous processes, as further elaborated below. Further steps may optionally be carried out according to the invention in place of or in addition to the process steps just recited.

An objective of the present invention is thus to provide an economical means for recycle of by-product salts derived from the synthesis of S₁₂. In one aspect, then, this invention relates to methods and systems for the regeneration of a molecular bromine (Br₂) oxidant from an alkali metal bromide by-product of the synthesis of S₁₂, formed via the reaction of a metallasulfur derivative and molecular halogen oxidant, and producing a metallahalide derivative.

Further, the invention relates also to processes and systems for the generation of an alkali metal polysulfide salt derived from the alkali metal bromide by-product of S₁₂ synthesis. The alkali metal polysulfide salt is useful for the recycle and reconversion of the by-product metallabromide derivative back into the metallasulfur derivative used in the synthesis of S₁₂. Thus, in one aspect, the present invention relates to an integrated process for the production of S₁₂ in which: a metallasulfur derivative is reacted with molecular halogen to produce S₁₂ and a corresponding metallahalide derivative; the metallahalide derivative is then converted back to a metallasulfur derivative by reaction with a polysulfide dianion which coproduces a halide; and the alkali metal halide is then oxidized to produce molecular halogen, which is coupled with reduction of a polysulfide from a higher to a lower rank. In another aspect, the invention relates to the integrated steps of: oxidizing an alkali metal halide salt to produce a molecular halogen; reducing an alkali metal polysulfide salt comprising a higher rank polysulfide dianion to produce a lower rank metal polysulfide dianion; and recovering molecular halogen from a mixture of one or more of an alkali metal trihalide, an alkali metal halide and molecular halogen. This aspect may further comprise recovering an alkali metal halide from a mixture of one or more of an alkali metal trihalide, an alkali metal halide, and molecular halogen.

Synthesis methods for S₁₂ are thus provided with high yield and may involve the reaction of a metallasulfur derivative, preferably the (TMEDA)Zn(S₆) complex, with an oxidizing agent, preferably molecular bromine (Br₂), to produce S₁₂ and a by-product metallabromide derivative, such as (TMEDA)ZnBr₂ complex. As noted, the metallasulfur derivatives such as (TMEDA)Zn(S₆) may be reformed by the recycle of the by-product metal dibromide, such as a (TMEDA)ZnBr₂ complex, and its reaction with a polysulfide dianion, such as Na₂Sₓ, wherein x may be on average from about 1.2 to about 6.5, that is 1.2<x<6.5; and optionally elemental sulfur species, y Sₙ, in which n denotes any sulfur allotrope, typically n≥5 up to about 30, or n is very large, i.e., with polymeric sulfur; and wherein the expression (y*n)+x≥6 is satisfied. The reaction allows for recycle of the amine ligand and zinc species together as a zinc complex metallahalide derivative and also produces an alkali metal bromide (e.g., NaBr) as a by-product. Such alkali metal halides may be conveniently recycled by electrochemical cell to produce a molecular halogen (e.g., Br₂) and coupled with the production of lower rank metal polysulfide dianions (e.g., Na₂Sₓ, with 1.2<x<6.5) as already described. Thus, by the methods described in the instant invention all by-product salts and necessary intermediates in S₁₂ synthesis may be recycled essentially in entirety without generation of unusable waste streams.

In a further aspect, it will be understood that additional process steps may be performed, as already described, such that the invention relates to a process comprising the following steps:
reacting a metallasulfur derivative with a molecular halogen, to produce S₁₂ and a metallahalide derivative;
reacting a metallahalide derivative with polysulfide salt to obtain a metallasulfur derivative and a halide, optionally in the presence of elemental sulfur;
reducing a higher rank polysulfide dianion to produce a lower rank polysulfide dianion, coupled with the oxidation of a halide to yield molecular halogen or a trihalide, for example in an electrolysis cell;
optionally reacting a lower rank polysulfide dianion with elemental sulfur to obtain a higher rank polysulfide dianion;
recovering molecular halogen from a mixture of one or more of a trihalide, a halide and molecular halogen; and
recovering a halide from a mixture of one or more of a trihalide, a halide, and molecular halogen.

These steps may likewise be advantageously carried out sequentially or simultaneously, and especially continuously to form cyclododecasulfur, with recycle and regeneration of the reactants, as just described. The invention also relates to systems that may be used to carry out these processes. According to this aspect, reacting a higher rank polysulfide salt with a halide may be carried out in the presence of electrons to produce a lower rank polysulfide salt, and one or more of a trihalide, a halide, or molecular halogen, for example in an electrolysis cell. In this aspect, it is not critical that the lower rank polysulfide dianion be reacted with sulfur in a discrete step to obtain the higher rank polysulfide dianion. Those skilled in the art will understand that the elemental sulfur may alternatively be provided at another step, as already described, such that the lower rank polysulfide dianion may be converted to a higher rank polysulfide dianion in the same “step” in which it is produced. The steps related to recovering molecular halogen and a halide, respectively, are further elaborated upon elsewhere herein.

In yet another aspect, then, the invention relates to processes that may include the following steps, in which the halogens used are more specifically defined:
reacting a metallasulfur derivative with molecular bromine, to produce S₁₂ and a corresponding metal dibromide derivative;
reacting a metal dibromide derivative with a polysulfide salt to obtain a metallasulfur derivative and bromide, optionally in the presence of elemental sulfur;
reacting a bromide salt with molecular chlorine to obtain molecular bromine and a chloride;
oxidizing a chloride in aqueous solution to obtain molecular chlorine coupled with hydrogen and hydroxide production; and
an optional step of carrying out the following steps:
reacting hydrogen with elemental sulfur to obtain hydrogen sulfide;
reacting hydrogen sulfide with a hydroxide to obtain a sulfide;
reacting a sulfide with elemental sulfur to obtain a polysulfide salt.
   These steps also may be advantageously carried out continuously to form cyclododecasulfur, with recycle and regeneration of the salts used as reactants, as already described. The invention also relates to systems that may be used to carry out these continuous processes.

Alternatively, in a further aspect, encompassing only some of the preceding steps, an invention is provided that comprises reacting an alkali metal bromide with molecular chlorine to obtain molecular bromine and alkali metal chloride; oxidizing an alkali metal chloride in aqueous solution with electrons to obtain molecular chlorine, hydrogen, and reducing water to obtain an alkali metal hydroxide, for example in a chloralkali cell; reacting hydrogen with elemental sulfur to obtain hydrogen sulfide; reacting hydrogen sulfide with an alkali metal hydroxide to obtain an alkali metal sulfide; and reacting an alkali metal sulfide with elemental sulfur to obtain an alkali metal polysulfide salt.

According to these aspects of the invention, certain steps may be analogous to those already described generically with respect to halogens and halides, but according to this aspect, the oxidizing agent is specifically molecular bromine (Br₂) and a metallabromide derivative and an alkali metal bromide salt are obtained. The alkali metal bromide salt is reacted with molecular chlorine to obtain molecular bromine, as well as alkali metal chloride which is reduced with electrons, for example in an electrolysis cell, to obtain molecular chlorine, hydrogen, and alkali metal hydroxide. The further steps described may be used to recover the hydrogen and alkali metal hydroxide to obtain a polysulfide dianion, by reacting hydrogen with elemental sulfur to obtain hydrogen sulfide, reacting the hydrogen sulfide with an alkali metal hydroxide to obtain an alkali metal sulfide, and reacting an alkali metal sulfide with elemental sulfur to obtain the polysulfide dianion. These steps may likewise be carried out sequentially or continuously, and may be combined or may be separated into discrete reactions in separate reaction zones, as further elaborated elsewhere herein.

Thus, in this aspect of the invention, certain of the steps just recited may be presented herein in equation form. Thus, in one aspect, a step is provided according to the equation in which 2 (TMEDA)Zn(S₆)+2 Br₂→S₁₂+2 (TMEDA)ZnBr₂. In a further aspect, a step is provided according to the equation (TMEDA)ZnBr₂+Na₂Sₓ+y Sₙ→(TMEDA)Zn(S₆)+2 NaBr, wherein, x+(y*n)=6. Similarly, a further aspect provides a step that may be depicted in the following equilibrium equation 2 NaBr+Cl₂←→NaCl+Br₂. Likewise, a further aspect is provided that may be depicted according to the following: 2 NaCl→Cl₂+2 e− (cathode) and H₂O+2 Na⁺+2 e⁻→H₂+2 NaOH (anode). We note that this step may be advantageously carried out in an electrochemical cell provided with an electric current as a source of electrons, as further elaborated below. Finally, optional step e) may be carried out according to the following equations: y Sₙ+H₂←→H₂S, wherein the product (y*n)=1; H₂S+2NaOH←→Na₂S+2H₂O; and Na₂S+(x−1)y Sₙ→Na₂S_{xyn}, with 1.8≤xyn≤6. Alternatively, an alkoxide may be used in place of hydroxide as disclosed elsewhere herein.

According to this aspect of the invention, certain of the steps are as already described. The alkali metal halide salt is oxidized with loss of electrons, for example in an electrolysis cell, to obtain molecular halogen, hydrogen, and an alkali metal hydroxide such as NaOH. In further steps, hydrogen is reacted with elemental sulfur to obtain hydrogen sulfide, hydrogen sulfide is reacted with an alkali metal hydroxide to obtain an alkali metal sulfide, and an alkali metal sulfide is reacted with elemental sulfur to obtain an alkali metal polysulfide salt. In a further step, an alkali metal halide is recovered from a mixture of one or more of an alkali metal trihalide, an alkali metal halide, and molecular halogen. These steps may likewise be carried out sequentially or continuously, and may be combined or may be separated into discrete reactions in separate reaction zones, as further elaborated elsewhere herein.

Further aspects and areas of applicability will become apparent from the description provided herein.

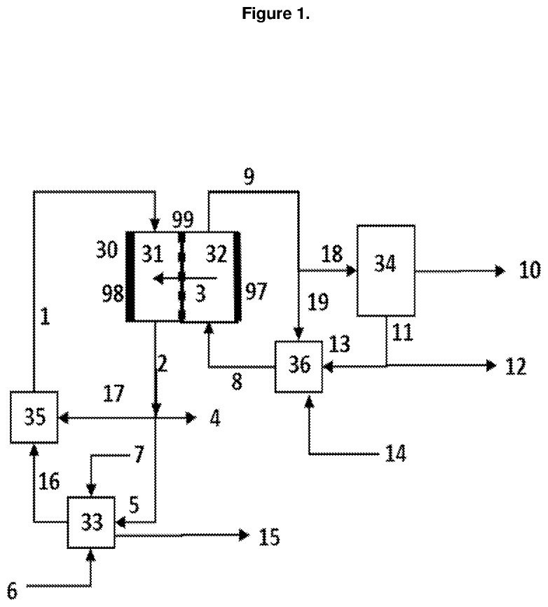

In a further aspect, the invention relates to systems for carrying out the steps and processes as already described, especially continuous processes. Thus, in yet another aspect as shown in in FIG. 1, an electrochemical (electrolysis) cell 30 is provided that includes a catholyte chamber 31 containing a cathode 98, an anolyte chamber 32 containing an anode 97. An external direct current energy supply, not pictured, is connected between the anode and cathode. The cathode and the anode may be a flow-through electrode or a flow-by electrode, independently of one another, without limitation. The catholyte chamber 31 and the anolyte chamber 32 are separated by an ion-selective membrane 99 which is permeable to cations, that is, is permeable to positive alkali metal ions such as lithium, sodium, and potassium, but substantially impermeable to anions such as bromide, chloride, sulfide, and polysulfide ions. A catholyte mixture is fed to the catholyte chamber 31 via line 1 from catholyte storage 35 that comprises an aqueous alkali metal polysulfide salt, such as Na₂Sₓ, for example wherein 1.8≤x≤4.5, that includes both alkali metal ions and polysulfide dianions. An anolyte mixture is fed via stream 8 to the anolyte chamber 32 from anolyte storage 36 that comprises an aqueous solution that includes one or more of an alkali metal halide salt, an alkali metal trihalide salt, and molecular halogen, and more typically a mixture of all three.

In operation, a catholyte mixture comprising a higher rank aqueous alkali metal polysulfide solution is present in catholyte chamber 31 of electrochemical cell 30, and alkali metal ions and water comprising stream 3 pass through the ion-selective separator membrane 99 by charge migration to combine at the cathode 98 with the higher rank alkali metal polysulfide dianion to produce a lower rank alkali metal polysulfide dianion catholyte effluent of stream 2. A portion of the aqueous alkali metal halide salt 8 of the anolyte mixture in the anolyte chamber 32 of the electrochemical cell 30, is oxidized to molecular halogen at the anode 97 and the charge migration referred to thus occurs by movement of the alkali metal ions across the ion-selective separator membrane according to stream 3 as just mentioned.

Catholyte effluent 2 is fed from the catholyte chamber 31 via line 5 to polysulfide regeneration zone 33. A separate fraction, stream 17 of catholyte effluent 2, may be recycled directly to catholyte storage 35 without further treatment. Yet another separate fraction of catholyte effluent 2, stream 4, may be used for preparation of a metallasulfur derivative, and subsequent production of S₁₂ via reaction of the metallasulfur derivative, for example with the molecular bromine stream 10 as described elsewhere herein. In the polysulfide regeneration zone 33, makeup water 7 and elemental sulfur 6 are combined and allowed to react with the lower rank alkali metal polysulfide dianion of the catholyte effluent of stream 5 to regenerate a higher rank aqueous alkali metal polysulfide dianion solution of stream 16 for recycle to electrochemical cell 30 via catholyte storage 35. Sufficient sulfur and water must be added into polysulfide regeneration zone 33 to maintain the desired overall polysulfide rank and polysulfide concentration in catholyte storage 35. A fraction of the higher rank aqueous alkali metal polysulfide dianion solution may exit polysulfide regeneration zone 33 via stream 15 for uses such as preparation of a metallasulfur derivative, and subsequent production of S₁₂ via reaction of the metallasulfur derivative with the molecular halogen stream 10.

A portion of an equilibrium mixture of alkali metal halide, trihalide, and molecular halogen comprising anolyte effluent stream 9 is conveyed via stream 18 to molecular halogen recovery zone 34, wherein purified molecular halogen exits via line 10 and an alkali metal halide mixture depleted of trihalide and molecular halide comprises effluent stream 11. A fraction of effluent stream 11, may be removed via purge stream 12 to prevent build-up of impurities which may interfere with the operation of electrochemical cell 30 or halogen recovery zone 34. The remaining unpurged fraction of effluent stream 11, stream 13, make-up bromide stream 14, and stream 19, a portion of anolyte effluent stream 9, are combined in anolyte storage 36 to maintain alkali metal halide concentration in aqueous alkali metal halide solution 8, the feed to the anolyte chamber 32 of electrochemical cell 30.

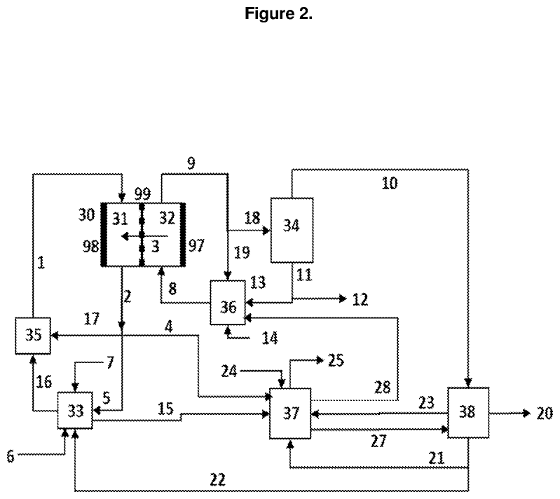

In another embodiment of the present invention, shown in FIG. 2, an integrated process for the production of S₁₂ is illustrated in which: a metallasulfur derivative is reacted with molecular bromine to produce S₁₂ and a metallabromide derivative; the metallasulfur derivative and sodium bromide are reformed by the reaction of the metallabromide derivative and an alkali metal polysulfide salt; and the sodium bromide salt is used to produce molecular halogen coupled to rank reduction of polysulfide dianion in the catholyte.

In the embodiment depicted in FIG. 2, an electrochemical cell 30 is provided that includes a catholyte chamber 31 containing a cathode 98, an anolyte chamber 32 containing an anode 97, and an external direct current energy supply connected between the anode and cathode. The cathode and the anode may be a flow-through electrode or a flow-by electrode, independently of one another, without limitation. The catholyte chamber 31 and the anolyte chamber 32 are separated by an ion-selective separator membrane 99 which is permeable to cations, that is, is permeable to positive alkali metal ions such as lithium, sodium, and potassium, but substantially impermeable to anions such as bromide, chloride, sulfide, and polysulfide ions. A catholyte mixture is fed to the catholyte chamber 31 via line 1 from catholyte storage 35 that comprises an aqueous alkali metal polysulfide salt, such as Na₂Sₓ, for example wherein 1.8×4.5, that includes alkali metal ions. An anolyte mixture is fed via stream 8 to the anolyte chamber 32 from anolyte storage 36 that comprises an aqueous solution that includes one or more of an alkali metal halide salt, an alkali metal trihalide salt, and molecular halogen, and more typically a mixture of all three.

In operation, a catholyte mixture comprising a higher rank aqueous alkali metal polysulfide dianion solution is present in catholyte chamber 31 of electrochemical cell 30, and alkali metal ions and water comprising stream 3 pass through the ion-selective separator membrane 99 by charge migration to combine at the cathode 98 with the higher rank alkali metal polysulfide dianion to produce a lower rank alkali metal polysulfide catholyte effluent of stream 2. A portion of the aqueous alkali metal halide salt 8 of the anolyte mixture in the anolyte chamber 32 of the electrochemical cell 30, is oxidized to molecular halogen at the anode 97 and the charge migration referred to thus occurs by movement of the alkali metal ions across the ion-selective separator membrane according to stream 3 as just mentioned.

Catholyte effluent 2 is fed from the catholyte chamber 31 via line 5 to polysulfide regeneration zone 33. A separate fraction, stream 17 of catholyte effluent 2, may be recycled directly to catholyte storage 35 without further treatment. Yet another separate fraction of catholyte effluent 2, stream 4, may be used for preparation of metallasulfur derivative in the MSD-reaction zone 37. In polysulfide regeneration zone 33, makeup water 7, elemental sulfur 6, and optionally recycle sulfur of stream 22, are combined and allowed to react with the lower rank alkali metal polysulfide dianion catholyte effluent of stream 5 to regenerate a higher rank aqueous alkali metal polysulfide solution of stream 16 for recycle to electrochemical cell 30 via catholyte storage 35. Sufficient sulfur and water should be added into the polysulfide regeneration zone 33 to maintain the desired overall polysulfide rank and polysulfide concentration in catholyte storage 35. A fraction of the higher rank aqueous polysulfide dianion solution may exit the PSR zone 33 via stream 15 for uses such as preparation of metallasulfur derivative in MSD-reaction zone 37.

A portion of an equilibrium mixture of alkali metal halide, trihalide, and molecular halogen comprising anolyte effluent stream 9 is conveyed via stream 18 to molecular halogen recovery zone 34, wherein purified molecular halogen exits via line 10 and an alkali metal halide mixture depleted of trihalide and molecular halogen comprises effluent stream 11. A fraction of effluent stream 11, may be removed via purge stream 12 to prevent build-up of impurities which may interfere with the operation of electrochemical cell 30 or halogen recovery zone 34. The remaining unpurged fraction of effluent stream 11, stream 13, make-up alkali metal halide stream 14, stream 19, a portion of anolyte effluent stream 9, and by-product alkali metal halide stream 28 from the metallasulfur derivative reaction zone 37, are combined in anolyte storage 36 to maintain alkali metal halide concentration in aqueous alkali metal halide solution 8, the feed to the anolyte chamber 32 of electrochemical cell 30.

In MSD-reaction zone 37, the desired metallasulfur derivative is regenerated by the reaction of an alkali metal polysulfide salt, elemental sulfur, and a metallahalide derivative. Polysulfide streams 4 and 15 may be concentrated by evaporation of water via line 18 and mixed with alkanol stream 24 to produce an alcoholic alkali metal polysulfide salt. Said alcoholic alkali metal polysulfide salt is combined and reacted with necessary additional recycle sulfur via line 21, and by-product metallahalide derivative-containing stream 23 to produce stream 27 comprising the desired metallasulfur derivative and stream 28 comprising by-product alkali metal halide.

In the S₁₂ reaction zone 38, metallasulfur derivative of stream 27 and molecular halogen oxidant of stream 10 are combined and reacted to produce stream 20 comprising S₁₂, stream 23 comprising by-product metal halide derivative, and streams 21 and 22 comprising sulfur allotropes.

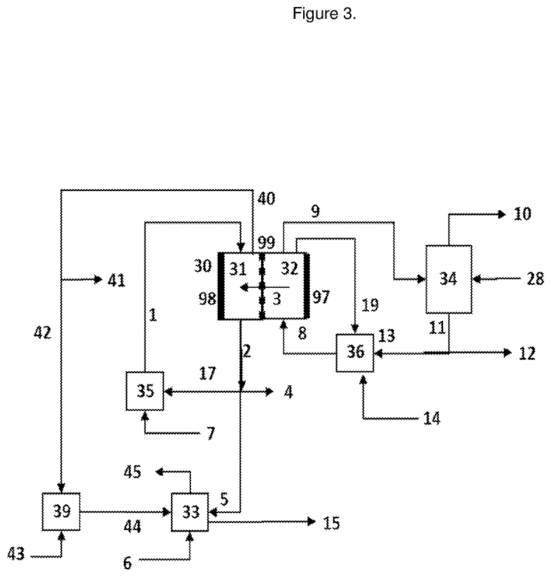

In a further aspect, the invention relates to a system for electrochemical regeneration of molecular bromine, with concomitant production of hydrogen and alkali metal hydroxide, and with subsequent integration into a process for generation of an alkali metal polysulfide. Thus, in yet another aspect as shown in in FIG. 3, an electrochemical cell 30 is provided that includes a catholyte chamber 31 containing a cathode 98, an anolyte chamber 32 containing an anode 97, and an external direct current energy supply connected between the anode and cathode, not pictured. The cathode and the anode may be a flow-through electrode or a flow-by electrode, independently of one another, without limitation. The catholyte chamber 31 and the anolyte chamber 32 are separated by an ion-selective membrane 99 which is permeable to cations, that is, is permeable to positive alkali metal ions such as lithium, sodium, and potassium, but substantially impermeable to anions such as bromide, chloride, sulfide, and polysulfide ions. A catholyte mixture is fed to the catholyte chamber 31 via line 1 from catholyte storage 35 that comprises water and optionally alkali metal hydroxide. An anolyte mixture is fed via stream 8 to the anolyte chamber 32 from anolyte storage 36 that comprises an aqueous solution that comprises an alkali metal bromide salt, and molecular bromine.

In operation, a catholyte mixture comprising water and an alkali metal hydroxide is present in catholyte chamber 31 of electrochemical cell 30 operating as a chloralkali electrochemical cell, and alkali metal ions and water comprising stream 3 pass through the ion-selective separator membrane 99 by charge migration, combining with hydroxide ions produced by water splitting at the cathode 98 to produce an alkali metal hydroxide-containing catholyte effluent of stream 2. Molecular hydrogen is co-produced with hydroxide ions at the cathode 98, and said hydrogen exits catholyte chamber 31 via line 40. A portion of the aqueous alkali metal chloride salts 8 of the anolyte mixture in the anolyte chamber 32 of the electrochemical cell 30, is oxidized to molecular chlorine at the anode 97 and the charge migration referred to thus occurs by movement of the alkali metal ions across the ion-selective separator membrane according to stream 3 as just mentioned.

Catholyte effluent 2 is fed from the catholyte chamber 31 via line 5 to polysulfide generation zone 33. A separate fraction, stream 17 of catholyte effluent 2, may be recycled directly to catholyte storage 35 without further treatment. Yet another separate fraction, stream 4 of catholyte effluent 2, may exit the system as a source of alkali metal hydroxide for other processes. Makeup water 7 is introduced into catholyte storage 35 to maintain water inventory in the catholyte loop.

A fraction of molecular hydrogen stream 40 may exit the system as a source of molecular hydrogen via stream 41 for other processes, while another fraction via stream 42 is sent to hydrogen sulfide generation zone 39. In hydrogen sulfide generation zone 39, molecular hydrogen is combined with elemental sulfur stream 43 and reacted to produce an effluent stream 44 comprising hydrogen sulfide.

In polysulfide generation zone 33, hydrogen sulfide 44, catholyte fraction 5, comprising aqueous alkali metal hydroxide, and elemental sulfur 6 are combined and allowed to react to generate a higher rank aqueous alkali metal polysulfide dianion solution of stream 15 for uses such as preparation of a metallasulfur derivative, and subsequent production of S₁₂ via reaction of the metallasulfur derivative with the molecular bromine stream 10. If the catholyte fraction 5 contains too much water for the desired concentration of higher rank aqueous alkali metal polysulfide dianion solution of stream 15, water may be removed via stream 45 from either the catholyte fraction 5 prior to reaction with hydrogen sulfide and elemental sulfur, or after formation of a higher rank aqueous alkali metal polysulfide dianion solution.

Molecular chlorine produced at the anode exiting the anolyte chamber via stream 9 is conveyed to bromine recovery zone 34, wherein molecular bromine stream 10 is produced by the interchange reaction of alkali metal bromide stream 28 with molecular chlorine 9. A mixture comprising aqueous alkali metal chloride, depleted of bromide and molecular bromine content comprises effluent stream 11. A fraction of effluent stream 11, may be removed via purge stream 12 to prevent build-up of impurities which may interfere with the operation of electrochemical cell 30 or bromine recovery zone 34. The remaining unpurged fraction of effluent stream 11, stream 13, make-up alkali metal chloride stream 14, and anolyte effluent stream 19, are combined in anolyte storage 36 to maintain alkali metal chloride concentration in aqueous alkali metal chloride solution 8, the feed to the anolyte chamber 32 of electrochemical cell 30.

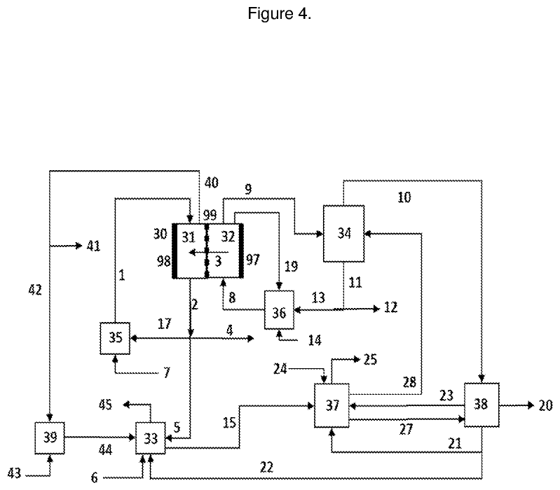

In another embodiment of the present invention, shown in FIG. 4, an integrated process for the production of S₁₂ is illustrated in which: a metallasulfur derivative is reacted with molecular bromine to produce S₁₂ and a metallabromide derivative; the metallasulfur derivative and an alkali metal bromide salt are reformed by the reaction of the metallabromide derivative and an alkali metal polysulfide salt; an alkali metal chloride salt is electrolyzed to produce alkali metal hydroxide, molecular hydrogen, and molecular chlorine; molecular chlorine is exchanged by reaction with bromide to produce molecular bromine and chloride salt; molecule hydrogen is reacted with elemental sulfur to produce hydrogen sulfide; and hydrogen sulfide, elemental sulfur, and alkali metal hydroxide are reacted to produce an alkali metal polysulfide salt.

In the embodiment depicted in FIG. 4, an electrochemical cell 30 is provided that includes a catholyte chamber 31 containing a cathode 98, an anolyte chamber 32 containing an anode 97, and an external direct current energy supply connected between the anode and cathode. The cathode and the anode may be a flow-through electrode or a flow-by electrode, independently of one another, without limitation. The catholyte chamber 31 and the anolyte chamber 32 are separated by an ion-selective membrane 99 which is permeable to cations, that is, is permeable to positive alkali metal ions such as lithium, sodium, and potassium, but substantially impermeable to anions such as bromide, chloride, sulfide, and polysulfide ions. A catholyte mixture is fed to the catholyte chamber 31 via line 1 from catholyte storage 35 that comprises water and optionally alkali metal hydroxide. An anolyte mixture is fed via stream 8 to the anolyte chamber 32 from anolyte storage 36 that comprises an aqueous solution that comprises an alkali metal chloride salt, an alkali metal bromide salt, and molecular halogens.

In operation, a catholyte mixture comprising water and an alkali metal hydroxide is present in catholyte chamber 31 of electrochemical cell 30, and alkali metal ions and water comprising stream 3 pass through the ion-selective separator membrane 99 by charge migration, combining with hydroxide ions produced by water splitting at the cathode 98 to produce an alkali metal hydroxide-containing catholyte effluent of stream 2. Molecular hydrogen is co-produced with hydroxide ions at the cathode 98, and the hydrogen exits catholyte chamber 31 via line 40. A portion of the aqueous alkali metal chloride salts 8 of the anolyte mixture in the anolyte chamber 32 of the electrochemical cell 30, is oxidized to molecular chlorine at the anode 97 and the charge migration referred to thus occurs by movement of the alkali metal ions across the ion-selective membrane according to stream 3 as just mentioned.

Catholyte effluent 2 is fed from the catholyte chamber 31 via line 5 to polysulfide generation zone 33. A separate fraction, stream 17 of catholyte effluent 2, may be recycled directly to catholyte storage 35 without further treatment. Yet another separate fraction, stream 4 of catholyte effluent 2, may exit the system as a source of alkali metal hydroxide for other processes. Makeup water 7 is introduced into catholyte storage 35 to maintain water inventory in the catholyte loop.

A fraction of molecular hydrogen stream 40 may exit the system as a source of molecular hydrogen via stream 41 for other processes, while another fraction via stream 42 is sent to hydrogen sulfide generation zone 39. In hydrogen sulfide generation zone 39, molecular hydrogen is combined with elemental sulfur stream 43 to react and produce an effluent stream 44 comprising hydrogen sulfide.

In polysulfide generation zone 33, hydrogen sulfide 44, catholyte fraction 5, comprising aqueous alkali metal hydroxide, and elemental sulfur 6, and optionally recycle sulfur of stream 22, are combined and allowed to react to generate a higher rank aqueous alkali metal polysulfide dianion solution of stream 15 for uses such as preparation of a metallasulfur derivative, and subsequent production of S₁₂ via reaction of the metallasulfur derivative with the molecular bromine stream 10. If the catholyte fraction 5 contains too much water for the desired concentration of higher rank aqueous alkali metal polysulfide dianion solution of stream 15, water may be removed via stream 45 from either the catholyte fraction 5 prior to reaction with hydrogen sulfide and elemental sulfur, or after formation of a higher rank aqueous alkali metal polysulfide dianion solution.

Molecular chlorine produced at the anode exiting the anolyte chamber via stream 9 is conveyed to bromine recovery zone 34, wherein a molecular bromine stream 10 is produced by the interchange reaction of alkali metal bromide stream 28 with molecular chlorine 9. A mixture comprising aqueous alkali metal chloride, depleted of bromide, and molecular bromine content comprises effluent stream 11. A fraction of effluent stream 11, may be removed via purge stream 12 to prevent build-up of impurities which may interfere with the operation of electrochemical cell 30 or bromine recovery zone 34. The remaining unpurged fraction of effluent stream 11, stream 13, make-up alkali metal chloride stream 14, and anolyte effluent stream 19, are combined in anolyte storage 36 to maintain alkali metal chloride concentration in aqueous alkali metal chloride solution 8, the feed to the anolyte chamber 32 of electrochemical cell 30.

In MSD-reaction zone 37, the desired metallasulfur derivative is regenerated by the reaction of an alkali metal polysulfide dianion salt, elemental sulfur, and a metal bromide derivative. Polysulfide stream 15 may be concentrated by evaporation of water via line 25 and mixed with alkanol stream 24 to produce an alcoholic alkali metal polysulfide salt. Said alcoholic alkali metal polysulfide salt is combined and reacted with necessary additional recycle sulfur via line 21, and by-product metal bromide derivative-containing stream 23 to produce stream 27 comprising the desired metallasulfur derivative and stream 28 comprising by-product alkali metal bromide.

In the S₁₂ reaction zone 38, the metallasulfur derivative of stream 27 and molecular bromine oxidant of stream 10 are combined and reacted to produce stream 20 comprising S₁₂, stream 23 comprising by-product metallabromide derivative, and streams 21 and 22 comprising sulfur allotropes.

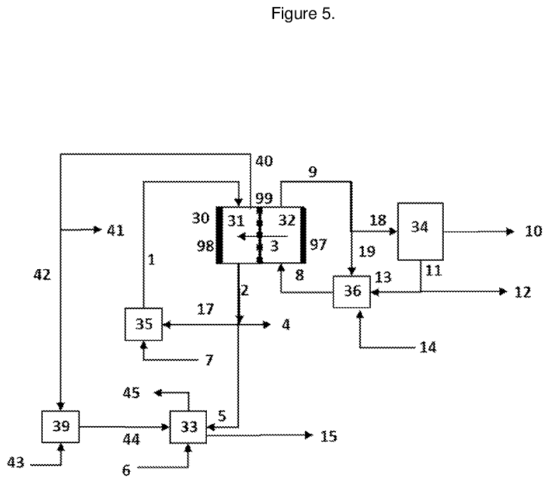

In a further aspect, the invention relates to a system for electrochemical regeneration of molecular bromine, with concomitant production of hydrogen and alkali metal hydroxide, and with subsequent integration into a process for generation of an alkali metal polysulfide. Thus, in yet another aspect as shown in in FIG. 5, an electrochemical cell 30 is provided that includes a catholyte chamber 31 containing a cathode 98, an anolyte chamber 32 containing an anode 97, and an external direct current energy supply connected between the anode and cathode, not pictured. The cathode and the anode may be a flow-through electrode or a flow-by electrode, independently of one another, without limitation. The catholyte chamber 31 and the anolyte chamber 32 are separated by an ion-selective membrane 99 which is permeable to cations, that is, is permeable to alkali metal ions such as lithium, sodium, and potassium, but substantially impermeable to anions such as bromide, chloride, sulfide, and polysulfide ions. A catholyte mixture is fed to the catholyte chamber 31 via line 1 from catholyte storage 35 that comprises water and optionally alkali metal hydroxide. An anolyte mixture is fed via stream 8 to the anolyte chamber 32 from anolyte storage 36 that comprises an aqueous solution that includes one or more of an alkali metal bromide salt, an alkali metal tribromide salt, and molecular bromine, and more typically a mixture of all three.

In operation, a catholyte mixture comprising water and an alkali metal hydroxide is present in catholyte chamber 31 of electrochemical cell 30, and alkali metal ions and water comprising stream 3 pass through the ion-selective membrane 99 by charge migration to combine with hydroxide ions produced by water splitting at the cathode 98 to produce an alkali metal hydroxide-containing catholyte effluent of stream 2. Molecular hydrogen is co-produced with hydroxide ions at the cathode 98, and said hydrogen exits catholyte chamber 31 via line 40. A portion of the aqueous alkali metal bromide salt 8 of the anolyte mixture in the anolyte chamber 32 of the electrochemical cell 30, is oxidized to molecular bromine at the anode 97 and the charge migration referred to thus occurs by movement of the alkali metal ions across the ion-selective separator membrane according to stream 3 as just mentioned.

Catholyte effluent 2 is fed from the catholyte chamber 31 via line 5 to polysulfide generation zone 33. A separate fraction, stream 17 of catholyte effluent 2, may be recycled directly to catholyte storage 35 without further treatment. Yet another separate fraction, stream 4 of catholyte effluent 2, may exit the system as a source of alkali metal hydroxide for other processes. Makeup water 7 is introduced into catholyte storage 35 to maintain water inventory in the catholyte loop.

A fraction of molecular hydrogen stream 40 may exit the system as a source of molecular hydrogen via stream 41 for other processes, while another fraction via stream 42 is sent to hydrogen sulfide generation zone 39. In hydrogen sulfide generation zone 39, molecular hydrogen is combined with elemental sulfur stream 43 to produce an effluent stream 44 comprising hydrogen sulfide.

In polysulfide generation zone 33, hydrogen sulfide 44, catholyte fraction 5, comprising aqueous alkali metal hydroxide, and elemental sulfur 6 are combined and allowed to react to generate a higher rank aqueous alkali metal polysulfide dianion solution of stream 15 for uses such as preparation of a metallasulfur derivative, and subsequent production of S₁₂ via reaction of the metallasulfur derivative with the molecular bromine stream 10. If the catholyte fraction 5 contains too much water for the desired concentration of higher rank aqueous alkali metal polysulfide dianion solution of stream 15, water may be removed via stream 45 from either the catholyte fraction 5 prior to reaction with hydrogen sulfide and elemental sulfur, or after formation of the higher rank aqueous alkali metal polysulfide dianion solution.

A portion of an equilibrium mixture of alkali metal bromide, tribromide, and molecular bromine comprising anolyte effluent stream 9 is conveyed via stream 18 to molecular bromine recovery zone 34, wherein purified molecular bromine exits via line 10 and an alkali metal bromide mixture depleted of tribromide and molecular bromine comprises effluent stream 11. A fraction of effluent stream 11, may be removed via purge stream 12 to prevent build-up of impurities which may interfere with the operation of electrochemical cell 30 or bromine recovery zone 34. The remaining unpurged fraction of effluent stream 11, stream 13, make-up alkali metal bromide stream 14, and stream 19, a portion of anolyte effluent stream 9, are combined in anolyte storage 36 to maintain alkali metal bromide concentration in aqueous alkali metal bromide solution 8, the feed to the anolyte chamber 32 of electrochemical cell 30.

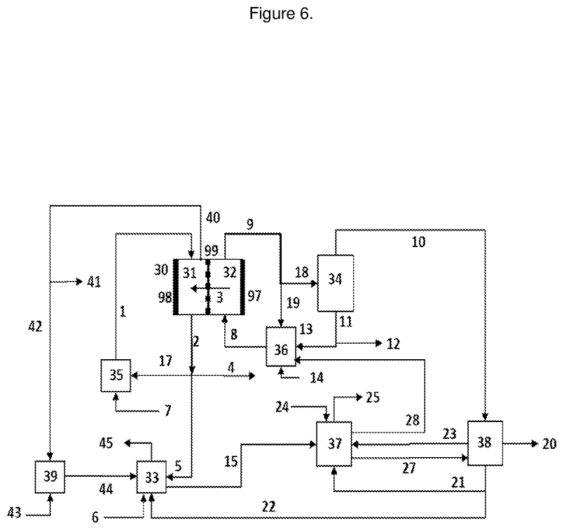

In another embodiment of the present invention, shown in FIG. 6, an integrated process for the production of S₁₂ is illustrated in which: a metallasulfur derivative is reacted with a molecular bromine to produce S₁₂ and a metal dibromide derivative; the metallasulfur derivative and an alkali metal bromide salt are reformed by the reaction of the metal dibromide derivative and an alkali metal polysulfide dianion salt; an alkali metal bromide salt is used to produce alkali metal hydroxide, molecular hydrogen, and molecular halogen oxidizing agent; molecule hydrogen is reacted with elemental sulfur to produce hydrogen sulfide; and hydrogen sulfide, elemental sulfur, and alkali metal hydroxide are reacted to produce an alkali metal polysulfide salt.

In the embodiment depicted in FIG. 6, an electrochemical cell 30 is provided that includes a catholyte chamber 31 containing a cathode 98, an anolyte chamber 32 containing an anode 97, and an external direct current energy supply connected between the anode and cathode. The cathode and the anode may be a flow-through electrode or a flow-by electrode, independently of one another, without limitation. The catholyte chamber 31 and the anolyte chamber 32 are separated by an ion-selective separator membrane 99 which is permeable to cations, that is, is permeable to positive alkali metal ions such as lithium, sodium, and potassium, but substantially impermeable to anions such as bromide, chloride, sulfide, and polysulfide ions. A catholyte mixture is fed to the catholyte chamber 31 via line 1 from catholyte storage 35 that comprises water and optionally alkali metal hydroxide. An anolyte mixture is fed via stream 8 to the anolyte chamber 32 from anolyte storage 36 that comprises an aqueous solution that includes one or more of an alkali metal bromide salt, an alkali metal tribromide salt, and molecular bromine, and more typically a mixture of all three.

In operation, a catholyte mixture comprising water and an alkali metal hydroxide is present in catholyte chamber 31 of electrochemical cell 30, and alkali metal ions and water comprising stream 3 pass through the ion-selective separator membrane 99 by charge migration to combine with hydroxide ions produced by water splitting at the cathode 98 to produce an alkali metal hydroxide-containing catholyte effluent of stream 2. Molecular hydrogen is co-produced with hydroxide ions at the cathode 98, and said hydrogen exits catholyte chamber 31 via line 40. A portion of the aqueous alkali metal bromide salt 8 of the anolyte mixture in the anolyte chamber 32 of the electrochemical cell 30, is oxidized to molecular bromine at the anode 97 and the charge migration referred to thus occurs by movement of the alkali metal ions across the ion-selective separator membrane according to stream 3 as just mentioned.

Catholyte effluent 2 is fed from the catholyte chamber 31 via line 5 to polysulfide generation zone 33. A separate fraction, stream 17 of catholyte effluent 2, may be recycled directly to catholyte storage 35 without out further treatment. Yet another separate fraction, stream 4 of catholyte effluent 2, may exit the system as a source of alkali metal hydroxide for other processes. Makeup water 7 is introduced into catholyte storage 35 to maintain water inventory in the catholyte loop.

A fraction of molecular hydrogen stream 40 may exit the system as a source of molecular hydrogen via stream 41 for unrelated processes, while another fraction via stream 42 is sent to hydrogen sulfide generation zone 39. In hydrogen sulfide generation zone 39, molecular hydrogen is combined with elemental sulfur stream 43 to produce an effluent stream 44 comprising hydrogen sulfide.

In polysulfide generation zone 33, hydrogen sulfide 44, catholyte fraction 5, comprising aqueous alkali metal hydroxide, and elemental sulfur 6, and optionally recycle sulfur of stream 22, are combined and allowed to react to generate a higher rank aqueous alkali metal polysulfide dianion solution of stream 15 for uses such as preparation of a metallasulfur derivative, and subsequent production of S₁₂ via reaction of the metallasulfur derivative with the molecular bromine stream 10. If the catholyte fraction 5 contains too much water for the desired concentration of higher rank aqueous alkali metal polysulfide solution of stream 15, water may be removed via stream 45 from either the catholyte fraction 5 prior to reaction with hydrogen sulfide and elemental sulfur, or after formation of the higher rank aqueous alkali metal polysulfide dianion solution.

A portion of an equilibrium mixture of alkali metal bromide, tribromide, and molecular bromine comprising anolyte effluent stream 9 is conveyed via stream 18 to molecular bromine recovery zone 34, wherein purified molecular bromine exits via line 10 and an alkali metal bromide mixture depleted of tribromide and molecular bromine comprises effluent stream 11. A fraction of effluent stream 11, may be removed via purge stream 12 to prevent build-up of impurities which may interfere with the operation of electrochemical cell 30 or bromine recovery zone 34. The remaining unpurged fraction of effluent stream 11, stream 13, make-up alkali metal bromide stream 14, and stream 19, a portion of anolyte effluent stream 9, and by-product alkali metal bromide stream 28 from the metallasulfur derivative reaction zone 37, are combined in anolyte storage 36 to maintain alkali metal bromide concentration in aqueous alkali metal bromide solution 8, the feed to the anolyte chamber 32 of electrochemical cell 30.

In metallasulfur derivative reaction zone 37, the desired metallasulfur derivative is regenerated by the reaction of an alkali metal polysulfide dianion salt, elemental sulfur, and a metal halide derivative. Polysulfide stream 15 may be concentrated by evaporation of water via line 25 and mixed with alkanol stream 24 to produce an alcoholic alkali metal polysulfide salt. Said alcoholic alkali metal polysulfide is combined and reacted with necessary additional recycle sulfur via line 21, and by-product metal bromide derivative-containing stream 23 to produce stream 27 comprising the desired metallasulfur derivative and stream 28 comprising by-product alkali metal bromide.

In the S₁₂ reaction zone 38, metallasulfur derivative of stream 27 and molecular bromine oxidant of stream 10 are combined and reacted to produce stream 20 comprising S₁₂, stream 23 comprising by-product metalbromide derivative, and streams 21 and 22 comprising sulfur allotropes.

The electrolysis or electrochemical cell of the present invention comprises, in one aspect, a cathode and a catholyte chamber and an anode and an anolyte chamber separated by an ion-selective membrane. Each electrode is connected to a direct current power supply in a circuit which allows for a current flow when energized and with electrolyte flow through the chambers. The capacity of such a unit cell may be increased by increasing the area of the electrodes and membrane as well as by forming stacks of alternating spacers (forming the electrolyte flow chamber) and bipolar electrodes in a parallel plate-and-frame filter press configuration. The end electrodes in such a stack are unipolar. Manifolds may be supplied such that flow of the electrolytes may be in parallel or series fashion through the flow chambers of the stack. Typically, 1 to 500 cells, more typically 10 to 250 cells, may be combined in a single stack. Heat exchange elements may also be placed in the stack, again with appropriate manifolding of the heat transfer fluid, to provide for removal of generated heat or otherwise maintained desired temperature ranges of the electrolysis cell. The flow chambers may contain turbulence promoters, i.e., static mixing elements, to enhance mass transfer and improve efficiency of the electrolysis. Typically mean linear flow velocities of the electrolyte solutions of 1 to 20 cm/sec are maintained.

When operating the electrolysis cell with a polysulfide-alkali metal bromide redox couple, flow and concentration of the catholyte polysulfide are maintained to result in reduction of the inlet higher rank polysulfide of form M₂Sₓ, from an average, for example of 2×4.5, or from 2×3.0, to the outlet lower rank polysulfide of form M₂S_{y}, from an average, for example, of 1.5 0≤y≤3.5, or from 1.4≤y≤3.5. Conversion across the electrolysis cell may vary greatly depending on the design of the electrolysis cell, desired production rate, and polysulfide concentration and rank. Typical conversion per cell pass results in a change in average polysulfide rank, δᵣ=x−y (inlet average rank−outlet average rank), of 0.05≤δᵣ≤2.0, or 0.05≤δᵣ≤1.0, or 0.1≤δᵣ≤0.5, wherein typically flow rates are such that the linear mean velocity of the solution passing through the catholyte chamber is 1 cm/sec to 20 cm/sec.

When operating the electrolysis cell with a water-alkali metal chloride redox couple, flow and concentration of the anolyte alkali metal chloride are maintained to result in an outlet alkali metal chloride concentration of 15 to 30 wt %. Typically, flow rates are such that the linear mean velocity of the solution passing through the anolyte chamber is 1 cm/sec to 20 cm/sec.

When operating the electrolysis cell with a bromide-containing anolyte, flow and concentration of the anolyte alkali metal bromide may be maintained to result in an outlet alkali metal bromide concentration of 10 to 30 wt %, and an outlet alkali metal bromide/tribromide concentration of 14 to 60 wt %. Typically, the latent molecular bromine content of the bromine/tribromide effluent from the electrolysis cell is 4 to 25 wt % as Br₂, more typically 8 to 20 wt % as Br₂. Conversion of the alkali metal bromide to bromine/tribromide ranges from about 10 wt % to about 55 wt %, more typically 15 to 45 wt %, based on feed NaBr solution to the electrolysis cell loop. Typically flow rates are such that the linear mean velocity of the solution passing through the anolyte chamber is 1 cm/sec to 20 cm/sec.

Electrodes for use in the electrochemical cell of this invention may be any electroactive material providing electrons to or through the electrolyte and the electrical circuit which is relatively non-reactive and stable in the electrolyte. Porous or sheet metal electrodes produced by methods known in the art are suitable, such as carbon-based graphite, graphite-polymer composites, platinum, palladium, titanium, tantalum, niobium, ruthenium, iridium, Raney catalyst metals, oxides of said metals, and combinations, alloys, or coatings thereof.

Preferred electrode materials for contact with the polysulfide catholyte are transition metal sulfides including graphite, graphite-polymer composites, vitreous (also known as glassy) carbon, vitreous carbon-polymer composites, NiS, Ni₃S₂, CoS, PbS, and CuS. Preferred electrode materials for contact with bromide containing anolytes include vitreous carbon, graphite, vitreous carbon-polymer compositions, such as polyethylene-vitreous carbon and polypropylene-vitreous carbon composites. Graphite containing anodes may be used but are not long-lasting.

Preferred substrate electrode materials for contacting chloride-containing anolytes include graphite, graphite-polymer compositions, and valve metals of the periodic groups IVB, VB, VIB, such as titanium, zirconium, hafnium, niobium, tantalum, tungsten, either singly or as alloys. Said substrate material may also be coated with oxides, carbides, borides, nitrides, oxychlorides, fluorides, phosphides, arsenides either singly or in combinations, or alloys of any or all of: the valve metals of the periodic groups IVB, VB, VIB; the noble metals platinum, iridium, rhodium, ruthenium, osmium, palladium; and the non-noble metals copper, silver, gold, iron, cobalt, nickel, tin, silicon, lead, antimony, arsenic. An example of a preferred electrode composition for contacting chloride containing anolytes is a titanium substrate coated with a TiO₂ and RuO₂ mixture. Another example of a preferred electrode composition for contacting chloride containing anolytes is a titanium substrate coated with a TiO₂, RuO₂, and SnO₂ mixture.

Preferred core electrode materials for contacting catholytes comprising aqueous alkali metal hydroxides include steel, graphite, graphite-polymer composites, and nickel. Said substrate materials, especially nickel, may also be alloyed with a wide variety of metals and non-metals, such as cobalt, tin, titanium, boron, silica, iridium, tungsten, bismuth, and zirconium.

The electrodes may be in the form of simple two-dimensional flat plates, perforated plates, lantern blades, or louvered. Alternatively, the electrodes may comprise porous, three-dimensional structures, such as porous mesh, expanded mesh, felts, or foams.

Current densities may vary widely, from 20 to about 4000 amps/m², depending on electrolyte composition, electrode materials of construction and form, and economic trade-offs of electricity costs versus capital. More typically current densities are about 400 to 2000 amps/m².

The ion-selective separator membrane may be any suitable membrane permeable to positive alkali metal ions, such as lithium, sodium, potassium, and cesium ions, and substantially impermeable to negative bromide, chloride, sulfide, and polysulfide ions. The separator membrane should also be substantially impermeable to diatomic chlorine and diatomic bromine. Suitable separator materials include nitrocellulose, cellulose acetate, cellulose acetate propionate, cellulose acetate butyrate, copolymers of tetrafluoroethylene (TFE) and sulfonated perfluoro (alkyl vinyl ether) such as Nafion®, sold by Chemours. Examples of specific membranes are Nafion® 415, 423, 424, 105, 111, 112, 115, 117, 211, 212, 1110, 1135, and the like.

The formation of lower rank polysulfides and molecular bromine/tribromide generates heat. Thus, it is preferred to supply heat transfer area in the cells and adjust the temperature of the inlet electrolyte solutions with heat exchangers external to the cell or stack of cells. The preferred temperature of electrolytes in the electrolysis cell is from about 10° C. to about 95° C. or below the boiling point of the electrolyte solutions, more preferably from 30° C. to 55° C., for bromide-containing anolytes, and about 20° C. to about 100° C. or below the boiling point of the electrolyte solutions, more preferably from 50° C. to 95° C., for chloride-containing anolytes.

The flowing electrolytes will be supplied at sufficient pressure to overcome the pressure drop through the cell stacks, piping, and heat exchangers of the electrolyte loops. Typical inlet electrolyte pressures are from about 0 to about 6 barg, more typically from 0 to 2 barg. It is desirous to maintain roughly equal pressures in both the catholyte and anolyte chambers to prevent damage to the membranes and to prevent pressure differential-induced permeation of species through the membrane.

In the polysulfide regeneration zone, the catholyte cell effluent is combined with water and elemental sulfur to regenerate a higher rank aqueous alkali metal polysulfide dianion solution for recycle to electrochemical cell. The elemental sulfur may be introduced as a solid, a solid slurry in a solvent, molten sulfur, or sulfur dissolved in a solvent. The elemental sulfur may be in any allotropic form which is convenient and available. Thus, the elemental sulfur may be of the form S_{y}, wherein y may be for example y=6, 7, 8, 12, and the like, or a very large but uncertain number as exemplifies polymeric sulfur. Water is a preferred solvent if present. Sufficient sulfur is typically introduced to bring the sulfur rank of the inlet polysulfide to about 2.0 to 4.5, thus the polysulfide is M₂Sₓ, where M is an alkali metal such as Na, Li, K, Cs, and 2.0<x<4.5. Sufficient water is introduced to the polysulfide regeneration zone to maintain the resulting higher rank polysulfide effluent at about 5 to 35 wt % polysulfide, more preferably 12-30 wt % polysulfide. The reaction of sulfur with lower rank polysulfide is generally rapid, so residence times of about 1 minute to 2 hours, more typically 5 minutes to 1 hour, is adequate, depending on temperature. The polysulfide regeneration zone may be operated at about 15° C. to 90° C., more typically at about 25 to 75° C., at pressures of 0 to 6 barg, more typically 0 to 2 barg.

The remaining fraction of catholyte effluent may be conveyed to a concentration zone wherein the lower rank alkali metal polysulfide dianion is concentrated by evaporation of water. Said evaporation may be accomplished by a single-effect or multiple-effect evaporation cascade, with either co-current or countercurrent steam to process fluid flow direction, by methods well known in the art. The evaporation cascade of concentration zone may be operated at about 45° C. to 130° C., more typically at about 65 to 110° C., at pressures of 0.1 to 4 bara, more typically 0.3 to 2 bara.

The concentration of lower rank polysulfide dianion exiting the evaporation cascade typically comprises from 2 to 0.3 kg of water per kg of alkali metal polysulfide present, more typically from 1 kg to 0.7 kg of water per kg of alkali metal polysulfide. The evaporator underflow may contain solid polysulfide and elemental sulfur particles if a high concentration of polysulfide is desired. The evaporator underflow may be diluted with a C₁ to C₄ alkanol, preferably C₁ to C₃ alkanols such as methanol, ethanol, isopropanol, and n-propanol in preparation for use in synthesis of a metallasulfur derivative, and subsequent production of S₁₂ via reaction of said metallasulfur derivative with the molecular bromine. The addition of the alkanols results in a polysulfide dianion solution comprising 5 to 30 wt % alkali metal polysulfide in the chosen alkanol and water.

The equilibrium mixture of alkali metal bromide, tribromide, and molecular bromine exiting from the anolyte chamber of the electrolysis cell may be further processed in a bromine recovery zone to produce purified molecular bromine and an alkali metal bromide solution for recycle to the anolyte chamber of the electrolysis cell. The species of molecular bromine (Br₂), alkali metal bromide (MBr, where M=Li, Na, K, Cs), and alkali metal tribromide (MBr₃) are known to exist in equilibrium with each other. See for example Griffith, McKeown, and Wynn in “The Bromine-Bromide-Tribromide Equilibrium”, Transactions of the Faraday Society, 28, pp. 101-107, 1932:

MBr+Br₂←→MBr₃

In the above equation, the equilibrium constant toward tribromide is about 15 to 18, depending on concentrations, alkali metal, and temperature. Thus, although molecular bromine is known to be largely immiscible with pure water, and mixtures of water and molecular bromine will spontaneously separate into two liquid phases, very little free molecular bromine exists in the anolyte chamber effluent of the electrolysis cell of the instant invention and typically does not separate spontaneously from an aqueous mixture. Free molecular bromine may be recovered from the anolyte chamber effluent by methods that alter the equilibrium of the bromine-tribromide equilibrium, such as flash distillation, fractional distillation, and extraction.

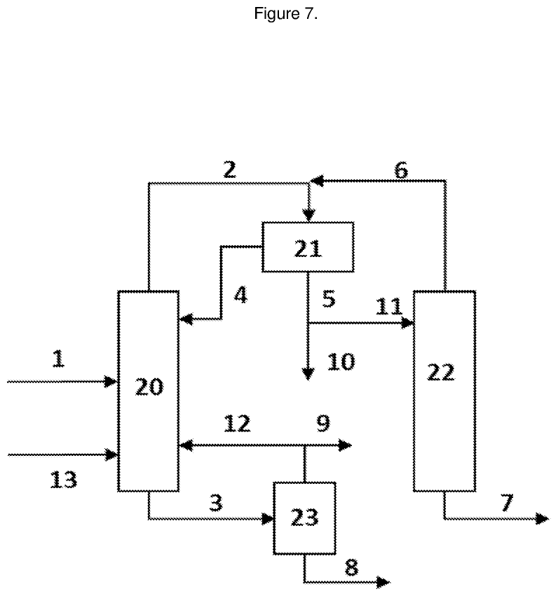

In one embodiment of the molecular halogen recovery zone, wherein the anolyte comprises a bromine-tribromide solution, as illustrated in FIG. 7, the anolyte chamber effluent 1 is fractionally distilled in a first distillation 20 to produce a first vapor 2 comprising molecular bromine and water (free of alkali metal bromide salts), and a first underflow 3 comprising aqueous alkali metal bromide, largely free of molecular bromine and tribromide. Said underflow 3 is useful as a source of bromide for electrolysis. The first distillation vapor 2, generally relatively close to the molecular bromine-water azeotropic composition, is condensed and conveyed to a liquid-liquid decanter zone 21 wherein sufficient residence time is supplied to allow the mixture to separate into two distinct liquid phases, with the top aqueous layer 4 predominantly water and the bottom bromine layer 5 predominantly molecular bromine. Provision is made to return the top aqueous layer to the first distillation as reflux, and part of the bottom bromine layer also may be returned as needed to ensure proper control of the first distillation.

A fraction or all of the bottom bromine layer 5, typically comprising greater than 99 wt % molecular bromine, and less than 0.5 wt % water, may be used directly as the wet oxidant stream 10 for preparation of cyclododecasulfur from a metallasulfur derivative. Alternatively, a fraction or all of the bottom bromine layer 5 may be conveyed as second distillation feed 11 to a second distillation 22 to produce a second vapor 6 comprising molecular bromine and the majority of the water in the second distillation feed 11, and a second underflow 7 comprising dry bromine, (i.e., greater than 99.6 wt % molecular bromine comprising less than 200 ppm, typically less than 100 ppm by mass dissolved water). Underflow 7 may also be used directly as the oxidant for preparation of cyclododecasulfur from a metallasulfur derivative.

The second vapor 6, generally relatively close to the molecular bromine-water azeotropic composition, is condensed and conveyed to the liquid-liquid decanter zone 21, also supplied by condensed first vapor 2. Part of the top aqueous layer may be returned as reflux as needed to ensure proper control of the second distillation.

Both the first and second vapors (streams 2 and 6 respectively) may be condensed in the same condensing heat exchanger. Alternatively, separate condensers may be used for the first and second distillations. The decanter 21 is maintained at 0 to 50° C., more typically 20 to 45° C., by the column condenser or condensers. The decanter 21 is operated at sufficient pressure to ensure that essentially all of the condensed first and second vapors remain as liquid during the decantation operation.

The first distillation 20 may be accomplished with 5 to 30 theoretical stages, typically with at least 5 to 25 stages in the rectifying section of the column. The first distillation 20 may be operated at a reflux ratio of 0.25/1 to 5/1 more typically 0.5/1 to 2/1, at a base column pressure of 0.3 bara to 5 bara, more typically about 0.4 bara to 1.5 bara.

The second distillation 22 may be accomplished with 10 to 30 theoretical stages, typically with at least 5 to 25 stages in the stripping section of the column. The second distillation 22 is operated at a reflux ratio of 0.25/1 to 5/1 more typically 0.5/1 to 2/1, at a base column pressure of 0.3 bara to 5 bara, more typically about 0.4 bara to 1.5 bara.

In order to maintain the desired water content of the anolyte, it may be necessary to remove water from the first underflow 3 prior to recycle to electrolysis. In such a case, first underflow 3 is conveyed to underflow concentration zone 23, wherein water is removed by boiling of the underflow 3 to produce concentrated alkali metal bromide solution 8 and concentrator overflow 9. This concentration step may be carried out in any vapor-liquid contacting device known in the art including fractional distillation, single effect evaporation, and multi-effect evaporation. The concentration step is preferably carried out at a pressure of 0.2 bara to 3 bara, more typically about 0.4 bara to 1.5 bara, with a base temperature of 60 to 140° C., more typically 80 to 125° C. The concentration step may be carried out in an integrated fashion with the first distillation, wherein said concentration step occurs in the reboiler of the first distillation, with stream 9 as a reboiler vapor draw, stream 12 is boil-up to provide heat to distillation 20. The anolyte chamber effluent 1 may comprise HBr. Said HBr may be converted to a more useful form for recovery of molecular bromine by addition of HBr conversion stream 13 to first distillation 20. HBr conversion stream 13 may comprise aqueous solutions of hydroxide, hydrogen carbonates, or carbonates, which convert the HBr to bromide salts (e.g., HBr+NaOH react to form NaBr, NaHCO₃+HBr react to form NaBr, or 2HBr+Na₂CO₃ react to form 2NaBr). Alternatively and preferably, HBr conversion stream 13 may comprise aqueous hydrogen peroxide, wherein H₂O₂+2HBr→2H₂O+Br₂. When using H₂O₂ to control HBr formation, typically the H₂O₂ is added at a molar ratio of less than or equal to 0.5 moles H₂O₂ per mole of HBr. When used at less than 0.5 mole per mole, then not all of the HBr will be reacted each pass through the first distillation 20, but will remain in the recycle anolyte and further react upon the next pass through the distillation.

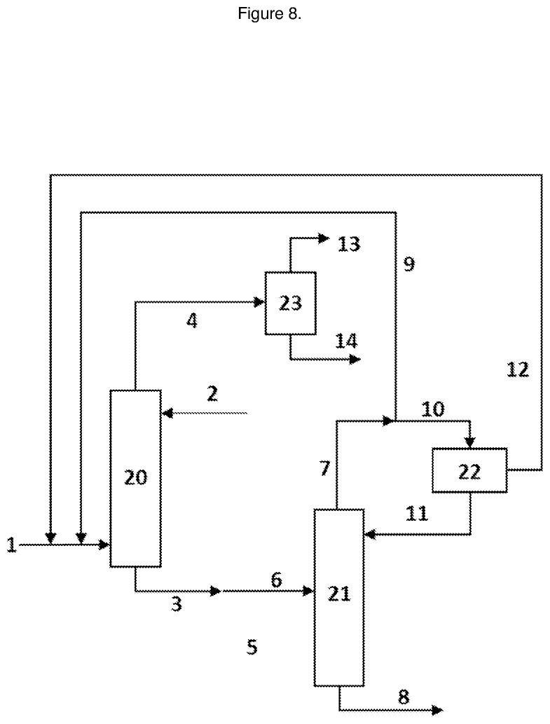

In a second embodiment of the molecular halogen recovery zone, illustrated in FIG. 8, wherein the anolyte comprises a bromine-tribromide solution, the anolyte chamber effluent 1 is extracted with solvent 2 in an extraction zone 20 to produce an extract stream 3 comprising said solvent and molecular bromine, largely free of water and alkali metal bromide salts, and a raffinate stream 4 comprising aqueous alkali metal bromide. A fraction or all of extract stream 3, typically comprising less than 1 wt % free water, and less than 1000 ppm alkali metal bromide, may be used directly as the crude extracted oxidant 5 for preparation of cyclododecasulfur from a metallasulfur derivative. Alternatively, a fraction or all of extract stream 3 may be used as distillation feed 6, and processed by distillation to reduce the water content therein. Distillation feed 6 is conveyed to extract distillation column 21 to produce an extract distillation vapor 7 comprising molecular bromine and the majority of the water in the extract feed 1, and an extract distillation underflow 8 comprising dry bromine in the extraction solvent (i.e., typically comprising less than 200 ppm, or less than 100 ppm by mass of dissolved water based on bromine content and on a solvent-free basis). Said dry extract distillation underflow 8 may also be used directly as the oxidant for preparation of cyclododecasulfur from a metallasulfur derivative.

The extract distillation vapor 7, generally relatively close to the molecular bromine-water azeotropic composition, is condensed and may be conveyed back to the extraction zone for reprocessing via line 9 or alternatively conveyed via line 10 to liquid-liquid decanter zone 22, with the top aqueous layer 12 returned to the extraction zone 20 and the bottom bromine layer 11 as reflux to the extract distillation 21. The extract distillation 21 may be accomplished with 10 to 30 theoretical stages, typically with at least 5 to 25 stages in the stripping section of the column. The extract distillation 21 is operated at a reflux ratio of 0.25/1 to 5/1 more typically 0.5/1 to 2/1, at a base column pressure of 0.2 bara to 2 bara, more typically about 0.4 bara to 1.5 bara.

In order to maintain the desired water content of the anolyte, and remove residual solvent prior to recycle to electrolysis, raffinate stream 4 is subjected to a stripping operation. Raffinate stream 4 is conveyed to stripping zone 23, wherein water is removed by boiling of raffinate stream 4 to produce concentrated alkali metal bromide solution 14 and stripping overflow 13. This stripping step may be carried out in any vapor-liquid contacting device known in the art including fractional distillation, single effect evaporation, and multi-effect evaporation. The stripping step is preferably carried out at a pressure of 0.2 bara to 3 bara, more typically about 0.4 bara to 1.5 bara, with a base temperature of 60 to 140° C., more typically 80 to 125° C.

Useful solvents for the extraction of bromine from the anolyte chamber effluent are solvents that are relatively unreactive to bromine and acceptable as diluents for S₁₂ synthesis. Preferred extraction solvents include those selected from the group consisting of CS₂, C₅ and larger alkanes, halogenated hydrocarbons of 1 to 12 carbon atoms and one halogen atom up to perhalogenated content, and esters of C₂ to C₈ carboxylic acids and C₁ to C₈ alcohols. Examples of halogenated solvents include methylene chloride, chloroform, carbon tetrachloride, carbon tetrabromide, methylene bromide, bromoform, bromobenzene, chlorobenzene, chlorotoluenes, dichlorobenzenes, o-, m-, p-dibromobenzenes. Examples of alkane and aromatic dissolving solvents include o-, m-, p-xylenes, toluene, benzene, ethyl benzene, o-, m-, p-diisopropylbenzene, naphthalene, methyl naphthalenes, hexane and isomers, heptane and isomers, cyclohexane, methylcyclohexane, and decane. Examples of esters of carboxylic acids are methyl acetate, ethyl acetate, n-propyl acetate, isopropyl acetate, n-butyl acetate, isobutyl acetate, sec-butyl acetate, n-propyl propionate, n-butyl propionate, ethyl butyrate, isobutyl isobutyrate, and the like. Preferred solvents are carbon disulfide and halogenated solvents, with chloro-aromatics such as chlorobenzene and dichlorobenzenes particularly preferred.

The extraction of bromine from the anolyte chamber effluent can be carried out by any means known in the art to intimately contact two immiscible liquid phases and to separate the resulting phases after the extraction procedure. For example, the extraction can be carried out using columns, centrifuges, mixer-settlers, and miscellaneous devices. Some representative examples of extractors include unagitated columns (e.g., spray, baffle tray and packed, perforated plate), agitated columns (e.g., pulsed, rotary agitated, and reciprocating plate), mixer-settlers (e.g., pump-settler, static mixer-settler, and agitated mixer-settler), centrifugal extractors (e.g., those produced by Robatel, Luwesta, deLaval, Dorr Oliver, Bird, CINC, and Podbielniak), and other miscellaneous extractors (e.g., emulsion phase contactor, electrically enhanced extractors, and membrane extractors). A description of these devices can be found in the “Handbook of Solvent Extraction”, Krieger Publishing Company, Malabar, Fla., 1991, pp. 275-501. The various types of extractors may be used alone or in any combination.

The extraction may be conducted in one or more stages. The number of extraction stages can be selected in consideration of capital costs, achieving high extraction efficiency, ease of operability, and the stability of the starting materials and mixed diol stream to the extraction conditions. The extraction also can be conducted in a batch or continuous mode of operation. In a continuous mode, the extraction may be carried out in a co-current, a counter-current manner, or as a fractional extraction in which multiple solvents and/or solvent feed points are used to help facilitate the separation. The extraction process also can be conducted in a plurality of separation zones that can be in series or in parallel.

In a preferred embodiment of the extraction zone, the fractional extraction is operated wherein the anolyte chamber effluent is fed to the middle of a fractional extractor with a heavy organic solvent fed above and water fed below. Preferred solvents for such a fractional extractor are carbon disulfide and halogenated solvents, with chloroaromatics such as chlorobenzene and dichlorobenzenes particularly preferred.

In another embodiment of the invention, the extraction zone and electrolysis occur in the same equipment. Thus, an extraction solvent is co-fed with the recycle aqueous alkali metal bromide solution to the anolyte chamber of the electrolysis cell, resulting in simultaneous production of molecular bromine/tribromide and extraction of molecular bromine into the solvent.

The extraction typically can be carried out at a temperature of about 0 to about 80° C. For example, the extraction can be conducted at a temperature of about 20 to about 55° C. The desired temperature range may be constrained further by the boiling point of the extractant components, molecular bromine, and water. Generally, it is undesirable to operate the extraction under conditions where the solvent or extractant boils. In one aspect, the extractor can be operated to establish a temperature gradient across the extractor in order to improve the mass transfer kinetics or decantation rates. In another aspect, the extractor may be operated under sufficient pressure to prevent boiling.

In an embodiment of the bromine recovery zone, molecular chlorine is generated in the anolyte chamber from an aqueous alkali metal chloride salt, and an alkali metal bromide is the recycle source for the oxidant, Br₂, for the formation of S₁₂. Molecular bromine may be recovered via the exchange reaction of molecular chloride with an alkali metal bromide salt described by the series of equilibrium reactions below:

NaBr+Cl₂←→ClBr+NaCl

NaBr+ClBr←→Br₂+NaCl

2NaBr+Cl₂←→Br₂+2NaCl—net reaction

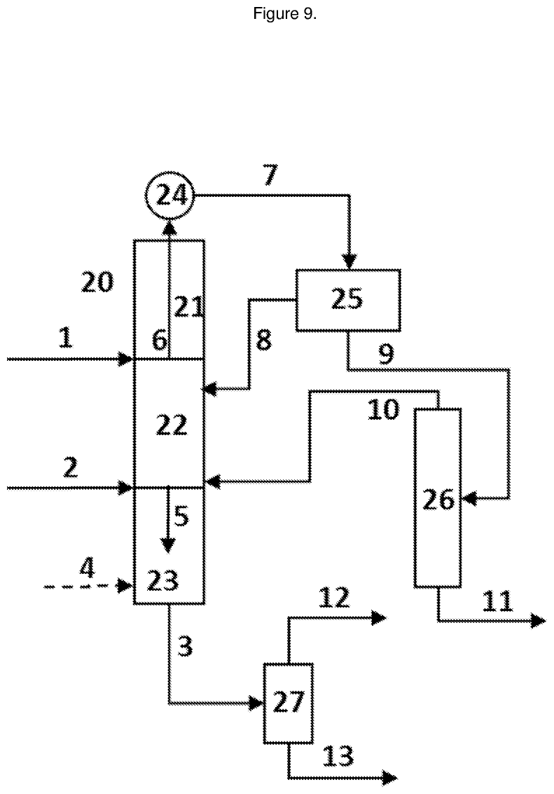

FIG. 9 illustrates an embodiment of the bromine recovery zone, wherein the bromine-chlorine exchange reaction between an aqueous alkali metal bromide solution, (originating, for example, as the by-product of a metallasulfur derivative preparation from a reaction of a metal halide derivative and an alkali metal polysulfide salt), and molecular chlorine gas may be carried out in exchange reaction tower 20 comprising an upper rectification section 21, a middle reaction section 22, and a lower stripping section 23, and with heat input into the bottom of the tower. The aqueous alkali metal bromide feed 1 is introduced at the upper feed point between rectification section 21 and reaction section 22, and chlorine gas 2 (originating for example, as a product of electrolysis of an alkali metal chloride) is introduced at the lower feed point, between reaction section 22 and stripping section 23. In reaction section 22, the up-flowing chlorine gas of stream 2 reacts and exchanges with the down-flowing aqueous alkali metal bromide of stream 1 to produce ClBr, Br₂, and alkali metal chloride species as described by the reaction equations above. It is desirable for conversion of the incoming feed alkali metal bromide to be greater than 95%, more preferably greater than 99%, most preferably for bromide content of the reaction section underflow to be less than 100 ppm Br—. In order to achieve high conversion of bromide to bromine it may be necessary to use an excess of Cl₂/Br—, typically at a Cl₂/Br— molar ratio of 0.5/1 to 0.6/1.

At the bottom of stripping section 23 of exchange reaction tower 20, heat is provided to boil out any molecular halogen species (Cl₂, ClBr, or Br₂) which exit from the bottom of reaction section 22 with the aqueous alkali metal halides. An aqueous alkali metal halide stream 3, typically comprising an alkali metal chloride, water, less than 100 ppm Br—, and essentially free of molecular halogens, typically comprising less than 100 ppm of said molecular halogens, exits the bottom of tower 20. Said alkali metal halide stream 3 is suitable for recycle to the electrolysis cell when the anolyte solution comprises an alkali metal chloride. Heat may be supplied by direct injection of live steam into the tower bottom or indirectly by heat transfer through a conventional reboiler driven by steam or hot oil as the heat source.

The heat input 4 at the bottom of tower 20 causes vaporous stream 6 comprising water and molecular halogen species (Cl₂, ClBr, and Br₂) to boil up from reaction section 22 into rectification section 21. Cooling is provided at the top of rectification section 21 to condense said vaporous stream 6 in either an internal or external condenser 24. The condensed vapors 7 are collected in a decanter 25, wherein an upper aqueous phase 8 and a lower molecular halogen phase 9 are formed. The aqueous phase 8, containing a minor amount of the molecular halogen species may be returned to exchange reactor tower 20, preferably at the same location in tower 20 as the molecular chloride feed 2. The lower molecular halogen phase 9, containing a majority of the molecular halogen species, and a minor amount of water is withdrawn for further purification to bromine purification column 26.

The bottom molecular halogen layer 9 from decanter 25 may be conveyed to bromine purification column 26 to remove chlorine-containing species and water as overflow stream 10. With concomitant production of a higher purity bromine product as underflow stream 11. The column overflow stream 10 comprises molecular bromine and the majority of the water and chlorine-containing species in the bromine purification column feed. The column underflow stream 11 comprises dry, chlorine-free bromine, (i.e., greater than 99.6 wt % molecular bromine comprising less than 200 ppm, typically less than 100 ppm by mass dissolved water and less than 100 ppm chlorine content as Cl₂ and ClBr). Said dry, chlorine-free bromine may also be used as the oxidant for preparation of cyclododecasulfur from a metallasulfur derivative.

The overflow stream 10 from the bromine purification column 26 is condensed and conveyed to the exchange reaction tower 20 for further recovery of chlorine and bromine content.

In order to maintain the desired water content of the anolyte, it may be necessary to remove water from alkali metal halide stream 3 prior to recycle to electrolysis. In such a case, alkali metal halide stream 3 is conveyed to underflow concentration zone 27, wherein water is removed by boiling of the alkali metal halide stream 3 to produce concentrated alkali metal bromide solution 13 and concentrator overflow 12. This concentration step may be carried out in any VLE contacting device known in the art including fractional distillation, single effect evaporation, and multi-effect evaporation. The concentration step is preferably carried out at a pressure of 0.2 bara to 3 bara, more typically about 0.4 bara to 1.5 bara, with a base temperature of 60 to 140° C., more typically 80 to 125° C.

The exchange reaction tower may be operated at 0.4 to 2 bara, more typically 0.5 to 1.1 bara, with a top temperature of about 30 to 45° C. and a bottom temperature of about 90 to 120° C.

The bromine purification column may comprise 10 to 30 theoretical stages, typically with at least 5 to 25 stages in the stripping section of the column. The bromine purification column is operated at a reflux ratio of 0.25/1 to 5/1 more typically 0.5/1 to 2/1, at a base column pressure of 0.3 bara to 5 bara, more typically about 0.4 bara to 1.5 bara.

The exchange reaction tower 20, bromine purification column 26, condenser 24, and decanter 25 may be constructed of any material which is not adversely affected by contact with aqueous metal halides, molecular chlorine, and molecular bromine. Metals and metal alloys, such as tantalum, niobium, and titanium, either solid or as coating, carbon steel lined with acid brick, glass, and plastics such as polytetrafluoroethylene and polyvinylidene fluoride are suitable as materials of construction.

Column internals, i.e., packing or trays, may likewise may be constructed of any material which is not adversely affected by contact with aqueous metal halides, molecular chlorine, and molecular bromine. Examples of such materials include ceramic, certain metals, such as tantalum, niobium, and titanium as alloys, either solid or as coatings, or various plastics such as polytetrafluoroethylene and polyvinylidene fluoride.

The distillation operations of the instant invention may be carried out in batch or continuous modes of operation, with any gas/liquid contacting device known in the art suitable for distillation practice. The gas/liquid contacting equipment of the distillation operation may include, but is not limited to, cross-flow sieve, valve, or bubble cap trays, structured packings such as Mellapak®, Metpak®, Rombopak®, Flexipak®, Gempak®, Goodloe®, Sulzer, Koch-Sulzer, York-Twist® or random or dumped packing, such as berl saddles, Intalox saddles, Raschig rings, Pall rings, Hy-Pak® rings, Cannon packing, and Nutter rings. These and other types of suitable gas/liquid contacting equipment are described in Kister, H. Z. Distillation Design, McGraw-Hill, New York (1992), Chapters 6 and 8.

U.S. Pat. No. 10,011,485, the disclosure of which is incorporated herein by reference in its entirety, relates to processes of producing zinc hexasulfide amine complexes that are suitable for use according to the present invention.

In one aspect, the method of the present invention is thus a method for the manufacture of a cyclododecasulfur compound. In this embodiment, a preferred metallasulfur derivative is a (TMEDA)Zn(S₆) complex. The (TMEDA)Zn(S₆) complex is most preferably formed in situ by reacting (TMEDA)ZnBr₂ complex with an alkali metal polysulfide salt, with by-product formation of alkali metal bromide.

The S₁₂ reaction step of the present invention may be performed at a wide range of temperature, pressure, and concentration ranges. Suitable reaction temperatures are from −78° to 100° C., or between −45° C. and 100° C., more typically −10 to 40° C. In an embodiment wherein (TMEDA)Zn(S₆) is selected as the metallacyclosulfane and Br₂ is selected as the sulfur-free oxidizing agent in the manufacture of cyclododecasulfur compound, typical reaction temperatures are from −78° C. to 60° C., or from −30° C. to 60° C., more preferably −10° C. to 40° C. In an embodiment wherein [PPh₄]₂[Zn(S₆)₂] is selected as the metallacyclosulfane and Br₂ as the oxidizing agent, typical reaction temperatures are from −78° C. to 60° C., or from −30° C. to 60° C., more preferably −10° C. to 40° C.

The metallasulfur derivative in the S₁₂ reaction step may be in any physical form desirable to facilitate the reaction. Suitable forms include solid, slurry in an appropriate solvent, or solution in an appropriate solvent. Accordingly, in one embodiment, the method includes forming a slurry of the metallasulfur derivative in a solvent prior to the reacting step. In another embodiment, the method includes forming a solution of the metallasulfur derivative in a solvent prior to the reacting step. When a slurry or solution form is utilized, typical metallasulfur derivative concentrations for the slurry or solution are 0.5 to 30 weight percent, more typically 2 to 25 weight percent, based on the total weight of the slurry or solution. Suitable solvents useful for the slurry or solution form in the reacting step include halogenated solvents of one to 12 carbon atoms and one halogen atom up to perhalogenated content. Examples of halogenated solvents include methylene chloride, chloroform, carbon tetrachloride, carbon tetrabromide, methylene bromide, bromoform, bromobenzene, chlorobenzene, chlorotoluenes, dichlorobenzenes, dibromobenzenes. Other suitable solvents include alkanes of 5 to 20 carbons, aromatics, alkyl aromatics of 7 to 20 carbons. Examples are pentanes, hexanes, cyclohexane, heptanes, octanes, decanes, benzene, toluene, xylenes, mesitylene, ethyl benzene and the like. One or more combinations of solvents may also be utilized.

Similarly, the oxidizing agent in the reacting step may be in any physical form desirable to facilitate the reaction. Preferably, the oxidizing agent is in the form of a dispersion in a suitable dispersant. Accordingly, in one embodiment of the method of the present invention, the method includes forming a dispersion of the oxidizing agent in a dispersant prior to the reacting step. Typically, the oxidizing agent will be present in the dispersion in an amount of 0.5 to 60 wt % based on the total weight of the dispersion, more typically 1 to 25 wt % based on the total weight of the dispersion. Examples of dispersants include carbon disulfide, methylene chloride, chloroform, carbon tetrachloride, carbon tetrabromide, methylene bromide, bromoform, bromobenzene, chlorobenzene, chlorotoluenes, dichlorobenzenes, and dibromobenzenes.

The products of the reaction of the molecular bromine oxidant and the metallasulfur derivative, including but not limited to, S₁₂, alkali metal bromide salt, and other sulfur allotropes, differ significantly in solubility in various solvents. As such, said reaction products may be separated by any means known in the art exploiting such physical property differences. Such separation methods include but are not limited to extraction, crystallization, precipitation, sedimentation, membrane permeation, filtration, and the like.

Although a cation selective exchange membrane is used for electrolysis, sulfide ions diffuse from the sulfide/polysulfide electrolyte into the bromine/bromide electrolyte where they will be oxidized by the bromine to form sulfate ions according to the equation below.

S⁻+4Br₂+4H₂O→8Br⁻+SO₄²⁻+8H⁺

Sulfate ions may also enter the anolyte solution via contamination of the make-up alkali metal halide solution, or as a by-product in recycle alkali metal halide solution which has come in contact with other sulfur-containing steps of the S₁₂ synthesis sequence. Regardless of their origin, the presence of sulfate ions in the anolyte solution degrade the performance of the electrolysis cell. Although the sulfate may be removed by simple purging of anolyte solution from the anolyte electrolysis system, such a strategy results in excess loss of valuable alkali metal bromide. Removal or purging of sulfate ions while largely retaining or recovering alkali metal halide is necessary for economical operation.

Various methods known in the art may be employed for removal of sulfate ions from aqueous alkali metal halide solutions. The sulfate ions may be precipitated as barium sulfate by addition of barium salts, such as barium carbonate and barium halide (i.e., chloride or bromide). The sulfate ions may be precipitated as calcium sulfate by addition of calcium salts, such as calcium carbonate and calcium halide (i.e., chloride or bromide), or calcium oxide. Further, the sulfate ions may be removed as alkali metal sulfates by evaporation and selective crystallization of alkali metal sulfates from an aqueous alkali metal halide solution, as halide content tends to lower the inherent solubility of sulfate ions versus that in fresh water. In yet another method, sulfate ions may be removed by nanofiltration of the divalent sulfate ions from monovalent halide ions. Further, sulfate ions may be selectively recovered from alkali metal halide solutions by complexation with solid hydrous zirconium (IV) oxide at a pH<3, with said complex removed from the bulk of the aqueous alkali bromide solution, followed by decomplexation of the solid by contacting with an aqueous solution of pH>3, as with subsequent recycle of solid hydrous zirconium (IV) oxide for reuse.

Sulfate ions may also be removed from aqueous alkali metal halide solutions by precipitation as sodium sulfate by addition of an alkanol miscible with water such as methanol, ethanol, n-propanol, i-propanol. Typically the mixture of aqueous alkali metal halide and alkanol comprises 10 to 50 wt % alkanol. Preferred alkanol is methanol and preferred halide is bromide.

As described above, leakage of sulfide ions into a bromide/bromine/tribromide-containing anolyte chamber results in the formation of hydrogen bromide and sulfate ions that lower the pH of the solution and result in potential loss of bromide content. Maintenance of cell pH in the desired range and conversion of hydrobromic acid back into a useful form for bromine recovery may be accomplished by a number of processing steps. Some examples are: by addition of alkali metal hydroxide, or alkali metal carbonate to convert hydrobromic acid to alkali metal bromides; by addition of hydrogen peroxide simultaneously with distillation, via the reaction H₂O₂+2HBr→2H₂O+Br₂; by metal-catalyzed oxidation with dioxygen; or by electrolysis to produce molecular hydrogen and molecular bromine.

In the hydrogen sulfide generation zone, molecular hydrogen is combined with elemental sulfur to produce an effluent stream comprising hydrogen sulfide:

H₂+⅛S₈←→H₂S

This H₂S-forming reaction may be carried out with or without catalyst. Typical catalysts include bauxite, aluminum silicate, oxides and sulfides of cobalt, molybdenum, and nickel singly or as mixtures, alloys, or composites. To achieve satisfactory reaction rate and high hydrogen sulfide yield, the reaction should take place at elevated temperature and pressure. A desired temperature range is 200 to 500° C., more desired 300 to 450° C. A desired pressure range is 1.3 to 30 bara, more desirably 4 bara to 20 bara. The hydrogen sulfide thus formed may be separated from unreacted elemental sulfur by cooling and solidification of said sulfur.

Alkali metal polysulfide may be synthesized by a series of reactions wherein H₂S is reacted with an alkali metal hydroxide (MOH), followed by elemental sulfur addition:

H₂S+2MOH←→M₂S+H₂O

M₂S+n S_{y}→M₂S_{1+yn}

The first reaction may be carried out in any vessel that allows for contact of gaseous hydrogen sulfide with an aqueous or alkanolic alkali metal hydroxide. In order to ensure complete reaction of MOH, H₂S should be supplied in molar excess, typically at a molar ratio of 2.1/1 to 3/1 MOH/H₂S. The first reaction may be operated at about 15° C. to 90° C., more typically at about 25 to 60° C., at pressures of 0 to 6 barg, more typically 0 to 2 barg.

For the second reaction, the elemental sulfur may be introduced as a solid, a solid slurry in a solvent, molten sulfur, or sulfur dissolved in a solvent. The elemental sulfur may be in any allotropic form which is convenient and available. Thus y in the above equation may be for example y=6, 7, 8, 12, and the like, or a very large but uncertain number as exemplifies polymeric sulfur. Water or C₁ to C₃ alkanols are the preferred solvent if present. Sufficient sulfur is typically introduced to bring the sulfur rank of the polysulfide to about 2.0 to 4.5, thus the polysulfide is M₂Sₓ, where x=1+8n, M is an alkali metal such as Na, Li, K, Cs, and 2.0<x<4.5. Sufficient water or alkanol is introduced to the polysulfide regeneration zone to maintain the resulting higher rank polysulfide effluent at about 5 to 35 wt % polysulfide, more preferably 12-30 wt % polysulfide. The reaction of sulfur with lower rank polysulfide is generally rapid, so residence times of about 1 minute to 2 hours, more typically 5 minutes to 1 hour, is adequate, depending on temperature. The second reaction may be operated at about 15° C. to 90° C., more typically at about 25 to 75° C., at pressures of 0 to 6 barg, more typically 0 to 2 barg.

Alkali metal polysulfide may be synthesized by a series of reactions wherein H₂S is reacted with an alkali metal alkoxide (MOR), followed by elemental sulfur addition:

H₂S+2MOR←→M₂S+2ROH

M₂S+n S_{y}→M₂S_{1+yn}
Where ROH and MOR represent an alkanol and an alkali metal alkoxide respectively, each of 1 to 4 carbons

The first reaction may be carried out in any vessel that allows for contact of gaseous hydrogen sulfide with an alkanolic alkali metal alkoxide. In order to ensure satisfactory reaction of MOR, H₂S should be supplied in molar excess, typically at a molar ratio of 2.1/1 to 3/1 MOR/H₂S. The first reaction may be operated at about 15° C. to 90° C., more typically at about 25 to 60° C., at pressures of 0 to 6 barg, more typically 0 to 2 barg.

For the second reaction, the elemental sulfur may be introduced as a solid, a solid slurry in a solvent, molten sulfur, or sulfur dissolved in a solvent. The elemental sulfur may be in any allotropic form which is convenient and available. Thus y in the above equation may be for example y=6, 7, 8, 12, and the like, or a very large but uncertain number as exemplifies polymeric sulfur. Water or C₁ to C₃ alkanols are the preferred solvent if present. Sufficient sulfur is typically introduced to bring the sulfur rank of the polysulfide to about 2.0 to 4.5, thus the polysulfide is M₂Sₓ, where x=1+8n, M is an alkali metal such as Na, Li, K, Cs, and 2.0<x<4.5. Sufficient water or alkanol is introduced to the polysulfide regeneration zone to maintain the resulting higher rank polysulfide effluent at about 5 to 35 wt % polysulfide, more preferably 12-30 wt % polysulfide. The reaction of sulfur with lower rank polysulfide is generally rapid, so residence times of about 1 minute to 2 hours, more typically 5 minutes to 1 hour, is adequate, depending on temperature. The second reaction may be operated at about 15° C. to 90° C., more typically at about 25 to 75° C., at pressures of 0 to 6 barg, more typically 0 to 2 barg.

### Analytical Methods

Differential scanning calorimetry (DSC)—The differential scanning calorimetry method (DSC) to measure the melting point range of the cyclic sulfur allotrope compound involves a first heating scan, from which are determined the melting peak temperature (Tm1) and the exothermic peak temperature (Tex1). The instrument used was a TA's Q2000 DSC (RCS) with a refrigerated cooling system. The procedure used is described herein as follows. The instrument was calibrated according to the manufacturers “User's Manual.” A calibration specimen of about 3.0 mg was then scanned at a rate of 20° C./min. in the presence of helium with a flow rate of 50 cc/min. For sulfur-containing specimens, a similar method was used. A TA's Tzero aluminum pan and lid along with two aluminum hermetic lids were tared on a balance. About 3.0 mg of the sulfur-containing specimen was weighed into the Tzero pan, covered with the tared lid, and crimped using a TA's sample crimper with a pair of “Black” dies. The crimped specimen from the “Black” die stand was moved to the “Blue” die stand, where two tared hermetic lids were placed on the top of the specimen pan and crimped with the top “Blue” die. An empty crimped Tzero aluminum pan and lid along with 2 hermetic lids was prepared in a similar fashion as reference. The specimen and reference pans were placed in the DSC tray and cell at room temperature. After the DSC was cooled to −5° C. using a refrigerated cooling system, the specimen was heated from −5 to 200° C. at a rate of 20° C./min in the presence of helium. “Melt point onset” was defined as the temperature at the start of the endothermic melting event. Data analysis was performed using TA's software, Universal V4.7A, wherein, Tm1 refers to the low melting peak temperature occurring on the melting curve, using analysis option, “Signal Maximum”. Tex1 refers to the exothermic peak temperature occurring right after Tm1, using analysis option, “Signal Maximum”.

UniQuant (UQ)—Samples were also analyzed using X-ray fluorescence and the UniQuant software package. UniQuant (UQ) is an x-ray fluorescence (XRF) analysis tool that affords standardless XRF analysis of samples. Samples can then be semi-quantitatively analyzed for up to 72 elements beginning with row three in the periodic table (i.e. Na to higher Z). The data are mathematically corrected for matrix differences between calibration standards and samples as well as absorption and enhancement effects; i.e. inter-element effects. Some factors that can affect the quality of results include granularity in the sample (leading to shadow effects), mineralogical effects (due to sample inhomogeneity), insufficient sample size, and lack of knowledge of the sample matrix. In cases where a sample was amenable to both, the XRF UQ analysis and the ICP-OES (i.e. quantitative) analysis generally agree within +/−10%. Samples were analyzed for Zn, Br, Cl, and S content by UQ.

ICP—Approximately 100 milligrams of sample was weighed into a precleaned Quartz sample tube. Then 3 mL of concentrated nitric acid was added to each tube (Trace metal grade Fisher Chemical). Samples were microwave-digested using an Ultrawave Single Reaction Chamber Digestion System. After addition of scandium as an internal standard element (1 ppm level after final dilution), digested samples were diluted to a volume of 25 mL, yielding a final acid concentration of ˜10% HNO₃ (based on nitric acid added and expected consumption of nitric acid during the digestion). A 1 ppm scandium internal standard was added to each sample. A Perkin Elmer Optima 2100 ICP-OES instrument (PerkinElmer Inc., Waltham Mass.) was calibrated with a matrix matched 1 ppm calibration standard and blank. Each sample, including a method blank was then analyzed for Zn, S, Br, and Cl content.

Raman Spectroscopy—The samples' Raman spectrum was measured using a Renishaw inVia confocal Raman microscope and WiRE 4.1 software with a 785 nm excitation laser and a 5× magnification microscope objective.

NMR—Weigh approximately 0.020 g of sample into a vial. Weigh approximately 0.020 g of the internal standard, 1,4-dimethoxybenzene, into the same vial. Add approximately 1 mL of pyridine-d5, or other deuterated solvent that the material is soluble in. Take a ¹H NMR of the material and integrate the peak at δ 3.68 (6 protons). Integrate the two peaks at δ 2.45 and δ 2.25 (16 protons). Calculate the % purity using the following equation.

% Purity=100[(mg IS/MW IS)*(∫sample/∫IS)*( 6/16)*(MW sample/mg sample)]
IS=internal standard
MW=molecular weight
∫=value of the integration from the ¹H NMR

Particle Size Distribution—The particle size distribution of cycoldodecasulfur materials was measured by a laser light scattering technique using a Malvern Mastersizer 3000 instrument, capable of measuring a particle size range from 0.1-1000 μm, equipped with optics comprising; a max. 4 mW He—Ne, 632.8 nm red light source; nominal 10 mW LED, 470 nm blue light source; reverse Fourier (convergent beam) lens arrangement, effective focal length of 300 mm; with the detector in a log-spaced array arrangement, angular range of 0.015-144 degrees, and automatic alignment. The disperant (isopropanol) was added to the instrument and a small amount of cyclododecasulfur sample was added to the isopropanol to achieve a laser obscuration near 5%. The sample was mixed for 30 seconds to 60 seconds, and subjected to light scattering analysis, with the particle size distribution based on a Mie scattering model, using a refractive index of 1.93. The method reports volume-weighted diameters, with the following distribution terms defined as:

D[4,3] is the “volume-weighted mean”, or “average” diameter, defined as:

$$D [ 4 , 3 ] = \frac{\sum {f}_{i} * {d}_{i}^{4}}{\sum {f}_{i} * {d}_{i}^{3}}$$

where fi is the fraction of the particle having a diameter of di.
   Dv (10)—10% of the population lies below this size
   Dv (50)—The volume “median diameter”, with 50% of the distribution above this
   value and 50% below
   Dv (90)—90% of the distribution lies below the size

Liquid Chromatrography—The liquid chromatography (LC) method separates elemental sulfur species including S₈ and S₁₂. The sulfur species were identified by retention time determined from known samples. The quantity of S₈ was determined by comparing the peak area of S₈ in the unknown sample with that of S₈ standard solutions of known concentrations made in toluene. Liquid samples were analyzed without further pretreatment. For solid samples, the sample was gently ground into a fine powder using a mortar and pestle. A 1-milligram sample was weighed using a micro balance accurate down to 1 microgram. The sample was transferred into an 8 dram vial, accurately pipetted with 25 mL chlorobenzene, stirred, and protected from light for 1.5 hours. This mixture was then filtered a syringe filter (PTFE, 0.45 micron pore size) added into an HPLC auto-sampler vial.

For S₁₂, the analysis was performed on an Agilent 1260 HPLC equipped with an auto-sampler, a quaternary pump that can pump up to 5 mL/min at or below 600 bar, a thermostated column oven and a photo diode array detector (DAD). A 60 mm pathlength flow cell (Agilent G4212-60007) was used to enhance the sensitivity. EZChrom Elite Version 3.3.2 SP2 was the chromatography data system used. An Agilent Eclipse XDB-C18 column that is 4.6×150 mm with 3.5 micron particles (PN 963967-902) was used as the separation column. Pure methanol was used as the mobile phase. The isocratic method was 20 minutes long with a flow rate of 0.8 mL/min. Column temperature was kept at 35° C. Injection volume was 5 microliter. 254 nm was the UV wavelength chosen with a data acquisition rate of 2.5 Hz. The quantitation was achieved by a 5 level linear calibration curve and plugging in the S₁₂ peak area of the sample of interest to calculate the concentration of S₁₂ in the solution. For solid samples, the weight percentage of S₁₂ in the original sample was calculated based on the concentration of the final solution, volume of the solution (25 mL) and the sample weight.

For S₈, the analysis was performed on an Agilent 1200 HPLC equipped with an auto-sampler, a quaternary pump that can pump up to 5 mL/min at or below 400 bar, a thermostated column oven and a photo diode array detector (DAD). EZChrom Elite Version 3.3.2 SP2 was the chromatography data system used. An Agilent Eclipse Plus C18 column that is 4.6×100 mm with 3.5 micron particles (PN 959961-902) was used as the separation column. A guard column, (Phenomenex security guard HPLC guard cartridge system with a C18 cartridge (PN KJO-4282)) was used. Pure methanol was used as the mobile phase. The isocratic method was 15 minutes long with a flow rate of 0.8 mL/min. Column temperature was kept at 35° C. Injection volume was 5 microliter. 254 nm was the UV wavelength chosen with a data acquisition rate of 10 Hz. A linear calibration curve was obtained by plotting the S₈ concentration of calibration standard solutions against the corresponding peak areas. Concentration of S₈ in the sample was calculated using the equation below where RF is the slope of the calibration curve, volume is the final volume of sample (25 mL). Weight is the weight of the original sample. This equation applies for both solid and liquid sample types.

$$Wt {\%}_{S 8} = \frac{{Area}_{S 8} ( a . u . ) \times Volume ( mL )}{RF ( a . u . \cdot {mg}^{- 1} mL ) \times {Weight}_{Sample} ( g )} \times \frac{1 g}{1000 mg} \times 100 \%$$

Titration for Molecular Bromine—This test method describes the iodometric determination of free bromine with concentrations from approximately 0.1% (100 ppm) to 100%. Equipment needed includes: a balance capable of weighing to 0.0001 g; magnetic stirrer and stir bars; Metrohm 904 Titrando equipped with appropriate burette. This method employs potentiometric titration using sodium thiosulfate and a combination platinum electrode. Bromine is reacted with potassium iodide in acidified medium (acetic acid:H₂O=9:1). The liberated iodine is titrated potentiometrically with sodium thiosulfate. The reaction process is shown in the following equations:

H+Br₂+2I⁻→I₂+2Br⁻

I₂+2[S₂O₃]²⁻→[S₄O₆]²⁻+2I⁻

Depending on the bromine concentration of the sample, 0.05 to 10 grams of the bromine sample was weighted to a titration cell. 30 ml acetic acid aqueous solution (90%), 2 ml KI aqueous solution (50%), and 30 ml H₂O was added to the cell in that sequence. The mixed solution was stirred under nitrogen purge for 1 min and titrated with 0.1 N Na₂S₂O₃ to the endpoint, which was determined potentiometrically by a combination platinum electrode. The concentration of bromine was calculated by:

$$\% Bromine = \frac{( V 2 - V 1 ) \times N \times 79.9 \times 100}{Wt \times 100 \; 0}$$

Where: V2=volume of titrant used for the sample
V1=volume of titrant used for blank
N=normality of sodium thiosulfate
Wt=weight of sample equivalent weight of bromine=79.9
Equipment needed includes:
A balance, capable of weighing to 0.0001 g, or equivalent
Magnetic stirrer and stir bars
Metrohm 904 Titrando equipped with appropriate burette

### EXAMPLES

Electrolysis cell—For examples 2 through 5, the same electrochemical cell, a Micro Flow Cell manufactured by Electrocell, was used. The cell was set up in a two-compartment configuration with a 4 mm gap between electrode and membrane providing 10 cm² electrode surface area in each chamber. The unit was equipped with PTFE end frames, PVDF turbulence mesh, Viton gaskets, Nafion 424 membrane, and plate style graphite electrodes in each chamber. Each compartment of the cell was piped to a small feed tank and piston pump fitted with a variable speed QVG50 drive and V300 stroke controller, and Q1CTC pump head (all manufactured by Fluid Metering Inc.). The cooling section on the outside of electrodes was attached to a Haake DC30 circulating bath filled with water and controlled at 40° C. Power was supplied to the cell by a Model Sorensen XPH 35-5 manufactured by AMETEK Programmable Power. It was operated in constant amperage mode.

Samples of the anolyte and catholyte solutions were analyzed by a titration method to determine equivalents of molecular bromine contained therein. UniQuant analysis was done to determine Na, S, and total bromine content of samples.

Example 1. Large-scale preparation of (TMEDA)Zn(S₆) complex. Two jacketed glass-lined 1893-liter steel reactors, each fitted with two pitched blade turbine impellers, glycol cooling fluid or steam heating on the jacket, nitrogen purge system, solids charging funnel, and pumped addition line was used to produce (TMEDA)Zn(S₆) used in Examples 14 and 15. Methanol (>99 wt % purity, 469 kgs) was charged to the first reactor, stirred at 100 rpm at room temperature, about 18° C. 35.0 kgs of hydrous Na₂S (60% sulfide, 40% water by mass) was added through the charging funnel, followed by 43.6 kg of sulfur powder, and finally 3 kgs of methanol to ensure all solids were washed into the reactor. Agitation was increased to 200 rpm and an additional 163.2 kgs of methanol was charged to the first reactor. The contents of the first reactor were heated by 1 barg steam on the reactor jacket to reflux temperature, about 65° C. and held for about 4 hours until all solids were dissolved completely and sodium polysulfide salt (nominally average of Na₂S₆). After the four-hour hold time, the reactor was cooled to about 30° C. Methanol (>99 wt % purity, 437 kgs) was charged to the second reactor, stirred at 100 rpm at about 25° C. Zinc acetate dihydrate (54.8 kilograms) was added through the charging funnel, followed by 3 kgs of methanol to ensure all solids were washed into the reactor. Agitation was increased to 200 rpm and 43.1 kgs of TMEDA was pumped into the second reactor, followed by 3 kgs of methanol to ensure all of the TMEDA was introduced into the reactor. The contents were stirred for about 1 hour to ensure complete dissolution of solids and formation of (TMEDA)Zn(OAc)₂. At this point, the contents of the first reactor were pumped into the second reactor over about one hour, resulting in the reaction of the (TMEDA)Zn(OAc)₂ with Na₂S₆ to form (TMEDA)Zn(S₆) and sodium acetate by-product. An additional 50 kilograms of methanol was added to the first reactor, agitated, and pumped into the second reactor. The second reactor was agitated for an additional two hours. Upon completion of the hold time, the contents of the second reactor were pumped to a stainless steel nutsche fitted with a polypropylene cloth (10 micron nominal size). An additional 490 kgs of methanol was added to the second reactor and the contents were pumped over the solids on the nutsche to ensure removal of excess TMEDA and by-product sodium acetate from the product (TMEDA)Zn(S₆) solids. Upon completion of the wash, the solids were covered with a polypropylene sheet and pulled under vacuum (˜0.1 bara) for several hours to remove liquid. The solids were shoveled onto stainless steel pans and dried in a vacuum oven overnight at 50° C. The dried solids weighed 94 kgs, and was analyzed to be 95.4 wt % (TMEDA)Zn(S₆) by NMR and 4 wt % S₈ by LC. Feed amounts and results are summarized in Table 1.

TABLE 1
Feed, wash, and product materials

| Feed materials | Mass, kg |
|---|---|
| Methanol | 1128.2 |
| Hydrous Na₂S | 35.0 |
| S₈ powder | 43.6 |
| Zn(OAc)₂*2H₂O | 54.8 |
| TMEDA | 43.1 |
| Wash materials | Mass, kg |
| Methanol | 490 |
| Product | Mass, kg |
| (TMEDA)Zn(S₆) | 94.0 |

Example 2. Effect of current density on single pass electrolysis. This experiment illustrates the effect of current density on conversion of NaBr and sodium polysulfide solutions, using the two-compartment cell described above. An anolyte solution (35 wt % NaBr) was prepared by dissolution of 175 g of NaBr crystals in 325 g of demineralized water. The sodium polysulfide solution, rank of 4 (i.e., Na₂S₄), was prepared by dissolution of 117.2 g of Na₂S.9H₂O and 46.9 g of cyclooctasulfur flakes in 335.9 g of demineralized water. The sodium polysulfide solution was fed to the cathode chamber at 0.8 ml/min, the NaBr solution was fed to the anolyte chamber at 1.2 ml/min. The cooling bath was set to 40° C. throughout. The power supply was set to the desired constant amperage and catholyte and anolyte chamber effluents were collected over 60 minutes. The amperage changed to a new value and the collection process repeated for four amperages. At the end of the experiment, all anolyte effluents were analyzed by the titration method for free molecular bromine equivalents and all catholyte effluents were analyzed by UniQuant for sodium content. Feed conditions and resulting analytical data, productivity (in g of Br₂ produced per hour per square centimeter of electrode area), and % conversion of NaBr are summarized in Table 2.

TABLE 2
Effect of Current Density

| | Exp 1 | Exp 2 | Exp 3 | Exp 4 |
|---|---|---|---|---|
| Current density, | 25 | 100 | 200 | 400 |
| amps/m² | | | | |
| Voltage, volts | 1.51 | 2.30 | 2.50 | 2.70 |
| Anolyte outlet, | 448 | 1982 | 5107 | 9784 |
| Br₂ equivs, | | | | |
| ppm by mass | | | | |
| Catholyte outlet, | 4.49 | 4.51 | 4.65 | 4.79 |
| Na wt % | | | | |
| Productivity, | 0.0044 | 0.019 | 0.050 | 0.096 |
| g Br₂/hr/cm² | | | | |
| % Conversion | 0.15 | 0.65 | 1.68 | 3.22 |
| of NaBr | | | | |

Example 3. High conversion electrolysis. This experiment illustrates closed recycle of catholyte polysulfide and anolyte NaBr solutions to achieve higher conversion of NaBr and sodium polysulfide solutions, using the two-compartment cell described above. An anolyte solution (35 wt % NaBr) was prepared by dissolution of 350 g of NaBr crystals in 650 g of demineralized water. The sodium polysulfide solution, rank of 4 (i.e., Na₂S₄), was prepared by dissolution of 234.6 g of Na₂S.9H₂O and 93.8 g of cyclooctasulfur flakes in 671.6 g of demineralized water. The sodium polysulfide solution was fed to the cathode chamber at 10.7 ml/min, the sodium bromide solution was fed to the anolyte chamber at 16 ml/min. The cooling bath was set to 40° C. throughout. The power supply was adjusted to achieve a constant current density of 400 amps/m². Catholyte and anolyte chamber effluents were recycled continuously over 69.15 hours. Samples of the anolyte were collected periodically to determine Br₂ content by titration. At the end of the experiment, the anolyte solution was analyzed by the titration method for free molecular bromine equivalents and the catholyte solution was analyzed by UniQuant for sodium content. Time of recycling and resulting analytical data, productivity (in grams of Br₂ produced per hour per square centimeter of electrode area), efficiency (measured coulombs/theoretical coulombs), and % conversion of NaBr are summarized in Table 3. At the end of the experiment, the rank of the polysulfide was reduced from 4.0 to 3.02.

TABLE 3
Recycle Conversion at 400 amps/m²

| | Time 1 | Time 2 | Time 3 | Time 4 |
|---|---|---|---|---|
| Time of electrolysis, hrs | 26.5 | 43.25 | 52.15 | 69.15 |
| Anolyte outlet, Br₂ equivalents, | 2.64% | 4.62% | 5.16% | 7.64% |
| wt % in NaBr solution | | | | |
| Catholyte outlet, Na wt % | N/M | N/M | N/M | 5.5% |
| Productivity, g Br₂/hr/cm² | 0.093 | 0.096 | 0.088 | 0.0925 |
| Current efficiency, % | 78.3% | 80.1% | 73.4% | 77.6% |
| % Conversion of NaBr | 9.1% | 15.2% | 16.8% | 24.7% |

Example 4. High conversion electrolysis. This experiment illustrates closed recycle of catholyte polysulfide and anolyte NaBr solutions to achieve higher conversion of NaBr and sodium polysulfide solutions, using the two-compartment cell described above. The resulting tribromide-containing anolyte chamber effluent was used in Example 7 to illustrate distillative recovery of molecular bromine and subsequent utilization of said molecular bromine in an S₁₂ synthesis reaction of Example 15. An anolyte solution (35 wt % NaBr) was prepared by dissolution of 343.2 g of NaBr crystals in 637.4 g of demineralized water. The sodium polysulfide solution, rank of 3.99 (i.e., Na₂S₄), was prepared by dissolution of 248.1 g of Na₂S.9H₂O and 92.3 g of cyclooctasulfur flakes in 614.6 g of demineralized water. The sodium polysulfide solution was fed to the cathode chamber at 10.7 ml/min, the sodium bromide solution was fed to the anolyte chamber at 16.0 ml/min. The cooling bath was set to 40° C. throughout. The power supply was adjusted to achieve a constant current density of 800 amps/m². Catholyte and anolyte chamber effluents were recycled continuously over 62 hours. At the end of the experiment, the anolyte solution (813.9 g) was analyzed by the titration method for free molecular bromine equivalents and Br—, and the catholyte solution (1105.4 g) was analyzed by UniQuant for sodium and sulfur content. Time of recycling and resulting analytical data, productivity (in grams of Br₂ produced per hour per square centimeter of electrode area), efficiency (measured coulombs/theoretical coulombs), and % conversion of NaBr are summarized in Table 4. At the end of the experiment, the rank of the polysulfide was reduced from 3.99 to 1.87.

TABLE 4
Recycle Conversion at 800 amps/m²

| | |
|---|---|
| Time of electrolysis, hrs | 62 |
| Anolyte outlet: | |
| Br₂ equivalents, wt % Br₂ | 16.3 |
| Br— equivalents, wt % Br— | 13.7 |
| Catholyte outlet: | |
| Na, wt % | 7.35 |
| Sulfur, wt % | 9.57 |
| Productivity, g Br₂/hr/cm² | 0.22 |
| Current efficiency, % | 90 |
| % Conversion of NaBr | 54.4 |

Example 5. Continuous electrolysis. This experiment illustrates a continuous electrolysis wherein fresh NaBr solution and polysulfide solution were introduced continuously to their respective recycle tanks of anolyte NaBr and catholyte polysulfide solutions using the two-compartment cell described above. Product anolyte and catholyte solutions were collected continuously from the two recycle tanks by overflow (i.e., level maintained by allowing material to overflow into product tanks). The resulting product anolyte solution was used in Example 7 to illustrate extractive recovery of molecular bromine and subsequent utilization of said molecular bromine in an S₁₂ synthesis reaction of Example 15. The resulting product catholyte solution was used in Examples 17, 19, and 29 to illustrate the synthesis of a metallasulfur derivative from a lower rank alkali metal polysulfide, and subsequent utilization of one of said MSD's in an S₁₂ synthesis reaction of Example 48. A fresh feed NaBr solution (35 wt % NaBr) was prepared by dissolution of 343.2 g of NaBr crystals in 637.4 g of demineralized water. The fresh feed sodium polysulfide solution, rank of 4.0 (i.e., Na₂S₄), was prepared by dissolution of 234.6 g of Na₂S.9H₂O and 93.79 g of cyclooctasulfur flakes in 671.6 g of demineralized water. The catholyte recycle tank was initially filled with 198 grams of polysulfide solution. Additional sodium polysulfide solution was fed to the catholyte recycle tank at a rate of 0.13 g/min. The anolyte recycle tank was initially filled with 198 grams of NaBr solution. Additional fresh sodium bromide solution was fed to the anolyte recycle chamber at a rate of 0.27 g/min. The polysulfide solution from the catholyte recycle tank was fed to the cathode chamber at 200 ml/min, the solution from the recycle anolyte tank was fed to the anolyte chamber at 200.0 ml/min. The cooling bath was set to 40° C. throughout. The power supply was adjusted to achieve a constant current density of 800 amps/m². Catholyte and anolyte chamber effluents were recycled and continuously fed fresh materials over 21 hours, with overflows from the recycle catholyte and anolyte tanks were collected in product tanks. At the end of the experiment, the overflow anolyte solution (250 g) was analyzed by the titration method for free molecular bromine equivalents and Br—, and the overflow catholyte solution (220 g) was analyzed by UniQuant for sodium and sulfur content. Time of recycling and resulting analytical data, productivity (in grams of Br₂ produced per hour per square centimeter of electrode area), efficiency (measured coulombs/theoretical coulombs), and % conversion of NaBr are summarized in Table 5. At the end of the experiment, the rank of the overflow catholyte (polysulfide) solution was reduced from 4.00 to 1.97. Portions of the overflow catholyte solution and overflow anolyte solutions were used in Examples 21-22 and Examples 48-49 respectively.

TABLE 5
Continuous Electrolysis at 800 amps/m²

| | |
|---|---|
| Time of electrolysis, hrs | 21 |
| Anolyte overflow product: | |
| Br₂ equivalents, wt % Br₂ | 5.45% |
| Br— equivalents, wt % Br— | 20.64% |
| Catholyte overflow product: | |
| Na, wt % | 6.78% |
| Sulfur, wt % | 9.28 |
| Productivity, g Br₂/hr/cm² | 0.29 |
| Current efficiency, % | 90 |
| % Conversion of NaBr (based | 21% |
| on outlet composition) | |

Example 6. Distillation of NaBr/Br₂ solution. This example demonstrates the recovery by distillation of molecular bromine from an aqueous NaBr/NaBr₃/Br₂ solution. A ten-plate silvered glass, vacuum-jacketed Oldershaw column (2.5 cm inside diameter) was fitted with a reboiler, comprising a glass 2 liter-3 neck round bottom flask with magnetic stirrer plate and electric heating mantle. Reflux was provided by a silvered glass vacuum-jacketed, magnetically-controlled vapor-dividing takeoff head fitted with a circulating cooling bath set at 1° C. The feed was introduced to the fifth tray of the column via a piston pump, and the column and feed tank (one liter glass vessel) were kept under a positive argon purge vented through a dry ice trap. All feed, product, and venting lines were either PTFE (Teflon) or C-Flex® tubing (Br₂ compatible).

The aqueous NaBr/NaBr₃/Br₂ feed to the column was prepared as follows. 525.88 g of NaBr were dissolved in 977.23 g of demineralized water. A portion, 822.2 g, of this NaBr solution was mixed with 110.75 g of Br₂, nominally 99 wt % purity to form 922.2 g of an aqueous NaBr/NaBr₃/Br₂ for distillation feed. The feed solution was one phase.

Prior to introduction of the feed, the reboiler pot was charged with 680.27 grams of the −35 wt % NaBr solution prepared above. The heating mantle was turned on and the column was heated at total reflux until the column reached a steady temperature profile at atmospheric pressure (˜0.98 bara). Once the feed mixture was started, the column was kept at total reflux conditions until the distillate temperature reached a steady state temperature of about 40.6-50.6° C. (approximately the Br₂-water azeotrope). Once stabilized, distillate was removed at a reflux ratio 2-1 to maintain the distillate temperature. After the feed mixture finished, distillate continued to be collected until the distillate temperature began to increase. At that point, the accumulated distillate was collected and labeled as D1. Additional distillate (D2) was collected until the distillate temperature approached the boiling point of water and the column was put on total reflux. Once the column cooled, the base pot material was collected as B1. All materials and samples were weighed and recorded. Each sample was analyzed by a titration method to determine Br— and Br₂ equivalents, and by UniQuant for Na. Results are summarized in Table 5. Results for a second essentially identical distillation (except with the reflux ratio kept at 5) are also given in Table 6. In both experiments, all of the Br₂ equivalents contained in the feed mixture were recovered to the distillate

TABLE 6
Distillation Conditions

| | Experiment 1 | | Experiment 2 | |
|---|---|---|---|---|
| Feed Flow, | 3.0 | | 3.0 | |
| ml/minute | | | | |
| Reflux ratio | 2.0 | | 5.0 | |
| Dist T, ° C. | 50.2 to 50.6 | | 50.1 to 50.2 | |
| Bottoms T, ° C. | 106.5 to 107.1 | | 106.6 to 106.9 | |
| Masses, grams | | | | |
| Reboiler initial | 680.27 | | 680.37 | |
| charge | | | | |
| Feed | 933.05 | | 933.87 | |
| D1 top phase | 13.56 | | 19.78 | |
| D1 bottom phase | 88.40 | | 88.01 | |
| D2 | 37.02 | | 5.73 | |
| B1 | 1433.7 | | 1470.3 | |
| Analysis, wt % | Br₂* | NaBr | Br₂ | NaBr |
| Feed | 11.8 wt % | 30.9% | 11.8 wt % | 30.9% |
| D1 top phase | 2.75% | N/D | 2.75% | N/D |
| D1 bottom phase | >99% | N/D | >99% | N/D |
| D2 | 2.76% | N/D | 91.5% | N/D |
| B1 | N/D | 32.6% | N/D | 31.5% |

*as Br₂ equivalents, i.e., free Bᵣ₂ or Bᵣ₂ as part of Br₃

Example 7. Distillation of NaBr₃ anolyte from electrolysis cell. The distillation system described in Example 6 was used to distill the NaBr₃ anolyte solution produced in Example 4, obtained from the electrolysis of NaBr/Na₂Sₓ aqueous solutions. Prior to introduction of the feed from Example 4, the reboiler pot was charged with 600.55 g of a 22 wt % NaBr solution prepared by dissolving NaBr in demineralized water. The feed tank was charged with 795.71 g of anolyte tribromide solution. The heating mantle was turned on and the column was heated at total reflux until the column reached a steady temperature profile at atmospheric pressure (˜0.98 bara). Once the feed mixture was started at a rate of 4 ml/min, the column was kept at total reflux conditions until the distillate temperature reached a steady state temperature of about 50.3° C. Once stabilized, distillate was removed at a reflux ratio of 5-1 to maintain the distillate temperature. After the feed mixture finished, distillate continued to be collected until the distillate temperature began to increase. At that point, the accumulated distillate was collected and labeled as D1. Additional distillate was collected (D2) until the distillate temperature approached the boiling point of water and the column was put on total reflux. A sample (B1) of the base pot was taken at this point and the heat was turned off. Once the column cooled, the base pot material was collected (B2). All materials and samples were weighed and recorded. Each sample was analyzed by a titration method to determine Br— and Br₂ equivalents, and by UniQuant for Na. Note that both the D1 and D2 samples comprised two phases, with small upper aqueous layers. The two phases were homogenized for analysis, but separated, with the lower bromine layer used in Example 15 for S₁₂ preparation. Results of the distillation are summarized in Table 7. The accountability of Br₂ equivalents in the feed as compared to Br₂ in the combined D1, D2, B1, and B2 samples was 96.7%. Recovery of Br₂ to the D1 and D2 samples was 99.5% of the accounted Br₂ equivalents.

TABLE 7
Summary of Distillation Conditions and Results

| Feed Flow, ml/minute | 4.0 | |
|---|---|---|
| Reflux ratio | 5.0 | |
| Dist T, ° C. | 50.2 to 50.3 | |
| Bottoms T, ° C. | 106.4 to 107.1 | |
| Masses, g | | |
| Reboiler initial charge | 600.55 | |
| Feed | 795.71 | |
| D1 | 117.3 | |
| D2 | 15.22 | |
| B1 | 24.57 | |
| B2 | 1221.36 | |
| Analysis, wt % | Br₂* | NaBr |
| Feed | 16.36 wt % | 17.9% |
| D1 | 94.64% | N/D |
| D2 | 94.51% | N/D |
| B1 | 0.02% | 17.6% |
| B2 | 0.048% | 21.79% |

Example 8. Phase Equilibrium of Chlorobenzene-NaBr—Br₂—NaBr₃ system. This experiment was carried out to determine the partitioning of Br₂ equivalents between an organic solvent phase comprising chlorobenzene (PhCl) and an aqueous sodium bromide/tribromide/molecular bromine (NaBr/NaBr₃/Br₂) mixture. An aqueous solution of 35 wt % NaBr in demineralized water was prepared by mixing 35 g of NaBr crystals with 65 g of water. At about 20° C., Br₂ was added to two different aliquots of the NaBr solution and allowed to disperse and equilibrate to NaBr/NaBr₃/Br₂. Each of these mixtures was then contacted with PhCl, mixed thoroughly and allowed to separate into two liquid phases at 20° C. These phases were then separated and analyzed by the titration method described above to determine bromide and Br₂ equivalents in each phase. The partition coefficient of Br₂ equivalents was calculated as:

P_{Br2}=wt % Br₂ equiv. org. phase/wt % Br₂ equiv in aq. phase

Initial weights and analytical results are given in Table 8.

TABLE 8
Bromine Phase equilibria

| | | Aq | Br₂ | | Wt % | Partition |
|---|---|---|---|---|---|---|
| | PhCl | NaBr | Added | Wt % | Br₂ | co- |
| | Mass, | Mass, | to NaBr, | Br₂ Aq | Organic | efficient, |
| Exp # | grams | grams | grams | Phase | Phase | P_{Br2} |
| 6-1 | 12.3835 | 12.3930 | 0.3002 | 0.80% | 1.50% | 1.88 |
| 6-2 | 13.2254 | 11.8826 | 1.3200 | 3.64% | 6.68% | 1.84 |

Example 9. Phase Equilibrium of Carbon Disulfide-NaBr—Br₂—NaBr₃ system. This experiment was carried out to determine the partitioning of Br₂ equivalents between an organic solvent phase comprising carbon disulfide (CS₂) and an aqueous sodium bromide/tribromide/molecular bromine (NaBr/NaBr₃/Br₂) mixture. A first aqueous solution of 23 wt % NaBr in demineralized water was prepared by mixing 19.1 g of NaBr crystals with 63.9 g of water. A second aqueous solution of 15 wt % NaBr in demineralized water was prepared by mixing 12.6 g of NaBr crystals with 71.4 g of water. At about 20° C., Br₂ was added to two different aliquots of the NaBr solution and allowed to disperse and equilibrate to NaBr/NaBr₃/Br₂. Each of these mixtures was then contacted with CS₂, mixed thoroughly and allowed to separate into two liquid phases at 20° C. These phases were then separated and analyzed by the titration method described above to determine the Br₂ equivalents in each phase. The partition coefficient of Br₂ equivalents was calculated as:

P_{Br2}=wt % Br₂ equiv. org. phase/wt % Br₂ equiv in aq. phase

Initial weights and analytical results are given in Table 9.

TABLE 9
Bromine Phase Equilibria

| | | | | | Br₂ | Br₂ | |
|---|---|---|---|---|---|---|---|
| | | aq. | aq | | aq | org | |
| | | NaBr | NaBr, | Br₂ Added | phase | phase | partition |
| | CS₂, g | wt % | g | to NaBr, g | wt % | wt % | coefficient |
| 7-1 | 15.019 | 23% | 24.7486 | 0.251 | 0.21% | 0.71% | 3.31 |
| 7-2 | 15.0406 | 23% | 22.0092 | 3.347 | 3.36% | 8.51% | 2.53 |
| 7-3 | 15.2238 | 15% | 24.8399 | 0.189 | 0.13% | 0.52% | 3.99 |
| 7-4 | 15.0418 | 15% | 22.9618 | 2.044 | 1.58% | 5.99% | 3.78 |

Example 10. Continuous Extraction of NaBr—Br₂—NaBr₃ system with CS₂ as solvent. A continuous extraction experiment was carried out to determine the efficacy of using 100 wt % CS₂ as the solvent for recovering Br₂ from a mixture of NaBr—Br₂—NaBr₃. The continuous extraction was carried out in a Karr column comprising a glass column (19 mm inside diameter, top and bottom glass disengagement sections, (25.4 mm inside diameter and 200 mm in length), and feed ports about 10 cm below and above the respective top and bottom disengagement sections. The total height of the resulting column was approximately 2 meters. Agitation in the column was supplied by an tantalum impeller shaft fitted with 118 tantalum plates, each with eight radial rectangular petals (to provide gaps for liquid flow paths), spaced 12.5 mm apart in the column section. The impeller shaft was attached at the top of the extractor to an air-driven motor fitted with a concentric gear to convert rotational motion into reciprocal motion. The agitator stroke length (i.e., extent of vertical motion) was 6.4 mm, and varied from 100 to 300 strokes per minute. The continuous phase comprised aqueous sodium bromide, with the liquid-liquid phase interface maintained in the bottom disengagement section. The two feeds were supplied to the column via piston pumps from glass vessels, while the underflow (more dense) product and the top, overflow (less dense) product were collected in glass vessels. The top product was collected by gravity overflow from the upper disengagement section, while the bottoms product flow was controlled by a variable rate piston pump. A feed mixture comprising 10 wt % NaBr and 9.53 wt % Br₂ was synthesized by combining a 11 wt % aqueous NaBr solution with molecular bromine. The extraction column was initially charged with 11 wt % aqueous NaBr at room temperature. The aqueous solution was pumped to the lower feed point and CS₂ solvent to the upper feed point. Extraction conditions and results are given in Table 10 for different agitation rates.

TABLE 10
Extraction Conditions and Results for Experiment 10

| | Experiment 10a | Experiment 10b |
|---|---|---|
| Flows, g/min | | |
| Br2/NaBr feed | 25.30 | 23.00 |
| CS2 solvent | 21.00 | 21.00 |
| Raffinate | 21.82 | 17.52 |
| Extract | 24.36 | 25.78 |
| S/F weight ratio | 0.83 | 0.91 |
| Agitation | 336 | 384 |
| (Strokes/min) | | |
| wt % Br2 in extract | 9.42% | 9.53% |
| raffinate color | faint yellow | water white |
| Br₂ Recov to Extract | 99.9999% | 100.0000% |

Example 11. Continuous Extraction of NaBr—Br₂—NaBr₃ system with ethyl acetate/CS₂ as solvent. A continuous extraction experiment was carried out to determine the efficacy of using a mixture of 7/93 wt % ethyl acetate/CS₂ as the solvent for recovering Br₂ from a mixture of NaBr—Br₂—NaBr₃. The continuous extraction was carried out in the Karr column described in detail in Experiment 10. A feed mixture comprising 10 wt % NaBr and 9.53 wt % Br₂ was synthesized by combining a 11 wt % aqueous NaBr solution with molecular bromine. The extraction column was initially charged with 11 wt % aqueous NaBr at room temperature. The aqueous solution was pumped to the lower feed point and 7/93 weight % ethyl acetate/CS₂ solvent to the upper feed point. Extraction conditions and results are given in Table 11.

TABLE 11
Extraction Conditions and Results for Experiment 11

| | Experiment 11 |
|---|---|
| Flows, g/min | |
| Br2/NaBr feed | 23.00 |
| CS2/Ethyl acetate solvent | 20.30 |
| Raffinate | 19.99 |
| Extract | 22.01 |
| S/F weight ratio | 0.88 |
| Agitation (Strokes/min) | 288 |
| wt % Br2 in extract | 9.98% |
| raffinate color | Water white |
| Br2 Recov to Extract | 100.00% |

Example 12. Batch Distillation of Electrolysis-derived NaBr/HBr Solution with addition of H₂O₂. This experiment illustrates the control of electrolysis solution pH and conversion of HBr to Br₂ by reaction with H₂O₂ under distillation conditions. An electrolysis-derived NaBr₃ solution as prepared in a polysulfide/NaBr cell system as in Example 5. The resulting NaBr₃ solution then was distilled continuously in the apparatus and in the fashion described in Example 7 to remove molecular Br₂ as a distillate product. The underflow NaBr solution was further analyzed by titration methods to determine remaining Br₂, HBr, sulfate, Br— weight percentages, and pH (Table 12, “Start” column). The underflow solution was a very faint brown-orange color. A portion of the underflow solution (150.17 g) was transferred to a batch distillation column comprising a 2.54 cm ID×15 cm H vacuum jacketed, silvered glass column packed with 3 mm glass helices, a heating mantle, glass reflux head, cooling water condenser, dry ice trap, receiver flask (50 ml), reboiler flask (250 ml volume), and 25 ml addition funnel fitted to the reboiler. 8.4 grams of 10 wt % H₂O₂ in water was added to the addition funnel. Heat was applied to the reboiler. Once the contents of the reboiler were boiling vigorously and the column heated up, the stopcock of the addition funnel was opened sufficiently to add the peroxide solution dropwise over 15 minutes. Immediately upon addition of peroxide, a brown vapor was seen to distill from the reboiler and collect in the receiver, along with water. The distillation was continued for 20 minutes after peroxide addition was completed, with further removal of water, to ensure no further Br₂ remained in the column. A total of 0.69 g of Br₂ (by titration method) and 24.7 g of water were collected in the receiver. The remaining water-white reboiler contents (133.1 g) were analyzed by titration methods to determine Br₂, HBr, sulfate, Br—, weight percentages, and pH (Table 12, “End” column). Essentially 100% of the HBr content of the Start material was converted to Br₂ and removed by distillation. The pH of the End solution was substantially increased to 2.73, from 0.78 of the Start material.

TABLE 12
Batch Distillation Results

| | Start | End |
|---|---|---|
| HBr, wt % | 0.462 | None detected |
| SO₄⁻², wt % | 0.0035 | 0.0039 |
| Br— (as NaBr), wt % | 33.8 | 38.1 |
| Br₂, wt % | 0.011 | 0.004 |
| pH | 0.78 | 2.73 |

Example 13. Extraction of Anolyte product with CS₂ to produce Br₂ solution. This experiment illustrates the extraction of molecular bromine from an electrolysis-derived anolyte solution, comprising NaBr, NaBr₃, and Br₂, using CS₂ as the solvent. The resulting CS₂/Br₂ extract was used in Example 44 as the bromine source for the synthesis of S₁₂ from the metallasulfur derivative (TMEDA)Zn(S₆). A portion of dark brown anolyte solution from Example 5 (160.06 g) was contacted with a first portion of 170.45 grams of CS₂ in a 250 ml glass separatory funnel. The mixture was shaken briefly and allowed to phase separate for 30 minutes. The lower CS₂, comprising extracted Br₂ and CS₂, was drained off into a collection vessel. The visibly lighter upper phase from the first extraction was contacted with a second portion of 170.04 g of fresh CS₂, shaken, and allowed to separate into two phases. The bottom layer was drained off again and combined with the first extract. The combined extract and the final, light colored upper raffinate layer from the second extraction were both analyzed for Br₂ and Br content. Results are given in Table 13.

TABLE 13
Extraction Results

| | Feed Anolyte | | |
|---|---|---|---|
| | solution | Raffinate layer | Combined extract |
| Mass, g | 160.06 | 146.77 | 346.22 |
| Br2 wt % | 5.45% | 0.33% | 2.35% |
| Br— wt % | 20.64% | 16.19% | None detected |

Example 14. Preparation of S₁₂ from Purchased Bromine. Chlorobenzene (1.82 kg) was added to a 6 L, 4-neck jacketed glass reactor equipped with a mechanical stirrer (reaching closely to the vessel walls), baffle, thermocouple, N₂ bubbler, and water condenser. To this flask, the zinc complex, (TMEDA)Zn(S₆) (216.1 g, 95.4 wt % purity), produced as described above in example 1 was added and the resulting slurry was cooled to −5° C. using a glycol/water chiller and agitated at 350 rpm. Bromine (Sigma-Aldrich, >99%, 91.03 g) was added to 455 g of chlorobenzene and chilled to about 0° C. The Br₂ solution was pumped into the reaction flask at 4 ml/min over the course of about 110 minutes, while agitating at 350 rpm, and maintaining the reactor contents at less than about 2° C. The reactor contents were held with agitation for an additional 20 minutes after addition of the bromine solution was complete. Methanol was added (400 g) to the reactor while maintaining agitation, the temperature was increased to 20° C. The solution was stirred for 30 minutes, filtered, washed with 4 liters of methanol to remove residual (TMEDA)ZnBr₂ and suctioned dry. The wet solids were dried in a vacuum oven overnight at 40° C., with a resulting dry weight of 94.12 g. Evaluation using the UniQuant elemental analysis method showed the material to be 92.1% S, 2.76% Zn, 5.07% Br. LC analysis indicated 61.4 wt % S₁₂, 9.8 wt % S₈. The yield of total sulfur contained in the feed (TMEDA)Zn(S₆) to product S₁₂ was 55%.

Example 15. Preparation of S₁₂ from decanted bromine from first distillation. This example illustrates the preparation of S₁₂ using the distilled bromine recovered in Example 7. Chlorobenzene (1.82 kg) was added to a 6 L, 4-neck jacketed glass reactor equipped with a mechanical stirrer (reaching closely to the vessel walls), baffle, thermocouple, N₂ bubbler, and water condenser. To this flask, the zinc complex, (TMEDA)Zn(S₆) (216.1 grams, 95.4 wt % purity), produced as described above in section “Large-scale preparation of (TMEDA)Zn(S₆) complex” was added and the resulting slurry was cooled to −5° C. using a glycol/water chiller and agitated at. Bromine (bromine phase from distillate decanter, Example 4, >99%, 91.06 gram) was added to 455 grams of chlorobenzene and chilled to about 0° C. The bromine solution was pumped into the reaction flask at 4 ml/min over the course of about 110 minutes, while agitating at 350 rpm, and maintaining the reactor contents at less than about 2° C. The reactor contents were held with agitation for an additional 20 minutes after addition of the bromine solution was complete. 400 grams of methanol were added to the reactor while maintaining agitation, the temperature was increased to 20° C. The solution was stirred for 30 minutes, filtered, washed with 2 liters of methanol to remove residual metallabromide derivative ((TMEDA)ZnBr₂) and suctioned dry. The wet solids were dried in a vacuum oven overnight at 40° C., with a resulting dry weight of 84.86 grams. Evaluation using the UQ elemental analysis method showed the material to be 99.36% sulfur. 0.07% Zn, 0.53% Br. LC analysis indicated 59.4 wt % S₁₂, 3.3 wt % S₈. Yield of total sulfur contained in the feed (TMEDA)Zn(S₆) to product S₁₂ was 48%. Although, the yield of S₁₂ was lower than Example 11, the product was easier to wash and showed less residual Zn and Br.

Example 16. Synthesis of (TMEDA)Zn(S₆) in MeOH. Under a nitrogen atmosphere, a 200 mL Schlenk flask equipped with a magnetic stir bar, was charged with Na₂S.xH₂O (60%, Scales, 38.4 mmol), sulfur powder (6.23 g, 192.2 mmol), and methanol (91 g). The resulting suspension was refluxed for 1 hr to obtain a dark red solution. In a separate 500 mL three-neck flask, (TMEDA)ZnX₂ was formed in-situ by combining ZnX₂ (X=OAc, Br; 34.9 mmol), TMEDA (6.15 g, 52.4 mmol), and methanol (63 g). Upon transferring the red solution to the (TMEDA)ZnX₂ solution, bright yellow precipitate of (TMEDA)Zn(S₆) formed immediately. The resulting slurry was stirred for additional 1 hr, filtered on a Buchner funnel (5 micron filter paper) and further washed with methanol. The solids were removed from the filter and dried under vacuum at 40° C. and 0.1 MPa (98.3% isolated yield). The solid product was characterized by ¹H NMR spectroscopy, Uniquant X-ray fluorescense, and liquid chromatography (LC).

Example 17. Synthesis of (TMEDA)Zn(S₆) in MeOH Using Electrochemically-Generated Aqueous Na₂Sₓ Solution. Under a nitrogen atmosphere, a 200 mL Schlenk flask equipped with a magnetic stir bar, was charged with electrochemical cell-generated polysulfide solution (produced in Example 5, 14 wt % assay, 25.00 g, 33.5 mmol), sulfur powder (4.56 g, 140.8 mmol), and methanol (69 g). The resulting suspension was refluxed for 1 hr to obtain a dark red solution. In a separate 500 mL three-neck flask, (TMEDA)ZnBr₂ was formed in-situ by combining anhydrous ZnBr₂ (7.34 g, 31.9 mmol), TMEDA (5.62 g, 47.9 mmol), chlorobenzene (53 g) and methanol (13 g). Upon transferring the red solution to the (TMEDA)ZnBr₂ solution, bright yellow precipitate of (TMEDA)Zn(S₆) formed immediately. The resulting slurry was stirred for additional 1 hr, filtered on a Buchner funnel (5 micron filter paper) and further washed with methanol. The solids were removed from the filter and dried under vacuum at 40° C. and 0.1 MPa (86.2% isolated yield). The solid product was characterized by ¹H NMR spectroscopy (90.2% purity), Uniquant X-ray fluorescense, and liquid chromatography (LC). This sample contained ˜9% of free sulfur.

Example 18. Synthesis of (TMEDA)Zn(S₆) in EtOH. Under a nitrogen atmosphere, a 200 mL Schlenk flask equipped with a magnetic stir bar, was charged with Na₂S.xH₂O (60%, Scales, 11 mmol), sulfur powder (1.78 g, 55 mmol), and ethanol (39 g). The resulting suspension was refluxed for 1 hr to obtain a dark red solution. In a separate 500 mL three-neck flask, (TMEDA)ZnX₂ was formed in-situ by combining ZnX₂ (X=OAc, Br; 10 mmol), TMEDA (1.20 g, 10.2 mmol), and ethanol (42 g). Upon transferring the red solution to the (TMEDA)ZnX₂ solution, bright yellow precipitate of (TMEDA)Zn(S₆) formed immediately. The resulting slurry was stirred for additional 1 hr, filtered on a Buchner funnel (5 micron filter paper) and further washed with ethanol. The solids were removed from the filter and dried under vacuum at 40° C. and 0.1 MPa (96.7% isolated yield). The solid product was characterized by ¹H NMR spectroscopy, Uniquant X-ray fluorescense, and liquid chromatography (LC).

Example 19. Synthesis of (TMEDA)Zn(S₆) in EtOH Using Electrochemically-Generated Aqueous Na₂Sₓ Solution. Under a nitrogen atmosphere, a 200 mL Schlenk flask equipped with a magnetic stir bar, was charged with electrochemical cell-generated polysulfide solution (produced in Example 5.14 wt % assay, 25.00 g, 33.5 mmol), sulfur powder (4.56 g, 140.8 mmol), and ethanol (69 g). The resulting suspension was refluxed for 1 hr to obtain a dark red solution. In a separate 500 mL three-neck flask, (TMEDA)ZnBr₂ was formed in-situ by combining anhydrous ZnBr₂ (7.34 g, 31.9 mmol), TMEDA (5.62 g, 47.9 mmol), chlorobenzene (53 g) and methanol (13 g). Upon transferring the red solution to the (TMEDA)ZnBr₂ solution, bright yellow precipitate of (TMEDA)Zn(S₆) formed immediately. The resulting slurry was stirred for additional 1 hr, filtered on a Buchner funnel (5 micron filter paper) and further washed with methanol. The solids were removed from the filter and dried under vacuum at 40° C. and 0.1 MPa (89.1% isolated yield). The solid product was characterized by ¹H NMR spectroscopy (91.2% purity), UniQuant X-ray fluorescense, and liquid chromatography (LC). This sample contained ˜7% of free sulfur.

Example 20. Synthesis of (TMEDA)Zn(S₆) in iPrOH. Under a nitrogen atmosphere, a 200 mL Schlenk flask equipped with a magnetic stir bar was charged with Na₂S.xH₂O (60%, Scales, 38.4 mmol), sulfur powder (6.23 g, 192.2 mmol), and isopropanol (85 g). The resulting suspension was refluxed for 1 hr to obtain a dark red solution. In a separate 500 mL three-neck flask, (TMEDA)ZnX₂ was formed in-situ by combining ZnX₂ (X=OAc, Br; 34.9 mmol), TMEDA (4.51 g, 38.4 mmol), and isopropanol (69 g). Upon transferring the red solution to the (TMEDA)ZnX₂ solution, bright yellow precipitate of (TMEDA)Zn(S₆) formed immediately. The resulting slurry was stirred for additional 1 hr, filtered on a Buchner funnel (5 micron filter paper) and further washed with methanol. The solids were removed from the filter and dried under vacuum at 40° C. and 0.1 MPa (95.1% isolated yield). The solid product was characterized by ¹H NMR spectroscopy (98.7% purity), UniQuant X-ray fluorescense, and liquid chromatography (LC).

Example 21. Synthesis of (TMEDA)Zn(S₆) in PhCl-MeOH. Under a nitrogen atmosphere, a 200 mL Schlenk flask equipped with a magnetic stir bar, was charged with Na₂S.xH₂O (60%, Scales, 38.4 mmol), sulfur powder (6.23 g, 192.2 mmol), and methanol (91 g). The resulting suspension was refluxed for 1 hr to obtain a dark red solution. In a separate 500 mL three-neck flask, (TMEDA)ZnX₂ was formed in-situ by combining ZnX₂ (X=OAc, Br; 34.9 mmol), TMEDA (6.15 g, 52.4 mmol), and a 80:20 mixture of chlorobenzene and methanol. Upon transferring the red solution to the (TMEDA)ZnX₂ solution, bright yellow precipitate of (TMEDA)Zn(S₆) formed immediately. The resulting slurry was stirred for additional 1 hr, filtered on a Buchner funnel (5 micron filter paper) and further washed with methanol. The solids were removed from the filter and dried under vacuum at 40° C. and 0.1 MPa (94.4% isolated yield). The solid product was characterized by ¹H NMR spectroscopy (98.9% purity), UniQuant X-ray fluorescense, and liquid chromatography (LC).

Example 22. Synthesis of (TMEDA)Zn(S₆) in MeOH-MeOAc. Under a nitrogen atmosphere, a 200 mL Schlenk flask equipped with a magnetic stir bar, was charged with Na₂S.xH₂O (60%, Scales, 38.4 mmol), sulfur powder (6.23 g, 192.2 mmol), and methanol (27 g). The resulting suspension was heated to 40° C. for 1 hr to obtain a dark red solution. In a separate 500 mL three-neck flask, (TMEDA)ZnBr₂ was formed in-situ by combining aqueous ZnBr₂ (75%, 10.49 g, 34.9 mmol), TMEDA (6.15 g, 52.4 mmol), and methyl acetate (42 g). Upon transferring the red solution to the (TMEDA)ZnBr₂ slurry, bright yellow precipitate of (TMEDA)Zn(S₆) formed immediately. The resulting slurry was stirred for additional 1 hr at 40° C., filtered on a Buchner funnel (5 micron filter paper) and further washed with methanol. The solids were removed from the filter and dried under vacuum at 40° C. and 0.1 MPa (96.3% isolated yield). The solid product was characterized by ¹H NMR spectroscopy (99.3% purity), UniQuant X-ray fluorescence, and liquid chromatography (LC).

Example 23. Synthesis of (TMEDA)Zn(S₆) in EtOH-EtOAc. Under a nitrogen atmosphere, a 200 mL Schlenk flask equipped with a magnetic stir bar, was charged with Na₂S.xH₂O (60%, Scales, 38.4 mmol), sulfur powder (6.23 g, 192.2 mmol), and ethanol (27 g). The resulting suspension was heated to reflux for 1 hr to obtain a dark red solution. In a separate 500 mL three-neck flask, (TMEDA)ZnBr₂ was formed in-situ by combining aqueous ZnBr₂ (75%, 10.49 g, 34.9 mmol), TMEDA (6.15 g, 52.4 mmol), and ethyl acetate (42 g). Upon transferring the red solution to the (TMEDA)ZnBr₂ slurry, bright yellow precipitate of (TMEDA)Zn(S₆) formed immediately. The resulting slurry was stirred for additional 1 hr at 40° C., filtered on a Buchner funnel (5 micron filter paper) and further washed with methanol. The solids were removed from the filter and dried under vacuum at 40° C. and 0.1 MPa (89.8% isolated yield). The solid product was characterized by ¹H NMR spectroscopy (99.9% purity), UniQuant X-ray fluorescence, and liquid chromatography (LC).

Example 24. Synthesis of (TEEDA)Zn(S₆). Under a nitrogen atmosphere, a 200 mL Schlenk flask equipped with a magnetic stir bar, was charged with Na₂S.xH₂O (60%, Scales, 38.4 mmol), sulfur powder (6.23 g, 192.2 mmol), and methanol (91 g). The resulting suspension was refluxed for 1 hr to obtain a dark red solution. In a separate 500 mL three-neck flask, (TEEDA)Zn(acetate)₂ was formed in-situ by combining Zn(OAc)₂.2H₂O (7.83 g, 34.9 mmol), N,N,N′,N′-tetraethyl ethylenediamine (9.22 g, 52.4 mmol), and methanol (63 g). Upon transferring the red solution to the (TEEDA)Zn(OAc)₂ solution, bright yellow precipitate of (TEEDA)Zn(S₆) formed immediately. The resulting slurry was stirred for additional 1 hr, filtered on a Buchner funnel (5 micron filter paper) and further washed with methanol. The solids were removed from the filter and dried under vacuum at 40° C. and 0.1 MPa (97.5% isolated yield). The solid product was characterized by ¹H NMR spectroscopy (99.7% purity), UniQuant X-ray fluorescence, and liquid chromatography (LC). ¹H NMR (py-d₅, δ): 2.54 (singlet, 4H, NCH₂CH₂N), 2.47 (quartet, 8H, NCH₂CH₃), 0.97 (triplet, 12H, NCH₂CH₃).

Example 25. Synthesis of (PMDETA)Zn(S₄). Under a nitrogen atmosphere, a 200 mL Schlenk flask equipped with a magnetic stir bar, was charged with Na₂S.xH₂O (60%, Scales, 38.4 mmol), sulfur powder (3.73 g, 115.2 mmol), and methanol (91 g). The resulting suspension was refluxed for 1 hr to obtain a dark red solution. In a separate 500 mL three-neck flask, (PMDETA)Zn(OAc)₂ was formed in-situ by combining Zn(OAc)₂.2 H₂O (7.83 g, 34.9 mmol), pentamethyl diethylenetriamine (52.4 mmol), and methanol (63 g). Upon transferring the red solution to the (PMDETA)Zn(OAc)₂ solution, bright yellow precipitate of (PMDETA)ZnS₄ formed immediately. The resulting slurry was stirred for additional 1 hr, filtered on a Buchner funnel (5 micron filter paper) and further washed with methanol. The solids were removed from the filter and dried under vacuum at 40° C. and 0.1 MPa (90.1% isolated yield). The solid product was characterized by ¹H NMR spectroscopy (97.3% purity), UniQuant X-ray fluorescense, and liquid chromatography (LC). ¹H NMR (CD₃CN, δ): 2.83 (m, 2H, CH₂); 2.71 (m, 2H, CH₂); 2.59 (m, 4H, CH₂); 2.50 (s, 12H, CH₃); 2.35 (s, 3H, CH₃).

Example 26. Conversion of the Crude Filtrate, Generated from Larg-Scale Bromination Reaction to (TMEDA)Zn(S₆). Under a nitrogen atmosphere, a 200 mL Schlenk flask equipped with a magnetic stir bar, was charged with Na₂S.xH₂O (60%, Scales, 38.4 mmol), sulfur powder (6.23 g, 192.2 mmol), and methanol (91 g). The resulting suspension was refluxed for 1 hr to obtain a dark red solution. In a separate 500 mL three-neck flask, 311 g of the crude filtrate (4.35 wt % (TMEDA)ZnBr₂, contains 38.8 mmol of (TMEDA)ZnBr₂), generated from a pilot-scale bromination reaction, and TMEDA (2.28 g, 19.8 mmol) were charged at room temperature. Upon transferring the red solution to the filtrate solution, bright yellow precipitate of (TMEDA)Zn(S₆) started forming after 15 min. The resulting slurry was stirred for additional 1 hr, filtered on a Buchner funnel (5 micron filter paper) and further washed with methanol. The solids were removed from the filter and dried under vacuum at 40° C. and 0.1 MPa (91.8% isolated yield). The solid product was characterized by ¹H NMR spectroscopy (99.2% purity), UniQuant X-ray fluorescense, and liquid chromatography (LC).

Example 27. Recycling of the Bromination Filtrate to (TMEDA)Zn(S₆). Under a nitrogen atmosphere, a 200 mL Schlenk flask equipped with a magnetic stir bar, was charged with Na₂S.xH₂O (60%, Scales, 38.4 mmol), sulfur powder (6.23 g, 192.2 mmol), and methanol (91 g). The resulting suspension was refluxed for 1 hr to obtain a dark red solution. In a separate 500 mL three-neck flask, 311 g of the bromination filtrate (4.35 wt % (TMEDA)ZnBr₂, contains 38.8 mmol of (TMEDA)ZnBr₂), generated from the bromination reaction, and TMEDA (2.28 g, 19.8 mmol) were charged at room temperature. Upon transferring the red solution to the filtrate solution, bright yellow precipitate of (TMEDA)Zn(S₆) started forming after 15 min. The resulting slurry was stirred for additional 1 hr, filtered on a Buchner funnel (5 micron filter paper) and further washed with methanol. The solids were removed from the filter and dried under vacuum at 40° C. and 0.1 MPa (91.8% isolated yield). The solid product was characterized by ¹H NMR spectroscopy, UniQuant X-ray fluorescense, and liquid chromatography (LC).

Example 28. Synthesis of (TMEDA)Zn(S₆) Using Aqueous Polysulfide Solution. Under a nitrogen atmosphere, a 200 mL Schlenk flask equipped with a magnetic stir bar, was charged with electrochemical cell-generated polysulfide solution (14 wt % assay, 25.00 g, 33.5 mmol), sulfur powder (4.56 g, 140.8 mmol), and methanol (69 g). The resulting suspension was refluxed for 1 hr to obtain a dark red solution. In a separate 500 mL three-neck flask, (TMEDA)ZnBr₂ was formed in-situ by combining anhydrous ZnBr₂ (7.34 g, 31.9 mmol), TMEDA (5.62 g, 47.9 mmol), chlorobenzene (53 g) and methanol (13 g). Upon transferring the red solution to the (TMEDA)ZnBr₂ solution, bright yellow precipitate of (TMEDA)Zn(S₆) formed immediately. The resulting slurry was stirred for additional 1 hr, filtered on a Buchner funnel (5 micron filter paper) and further washed with methanol. The solids were removed from the filter and dried under vacuum at 40° C. and 0.1 MPa (91.2% isolated yield). The solid product was characterized by ¹H NMR spectroscopy, UniQuant X-ray fluorescense, and liquid chromatography (LC).

Example 29. Synthesis of (TMEDA)Zn(S₆) in MeOH Using Electrochemically-Generated Aqueous Na₂Sₓ Solution. Under a nitrogen atmosphere, a 200 mL Schlenk flask equipped with a magnetic stir bar, was charged with electrochemical cell-generated polysulfide solution (produced in Example 5, 14 wt % assay, 25.00 g, 33.5 mmol), sulfur powder (4.56 g, 140.8 mmol), and methanol (69 g). The resulting suspension was refluxed for 1 hr to obtain a dark red solution. In a separate 500 mL three-neck flask, (TMEDA)ZnBr₂ was formed in-situ by combining anhydrous ZnBr₂ (7.34 g, 31.9 mmol), TMEDA (5.62 g, 47.9 mmol), chlorobenzene (53 g) and methanol (13 g). Upon transferring the red solution to the (TMEDA)ZnBr₂ solution, bright yellow precipitate of (TMEDA)Zn(S₆) formed immediately. The resulting slurry was stirred for additional 1 hr, filtered on a Buchner funnel (5 micron filter paper) and further washed with methanol. The solids were removed from the filter and dried under vacuum at 40° C. and 0.1 MPa (86.2% isolated yield). The solid product was characterized by ¹H NMR spectroscopy (90.2% purity), UniQuant X-ray fluorescence, and liquid chromatography (LC). This sample contained ˜9% of free sulfur.

Example 30. Larger-Scale Synthesis of (TMEDA)Zn(S₆). Under a nitrogen atmosphere, a 6 L baffled, jacketed reactor equipped with a mechanical stirrer, was charged with Na₂S.xH₂O (60%, Scales, 90 g, 0.69 mol), sulfur powder (112 g, 3.46 mol), and methanol (1.63 kg). The resulting suspension was refluxed for 1 hr to obtain a dark red solution. In a separate 6 L jacketted reactor, (TMEDA)Zn(OAc)₂ was formed in-situ by combining Zn(OAc)₂.2H₂O (141 g, 0.63 mol), TMEDA (81 g, 0.69 mol), and methanol (1.14 kg). Upon transferring the red solution to the (TMEDA)Zn(OAc)₂ solution, bright yellow precipitate of (TMEDA)Zn(S₆) formed immediately. The resulting slurry was stirred for additional 1 hr, filtered on a Buchner funnel (5 micron filter paper) and further washed with methanol (2.0 L). The solids were removed from the filter and dried under vacuum at 40° C. and 0.1 MPa (97.0% isolated yield). The solid product was characterized by ¹H NMR spectroscopy, UniQuant X-ray fluorescense, and liquid chromatography (LC).

Example 31. Pilot-Scale Synthesis of (TMEDA)Zn(S₆). Under a nitrogen atmosphere, a 500-gal glass reactor (RG-2) equipped with a mechanical stirrer, was charged with Na₂S.xH₂O (60%, Scales, 40.0 kg, 307.53 mol), sulfur powder (49.8 kg, 1537.67 mol), and methanol (776 kg). The resulting suspension was refluxed for 1 hr to obtain a dark red solution. In a separate 500 gal glass reactor (RG-1), (TMEDA)Zn(OAc)₂ was formed in-situ by combining Zn(OAc)₂.2H₂O (61.37 kg, 279.48 mol), TMEDA (49.23 kg, 419.37 mol), and methanol (450 kg). Upon transferring the red solution to the (TMEDA)Zn(OAc)₂ solution, bright yellow precipitate of (TMEDA)Zn(S₆) formed immediately. The resulting slurry was stirred for additional 1 hr, filtered on a nutche and further washed with methanol (55 gal). The solids were removed from the nutche and dried under vacuum at 40° C. and 0.1 MPa (94.3% isolated yield). The solid product was characterized by ¹H NMR spectroscopy (97.3% purity), UniQuant X-ray fluorescence, and liquid chromatography (LC). This sample contained >2% of sulfur.

Example 32. Conversion of the Crude Filtrate, Generated from the Pilot-Scale Bromination Reaction to (TMEDA)Zn(S₆). Under a nitrogen atmosphere, a 200 mL Schlenk flask equipped with a magnetic stir bar, was charged with Na₂S.xH₂O (60%, Scales, 38.4 mmol), sulfur powder (6.23 g, 192.2 mmol), and methanol (91 g). The resulting suspension was refluxed for 1 hr to obtain a dark red solution. In a separate 500 mL three-neck flask, 311 g of the crude filtrate (4.35 wt % (TMEDA)ZnBr₂, contains 38.8 mmol of (TMEDA)ZnBr₂), generated from a pilot-scale bromination reaction, and TMEDA (2.28 g, 19.8 mmol) were charged at room temperature. Upon transferring the red solution to the filtrate solution, bright yellow precipitate of (TMEDA)Zn(S₆) started forming after 15 min. The resulting slurry was stirred for additional 1 hr, filtered on a Buchner funnel (5 micron filter paper) and further washed with methanol. The solids were removed from the filter and dried under vacuum at 40° C. and 0.1 MPa (91.8% isolated yield). The solid product was characterized by ¹H NMR spectroscopy (99.2% purity), UniQuant X-ray fluorescence, and liquid chromatography (LC).

Example 33. Synthesis of (TMEDA)Zn(S₆) at 25 wt % Product Concentration. Under a nitrogen atmosphere, a 6 L baffled, jacketted reactor equipped with a mechanical stirrer, was charged with Na₂S.xH₂O (60%, Scales, 500 g, 3.84 mol), sulfur powder (622.2 g, 19.22 mol), and methanol (1.7 kg). The resulting suspension was refluxed for 1 hr to obtain a dark red solution. In a separate 6 L jacketted reactor, (TMEDA)Zn(OAc)₂ was formed in-situ by combining Zn(OAc)₂.2H₂O (861 g, 3.84 mol), TMEDA (677 g, 5.77 mol), chlorobenzene (1.28 kg) and methanol (320 g). Upon transferring the (TMEDA)Zn(OAc)₂ solution to the red polysulfide solution (reverse order of addition), bright yellow precipitate of (TMEDA)Zn(S₆) formed immediately. The resulting slurry was stirred for additional 1 hr, filtered on a Buchner funnel (5 micron filter paper) and further washed with methanol (2.0 L). The solids were removed from the filter and dried under vacuum at 40° C. and 0.1 Mpa (96.3% isolated yield). The solid product was characterized by ¹H NMR spectroscopy (98.8% purity, UniQuant X-ray fluorescense, and liquid chromatography (LC).

Example 34. Synthesis of (TMEDA)Zn(S₆) at 40 wt % Product Concentration. Under a nitrogen atmosphere, a 6 L baffled, jacketted reactor equipped with a mechanical stirrer, was charged with Na₂S.xH₂O (60%, Scales, 500 g, 3.84 mol), sulfur powder (622.2 g, 19.22 mol), and methanol (450 g). The resulting suspension was refluxed for 1 hr to obtain a dark red solution. In a separate 6 L jacketted reactor, (TMEDA)Zn(OAc)₂ was formed in-situ by combining Zn(OAc)₂.2H₂O (861 g, 3.84 mol), TMEDA (677 g, 5.77 mol), chlorobenzene (564 g) and methanol (141 g). Upon transferring the (TMEDA)Zn(OAc)₂ solution to the red polysulfide solution (reverse order of addition), bright yellow precipitate of (TMEDA)Zn(S₆) formed immediately. The resulting slurry was stirred for additional 1 hr, filtered on a Buchner funnel (5 micron filter paper) and further washed with methanol (2.0 L). The solids were removed from the filter and dried under vacuum at 40° C. and 0.1 MPa (98.8% isolated yield). The solid product was characterized by ¹H NMR spectroscopy (98.9% purity), UniQuant X-ray fluorescense, and liquid chromatography (LC).

Example 35. Synthesis of (TMEDA)Zn(S₆) in the Presence of 17 wt % Water. Under a nitrogen atmosphere, a 200 mL Schlenk flask equipped with a magnetic stir bar, was charged with Na₂S.xH₂O (60%, Scales, 38.4 mmol), sulfur powder (6.23 g, 192.2 mmol), deionized water (9.0 g), and methanol (17 g). The resulting suspension was refluxed for 1 hr to obtain a dark red solution. In a separate 500 mL three-neck flask, (TMEDA)ZnBr₂ was formed in-situ by combining anhydrous ZnBr₂ (8.83 g, 38.4 mmol), TMEDA (6.77 g, 57.7 mmol), and a 80:20 mixture of chlorobenzene (13 g) and methanol (3 g). Upon transferring the red solution to the (TMEDA)ZnBr₂ solution, bright yellow precipitate of (TMEDA)Zn(S₆) formed immediately. The resulting slurry was stirred for additional 1 hr, filtered on a Buchner funnel (5 micron filter paper) and further washed with methanol. The solids were removed from the filter and dried under vacuum at 40° C. and 0.1 MPa (97.6% isolated yield). The solid product was characterized by ¹H NMR spectroscopy (98.7%), UniQuant X-ray fluorescense, and liquid chromatography (LC).

Example 36. Synthesis of (TMEDA)Zn(S₆) in the Presence of 21-25 wt % Water. Under a nitrogen atmosphere, a 200 mL Schlenk flask equipped with a magnetic stir bar, was charged with Na₂S.xH₂O (60%, Scales, 38.4 mmol), sulfur powder (6.23 g, 192.2 mmol), deionized water (12.5 g-15.92 g, depending on the % water), and methanol (17 g). The resulting suspension was refluxed for 1 hr to obtain a dark red solution. In a separate 500 mL three-neck flask, (TMEDA)ZnBr₂ was formed in-situ by combining anhydrous ZnBr₂ (8.83 g, 38.4 mmol), TMEDA (6.77 g, 57.7 mmol), and a 80:20 mixture of chlorobenzene (13 g) and methanol (3 g). Upon transferring the red solution to the (TMEDA)ZnBr₂ solution, bright yellow precipitate of (TMEDA)ZnS₆ formed immediately. The resulting slurry was stirred for additional 1 hr, filtered on a Buchner funnel (5 micron filter paper) and further washed with methanol. The solids were removed from the filter and dried under vacuum at 40° C. and 0.1 MPa (65.2-76.1% isolated yield). The solid product was characterized by ¹H NMR spectroscopy (72.1-81.4% purity), UniQuant X-ray fluorescense, and liquid chromatography (LC). This sample contained ˜17.8-23.7% of unreacted sulfur

Example 37. Synthesis of (TMEDA)Zn(S₆) with a (Na₂S₅+S) Polysulfide Recipe. Under a nitrogen atmosphere, a 200 mL Schlenk flask equipped with a magnetic stir bar, was charged with Na₂S.xH₂O (60%, Scales, 38.4 mmol), sulfur powder (4.98 g, 153.8 mmol), and methanol (47 g). The resulting suspension was refluxed for 1 hr to obtain a dark red solution. In a separate 500 mL three-neck flask, (TMEDA)Zn(OAc)₂ was formed in-situ by combining Zn(OAc)₂.2 H₂O (7.83 g, 34.9 mmol), TMEDA (6.15 g, 52.4 mmol), sulfur powder (1.25 g, 38.4 mmol) and methanol (63 g). Upon transferring the red solution to the (TMEDA)ZnBr₂/sulfur slurry, bright yellow precipitate of (TMEDA)Zn(S₆) formed immediately. The resulting slurry was stirred for additional 1 hr, filtered on a Buchner funnel (5 micron filter paper) and further washed with methanol. The solids were removed from the filter and dried under vacuum at 40° C. and 0.1 MPa (98.1% isolated yield). The solid product was characterized by ¹H NMR spectroscopy (99.1% purity), UniQuant X-ray fluorescense, and liquid chromatography (LC).

Example 38. Synthesis of (TMEDA)Zn(S₆) with a (Na₂S₄+2S) Polysulfide Recipe. Under a nitrogen atmosphere, a 200 mL Schlenk flask equipped with a magnetic stir bar, was charged with Na₂S.xH₂O (60%, Scales, 38.4 mmol), sulfur powder (3.74 g, 115.3 mmol), and methanol (47 g). The resulting suspension was refluxed for 1 hr to obtain a dark red solution. In a separate 500 mL three-neck flask, (TMEDA)ZnBr₂ was formed in-situ by combining ZnBr₂ (8.83 g, 34.9 mmol), TMEDA (6.77 g, 57.7 mmol), sulfur powder (2.49 g, 76.9 mmol) and methanol (63 g). Upon transferring the red solution to the (TMEDA)ZnBr₂/sulfur slurry, bright yellow precipitate of (TMEDA)Zn(S₆) formed immediately. The resulting slurry was stirred for additional 1 hr, filtered on a Buchner funnel (5 micron filter paper) and further washed with methanol. The solids were removed from the filter and dried under vacuum at 40° C. and 0.1 MPa (95.3% isolated yield). The solid product was characterized by ¹H NMR spectroscopy (98.6% purity), UniQuant X-ray fluorescense, and liquid chromatography (LC).

Example 39. Synthesis of (TMEDA)Zn(S₆) in MeOH with 1.02 equivalents of TMEDA. Under a nitrogen atmosphere, a 200 mL Schlenk flask equipped with a magnetic stir bar, was charged with Na₂S.xH₂O (60%, Scales, 38.4 mmol), sulfur powder (6.23 g, 192.2 mmol), and methanol (91 g). The resulting suspension was refluxed for 1 hr to obtain a dark red solution. In a separate 500 mL three-neck flask, (TMEDA)ZnX₂ was formed in-situ by combining ZnX₂ (X=OAc, Br; 34.9 mmol), TMEDA (4.18 g, 35.60 mmol), and methanol (63 g). Upon transferring the red solution to the (TMEDA)ZnX₂ solution, bright yellow precipitate of (TMEDA)Zn(S₆) formed immediately. The resulting slurry was stirred for additional 1 hr, filtered on a Buchner funnel (5 micron filter paper) and further washed with methanol. The solids were removed from the filter and dried under vacuum at 40° C. and 0.1 MPa (89.7% isolated yield). The solid product was characterized by ¹H NMR spectroscopy (97.6% purity), UniQuant X-ray fluorescence, and liquid chromatography (LC).

Example 40. Preparation of S₁₂ From Polysulfide-Derived (TMEDA)Zn(S₆) in Chlorobenzene. Chlorobenzene (88 g) was added to a 300 mL, 4-neck glass flask equipped with a magnetic stir-bar, dropping funnel, N₂ bubbler and stopper. To this flask, the zinc complex, (TMEDA)Zn(S₆) (10 g, 26.25 mmol, 98% pure) was added and the resulting slurry was cooled to −5° C. using a cooling bath. Bromine (4.24 g, 26.51 mmol) was charged into the dropping funnel containing 50 g chlorobenzene and this solution was dropwise added to the flask over a period of ˜30 minutes. The solution was stirred for 15 minutes, filtered, washed with chlorobenzene to remove residual zinc complex and suctioned dried. The solids were slurried in an 80:20 mixture of chlorobenzene-methanol (100 g), filtered, further washed with 100 g MeOH, and suctioned dried to afford 3.57 g of a pale yellow solid. Evaluation using the UQ elemental analysis method showed the material to be 99.4% sulfur (cyclododecasulfur compound (S₁₂) plus cyclooctasulfur and sulfur polymer by Raman spectroscopy and Liquid Chromatography).

Example 41. Preparation of S₁₂ From Polysulfide-Derived (TMEDA)Zn(S₆) in CS₂. Carbon disulfide (88 g) was added to a 300 mL, 4-neck glass flask equipped with a magnetic stir-bar, dropping funnel, N₂ bubbler and stopper. To this flask, the zinc complex, (TMEDA)Zn(S₆) (10 g, 26.25 mmol, 98% pure) was added and the resulting slurry was cooled to −5° C. using a cooling bath. Bromine (4.24 g, 26.51 mmol) was charged into the dropping funnel containing 90 g CS₂ and this solution was dropwise added to the flask over a period of ˜60 minutes. The solution was stirred for 15 minutes, filtered, and suctioned dried. The solids were slurried in an 80:20 mixture of chlorobenzene-methanol (100 g), filtered, further washed with 100 g MeOH and suctioned dried to afford 3.26 g of a pale yellow solid. Evaluation using the UQ elemental analysis method showed the material to be 99.9% sulfur (cyclododecasulfur compound (S₁₂) plus traces of cyclooctasulfur and sulfur polymer by Raman spectroscopy and Liquid Chromatography).

Example 42. Preparation of S₁₂ From Polysulfide-Derived (TMEDA)Zn(S₆) in CS₂-EtOAc. Carbon disulfide (88 g) was added to a 300 mL, 4-neck glass flask equipped with a magnetic stir-bar, dropping funnel, N₂ bubbler and stopper. To this flask, the zinc complex, (TMEDA)Zn(S₆) (10 g, 26.25 mmol, 98% pure) was added and the resulting slurry was cooled to −5° C. using a cooling bath. Bromine (4.24 g, 26.51 mmol) was charged into the dropping funnel containing 90 g EtOAc and this solution was dropwise added to the flask over a period of ˜60 minutes. The solution was stirred for 15 minutes, filtered, and suctioned dried. The solids were slurried in a 80:20 mixture of chlorobenzene-methanol (100 g), filtered, further washed with 100 g MeOH and suctioned dried to afford 3.98 g of a pale yellow solid. Evaluation using the UQ elemental analysis method showed the material to be 99.9% sulfur (cyclododecasulfur compound (S₁₂) plus cyclooctasulfur and sulfur polymer by Raman spectroscopy and Liquid Chromatography).

Example 43. Preparation of S₁₂ From Polysulfide-Derived (TMEDA)Zn(S₆) in CS₂-MeOAc. Carbon disulfide (88 g) was added to a 300 mL, 4-neck glass flask equipped with a magnetic stir-bar, dropping funnel, N₂ bubbler and stopper. To this flask, the zinc complex, (TMEDA)Zn(S₆) (10 g, 26.25 mmol, 98% pure) was added and the resulting slurry was cooled to −5° C. using a cooling bath. Bromine (4.24 g, 26.51 mmol) was charged into the dropping funnel containing 90 g MeOAc and this solution was dropwise added to the flask over a period of ˜60 minutes. The solution was stirred for 15 minutes, filtered, and suctioned dried. The solids were slurried in an 80:20 mixture of chlorobenzene-methanol (100 g), filtered, further washed with 100 g MeOH and suctioned dried to afford 2.91 g of a pale yellow solid. Evaluation using the UQ elemental analysis method showed the material to be 99.1% sulfur (cyclododecasulfur compound (S₁₂) plus cyclooctasulfur and sulfur polymer by Raman spectroscopy and Liquid Chromatography).

Example 44. Preparation of S₁₂ from Polysulfide-Derived (TMEDA)Zn(S₆) Using Br₂ Extracted from Electrochemically Produced Aqueous NaBr₃ Solution. Electrochemically-generated aqueous sodium tribormide solution was first extracted with CS₂ using a separatory funnel to obtain a ˜2.35 wt % Br₂ solution in CS₂, as described in detail in Example 13. Carbon disulfide (88 g) was added to a 300 mL, 4-neck glass flask equipped with a magnetic stir-bar, dropping funnel, N₂ bubbler and stopper. To this flask, the zinc complex, (TMEDA)Zn(S₆) (10 g, 26.25 mmol, 98% pure) was added and the resulting slurry was cooled to −5° C. using a cooling bath. Br₂ solution was dropwise added to the flask over a period of ˜60 minutes until the color of the mixture appeared slightly orange. The solution was stirred for 15 minutes, filtered, and suctioned dried. The solids were slurried in a 80:20 mixture of chlorobenzene-methanol (100 g), filtered, further washed with 100 g MeOH and suctioned dried to afford 3.13 g of a pale yellow solid. Evaluation using the UQ elemental analysis method showed the material to be 99.6% sulfur (cyclododecasulfur compound (S₁₂) plus traces of cyclooctasulfur and sulfur polymer by Raman spectroscopy and Liquid Chromatography).

Example 45. Preparation of S₁₂ From Polysulfide-Derived (TMEDA)Zn(S₆) Using Electrochemically-Generated Aqueous NaBr₃ Solution. Carbon disulfide (88 g) was added to a 300 mL, 4-neck glass flask equipped with a magnetic stir-bar, dropping funnel, N₂ bubbler and stopper. To this flask, the zinc complex, (TMEDA)Zn(S₆) (10 g, 26.25 mmol, 98% pure) was added and the resulting slurry was cooled to −5° C. using a cooling bath. To this solution, electrochemically-derived aqueous NaBr₃ solution (prepared as described in detail in Example 5) was added dropwise over a period of ˜60 minutes until the color of the CS₂ layer turned slightly orange. The solution was stirred for additional 15 minutes, filtered, and suctioned dried. The solids were slurried in an 80:20 mixture of chlorobenzene-methanol (100 g), filtered, further washed with 100 g MeOH and suctioned dried to afford 2.43 g of a pale yellow solid. Evaluation using the UQ elemental analysis method showed the material to be 98.6% sulfur (cyclododecasulfur compound (S₁₂) plus cyclooctasulfur and sulfur polymer by Raman spectroscopy and Liquid Chromatography).

Example 46. Preparation of S₁₂ From Polysulfide-Derived (TEEDA)Zn(S₆) in CS₂. Carbon disulfide (88 g) was added to a 300 mL, 4-neck glass flask equipped with a magnetic stir-bar, dropping funnel, N₂ bubbler and stopper. To this flask, the zinc complex, (TEEDA)Zn(S₆) (10 g, 21.79 mmol, 97% pure) was added and the resulting slurry was cooled to −5° C. using a cooling bath. Bromine (3.55 g, 22.00 mmol) was charged into the dropping funnel containing 90 g CS₂ and this solution was dropwise added to the flask over a period of ˜60 minutes. The solution was stirred for 15 minutes, filtered, and suctioned dried. The solids were slurried in a 80:20 mixture of chlorobenzene-methanol (100 g), filtered, further washed with 100 g MeOH and suctioned dried to afford 2.86 g of a pale yellow solid. Evaluation using the UQ elemental analysis method showed the material to be 99.9% sulfur (cyclododecasulfur compound (S₁₂) plus cyclooctasulfur and sulfur polymer by Raman spectroscopy and Liquid Chromatography).

Example 47. One-pot Synthesis of (TMEDA)Zn(S₆) in MeOH. Under a nitrogen atmosphere, a 200 mL Schlenk flask equipped with a magnetic stir bar, was charged with Na₂S.xH₂O (60%, Scales, 38.4 mmol), sulfur powder (6.23 g, 192.2 mmol), (TMEDA)ZnBr₂ (13.38 g, 38.4 mmol), and methanol (120 g). The resulting suspension was refluxed for 1 hr to obtain a bright yellow precipitate. The resulting slurry was filtered on a Buchner funnel (5 micron filter paper) and further washed with methanol (3×100 g). The solids were removed from the filter and dried under vacuum at 40° C. and 0.1 Mpa (39% isolated yield). The solid product was characterized by ¹H NMR spectroscopy (58.2% purity), Uniquant X-ray fluorescense, and liquid chromatography (LC).

Example 48. Synthesis of (TMEDA)Zn(S₆) from NaHS. Under a nitrogen atmosphere, a 200 mL Schlenk flask equipped with a magnetic stir bar, was charged with NaHS.xH₂O (90% assay, 40.1 mmol, 2.50 g), sodium methoxide (NaOMe) solution (25 wt %, 40.9 mmol, 8.85 g), sulfur powder (6.50 g, 200.1 mmol), and methanol (73 g). The resulting suspension was refluxed for 1 hr to obtain a dark red solution. In a separate 500 mL three-neck flask, (TMEDA)ZnX₂ was formed in-situ by combining ZnX₂ (X=OAc, Br; 36.5 mmol), TMEDA (6.42 g, 54.7 mmol), and methanol (63 g). Upon transferring the red polysulfide solution to the (TMEDA)ZnX₂ solution, bright yellow precipitate of (TMEDA)Zn(S₆) formed immediately. The resulting slurry was stirred for additional 1 hr, filtered on a Buchner funnel (5 micron filter paper) and further washed with methanol. The solids were removed from the filter and dried under vacuum at 40° C. and 0.1 Mpa (87% isolated yield). The solid product was characterized by ¹H NMR spectroscopy (96.2% purity), Uniquant X-ray fluorescense, and liquid chromatography (LC).

Example 49. Preparation of S₁₂ in CS₂ From Electrochemically-derived Polysuflide converted to (TMEDA)Zn(S₆). Na₂Sₓ produced in the electrolysis of Example 5 was used to produce (TMEDA)Zn(S₆) in Example 17, then used in the synthesis of S₁₂ as described herein. Carbon disulfide (88 g) was added to a 300 mL, 4-neck glass flask equipped with a magnetic stir-bar, dropping funnel, N₂ bubbler and stopper. To this flask, the zinc complex, (TMEDA)Zn(S₆) (10 g, 26.25 mmol, 98% pure), produced from electrochemically generated aqueous Na₂Sₓ, was added and the resulting slurry was cooled to −5° C. using a cooling bath. To this solution, Br₂ solution (2.5 wt % in CS₂) was added dropwise over a period of ˜60 minutes until the color of the CS₂ layer turned slightly orange. The solution was stirred for additional 15 minutes, filtered, and suctioned dried. The solids were slurried in a 80:20 mixture of chlorobenzene-methanol (100 g), filtered, further washed with 100 g MeOH and suctioned dried to afford 2.33 g of a pale yellow solid. Evaluation using the UQ elemental analysis method showed the material to be 99.0% sulfur (cyclododecasulfur compound (S₁₂) plus <2% of cyclooctasulfur by Raman spectroscopy and Liquid Chromatography).

That which is claimed is:

1. A method of producing molecular halogen, comprising:
oxidizing a halide to produce a mixture comprising one or more of a molecular halogen, a trihalide, and a halide;
reducing a polysulfide comprising a higher rank polysulfide dianion to produce a lower rank polysulfide dianion; and
recovering molecular halogen from the mixture comprising one or more of a molecular halogen, a trihalide, and a halide.

2. The method of claim 1, wherein the molecular halogen is recovered by reacting the molecular halogen with a metallasulfur derivative by contacting the mixture with the metallasulfur derivative, to produce cyclododecasulfur and a metallahalide derivative.

3. The method of claim 1, further comprising a step of reacting a metallasulfur derivative with the molecular halogen, to produce cyclododecasulfur and a metallahalide derivative.

4. The method of claim 1, wherein the oxidizing and the reducing steps are carried out in an electrochemical cell comprising a catholyte chamber and an anolyte chamber separated by an ion-selective membrane which is permeable to cations, wherein the polysulfide is reduced by electrons in the catholyte chamber, and wherein the halide is oxidized in the anolyte chamber by loss of electrons to produce molecular halogen.

5. The method of claim 1, wherein the recovering of the molecular halogen occurs by contacting the mixture with an extraction solvent comprising one or more of: CS₂, C₅ and larger alkanes, halogenated hydrocarbons of 1 to 12 carbon atoms and one halogen atom up to perhalogenated content, and esters of C₂ to C₈ carboxylic acids with C₁ to C₈ alcohols.

6. The method of claim 1, wherein the halide comprises one or more of a metal halide or a quaternary halide.

7. The method of claim 1, wherein the recovering of the molecular halogen occurs by contacting the mixture with an extraction solvent comprising one or more of: CS₂, chlorobenzene, or ethyl acetate.

8. The method of claim 1, wherein the recovering of the molecular halogen occurs by heterogeneous azeotropic distillation.

9. The method of claim 8, wherein the heterogeneous azeotropic distillation is carried out in the presence of hydrogen peroxide.

10. The method of claim 3, further comprising reacting the metallahalide derivative with a polysulfide to obtain the metallasulfur derivative and a halide.

11. The method of claim 10, further comprising reacting the lower rank metal polysulfide dianion with elemental sulfur to obtain a higher rank polysulfide dianion.

12. The method of claim 1, wherein the halide comprises an alkali metal halide.

13. The method of claim 1, wherein the concentration of lower rank polysulfide dianion after the reducing step is from about 20 wt % to about 45 wt %.

14. The method of claim 1, further comprising:
reacting the lower rank polysulfide dianion with elemental sulfur to
obtain a higher rank metal polysulfide dianion; and
reacting the higher rank metal polysulfide dianion with a metallahalide derivative to obtain a metallasulfur derivative and a halide.

15. A method of producing molecular bromine, comprising:
oxidizing NaBr by loss of electrons to produce a mixture comprising molecular bromine, NaBr₃, and NaBr;
reducing Na₂Sₓ comprising a higher rank polysulfide dianion, wherein x is an average of from about 1.2 to about 6.5, to produce a lower rank polysulfide dianion; and
recovering molecular bromine from the mixture of one or more of molecular bromine, NaBr₃, and NaBr.

16. The method of claim 15, wherein the molecular bromine in the mixture of the molecular bromine, NaBr₃, and NaBr is recovered by reaction with (TMEDA)Zn(S₆) by contacting the mixture with (TMEDA)Zn(S₆), to produce cyclododecasulfur and (TMEDA)ZnBr₂.

17. The method of claim 15, wherein the oxidizing and the reducing steps are carried out in an electrochemical cell comprising a catholyte chamber and an anolyte chamber separated by an ion-selective membrane which is permeable to cations, wherein the Na₂Sₓ is reduced by electrons in the catholyte chamber, and wherein the NaBr is oxidized in the anolyte chamber by loss of electrons to produce the molecular bromine.

18. The method of claim 15, wherein the recovering of the molecular bromine occurs by contacting the mixture with an extraction solvent comprising one or more of: CS₂, chlorobenzene, or ethyl acetate.

19. The method of claim 15, wherein the recovering of the molecular bromine occurs by heterogeneous azeotropic distillation.

20. The method of claim 19, wherein the heterogeneous azeotropic distillation is carried out in the presence of hydrogen peroxide.
